(19) United States
(12) Patent Application Publication
(10) Pub. No.: US 2026/0079095 A1
(43) Pub. Date: Mar. 19, 2026

(54) SOLID SUPPORTS USEFUL FOR TISSUE ADHERENCE

(71) Applicant: Singular Genomics Systems, Inc., San Diego, CA (US)

(72) Inventors: Yuji Ishitsuka, San Diego, CA (US); Zhenmin Hong, San Diego, CA (US); Sarthak Duggal, San Diego, CA (US); Jaekyung Koh, San Diego, CA (US); Daan Witters, San Diego, CA (US)

(21) Appl. No.: 19/038,150

(22) Filed: Jan. 27, 2025

Related U.S. Application Data
(60) Provisional application No. 63/548,609, filed on Feb. 1, 2024.
(60) Provisional application No. 63/651,542, filed on May 24, 2024.
(60) Provisional application No. 63/675,430, filed on Jul. 25, 2024.

(51) Int. Cl. G01N 15/1434; G01N 15/10

(52) U.S. Cl. CPC G01N 15/1436; G01N 2015/1006

(57) ABSTRACT

Disclosed herein, inter alia, are compositions and methods of use of solid supports useful for tissue adherence and/or retention.

### CROSS-REFERENCE TO RELATED APPLICATIONS

This application claims the benefit of U.S. Provisional Application No. 63/548,609, filed Feb. 1, 2024; U.S. Provisional Application No. 63/651,542, filed May 24, 2024; U.S. Provisional Application No. 63/675,430, filed Jul. 25, 2024; each of which are incorporated herein by reference in their entirety and for all purposes.

### BACKGROUND

Flow cells are integral components in next-generation sequencing (NGS) technologies, serving as sophisticated platforms for DNA sequencing. At their core, a flow cell is a hollow glass slide with one or more channels (“lanes”), through which reagents and solutions (e.g., polymerases, nucleotides, and buffers) may traverse. A surface within the channel includes a plurality of immobilized oligonucleotides for capturing target nucleic acid fragments of interest. The captured target molecules may then be amplified and sequenced.

While flow cells have been instrumental in transforming the efficiency and economic feasibility of NGS, their application in spatial biology, particularly for in situ transcript detection within cells and tissues, remains unexplored and challenging. A primary impediment in this translation is tissue delamination, a process where the structural integrity of tissue samples is compromised during repetitive reagent exchanges and thermal changes. Furthermore, when utilizing tissue sections, commonly around 5-7 μm in thickness, additional complications arise. Thin tissue sections are prone to wrinkling, which leads to non-uniform exposure to reagents and target detection inefficiencies. Degradation can result from both the mechanical handling of these fragile sections and the chemical interactions during the sequencing process, leading to a loss of vital biological information and potential misinterpretation of sequencing data. Disclosed herein, inter alia, are solutions to these and other problems in the art.

### BRIEF SUMMARY

In an aspect is a flow cell assembly, the flow cell including a first solid support; a polymer attached to the first solid support; a coupling agent attached to the first polymer; a cell or tissue attached to the coupling agent; a second solid support attached to the first solid support, wherein the second solid support is configured to define a reaction chamber when attached to the first solid support. In embodiments, the coupling agent is the second polymer.

In an aspect is a flow cell assembly, the flow cell including a first solid support; a resist attached to the first solid support; a coupling agent attached to the resist; a cell or tissue attached to the coupling agent; a second solid support attached to the first solid support, wherein the second solid support is configured to define a reaction chamber when attached to the first solid support.

In an aspect is provided a method of making a flow cell assembly, the method including: binding a polymer to a first solid support; binding a coupling agent to the polymer, attaching a cell or tissue to the coupling agent; and affixing a second solid support to the first solid support, wherein the first solid support or the second solid support includes a port.

In an aspect is provided a method of making a flow cell assembly, the method including: binding a resist to a first solid support; binding a coupling agent to the resist; attaching a cell or tissue to the coupling agent; and affixing a second solid support to the first solid support, wherein the first solid support or the second solid support includes a port.

In an aspect is provided a method of detecting a biomolecule in or on a cell or tissue, the method including immobilizing a cell or tissue including a biomolecule to a solid support, wherein the solid support includes a polymer attached to the solid support, and a coupling agent attached to the polymer; attaching a second solid support to the first solid support; contacting the biomolecule in or on the cell or tissue with a detection agent including a label; detecting the label, thereby detecting the biomolecule.

In an aspect is provided a method of detecting a biomolecule in or on a cell or tissue, the method including immobilizing a cell or tissue including a biomolecule to a solid support, wherein the solid support includes a resist attached to the solid support, and a coupling agent attached to the resist; attaching a second solid support to the first solid support; contacting the biomolecule in or on the cell or tissue with a detection agent including a label; detecting the label, thereby detecting the biomolecule. In embodiments, the method includes imaging the cell or tissue.

### BRIEF DESCRIPTION OF THE DRAWINGS

FIGS. 1A-1B. Illustrated in FIG. TA are protocols for the development of a robust solid support for tissue adherence and the assembly of the solid support with a second solid support to generate a flow cell as described. The protocol includes surface functionalization with a resist and coupling agent. In embodiments, the resist includes a polymer described herein. Following surface modification with the polymer and coupling agent, the sample (e.g., tissue section) is deposited onto the functionalized glass slide, where the cloud shape depicts the tissue section. Once affixed, further processing may occur, such as deparaffinization, antigen retrieval, and/or further fixation. Afterwards, the flow cell assembly is accomplished by contacting the functionalized tissue slide with a second solid support, wherein the second solid support includes one or more channels. The channel(s) may be formed by affixing a spacer element (depicted as a dark rectangle) to create a defined gap or channel through which liquid can flow or be contained. The spacer element may be made of any suitable material, for example resin, glass, plastic, silicon, an adhesive, or a combination thereof. In embodiments, the spacer includes a first adhesive in contact with the functionalized glass slide and second adhesive in contact with the second solid support. The depth (i.e., the height) of the resulting channel may be controlled by modulating the height of the spacer element. For example, the spacer element may include a pressure sensitive adhesive (PSA), which may include a carrier polymer that is in contact with both the adhesive layers (as illustrated in FIG. 1B). The resulting depth, otherwise referred to as a height or gap, is depicted as being about 90 μm. In embodiments, the distance between the first and second solid support may be about 50-200 μm to enable fluid flow over the tissue. In embodiments, assembling the flow cell includes using a device to align the functionalized tissue slide and second solid support such that the second solid support can be affixed onto the tissue slide by applying pressure to create a fluidic leak-free seal between the two slides. Following bonding of the two supports, the assembly is ready for downstream sample preparation for in situ spatial sequencing, where downstream sample preparation may include amplification.

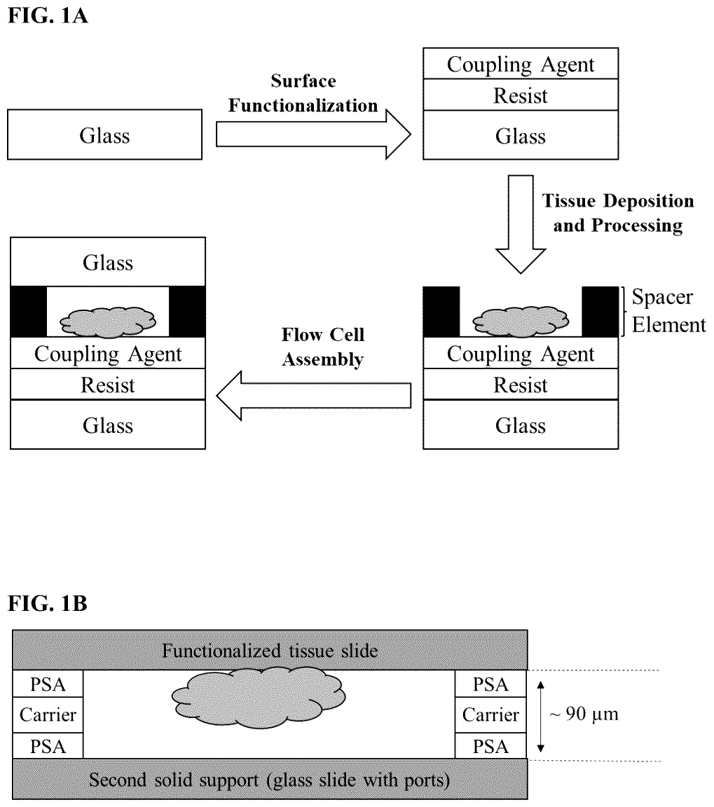

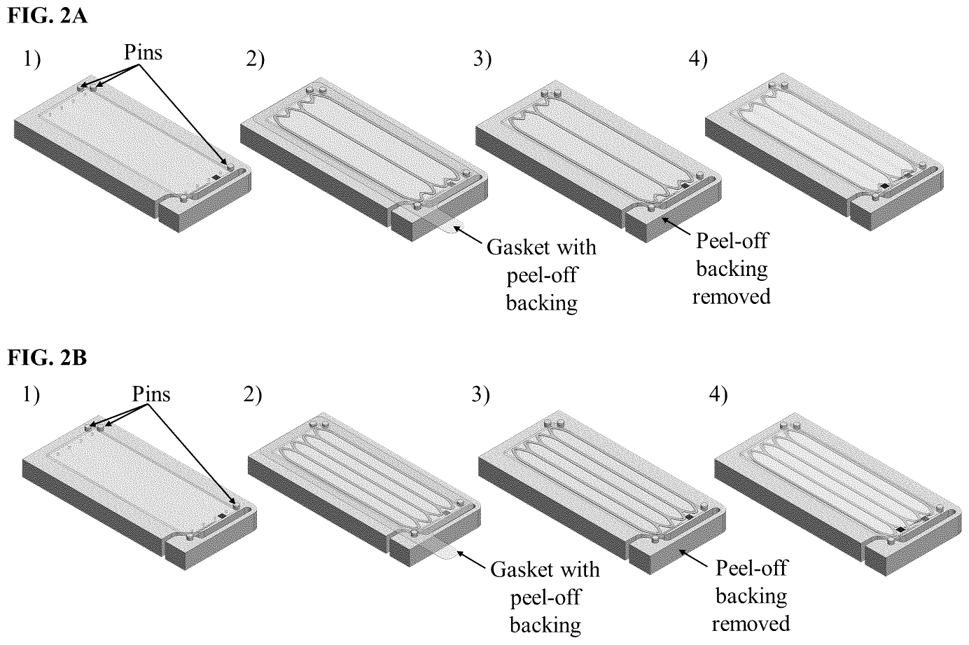

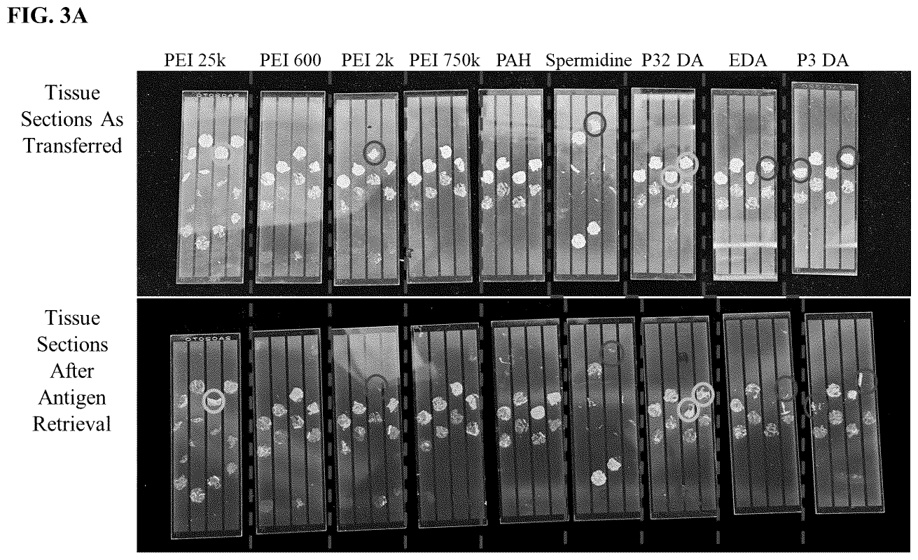

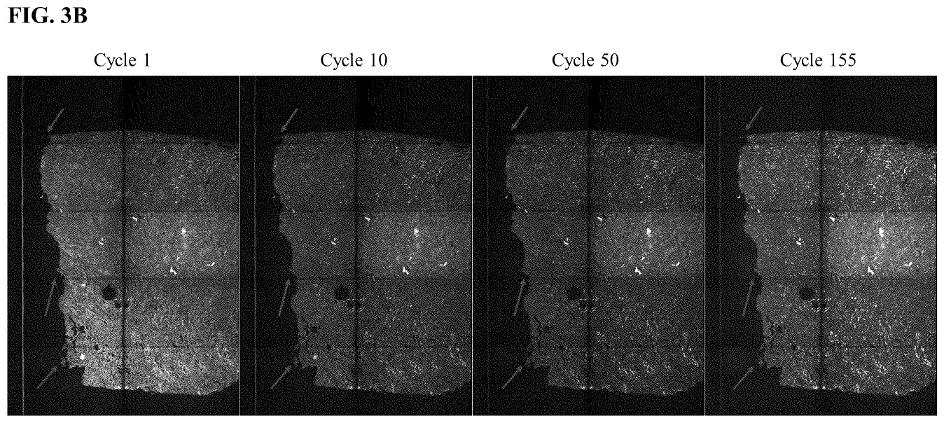

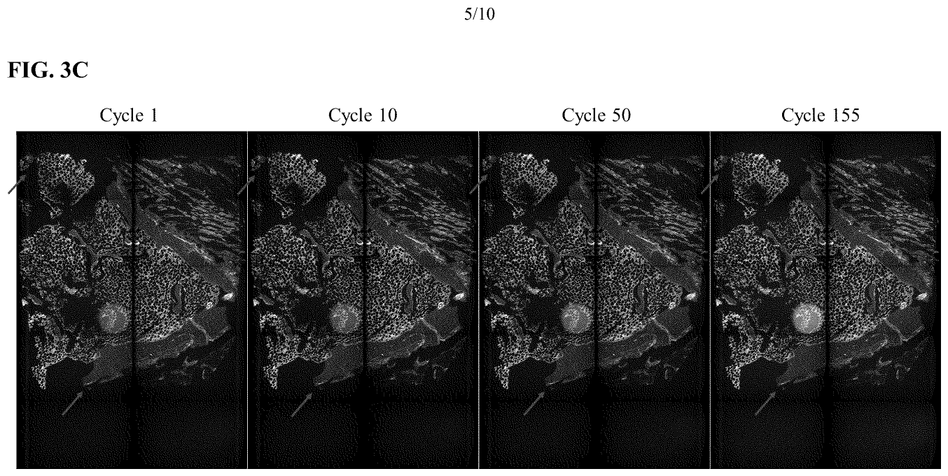

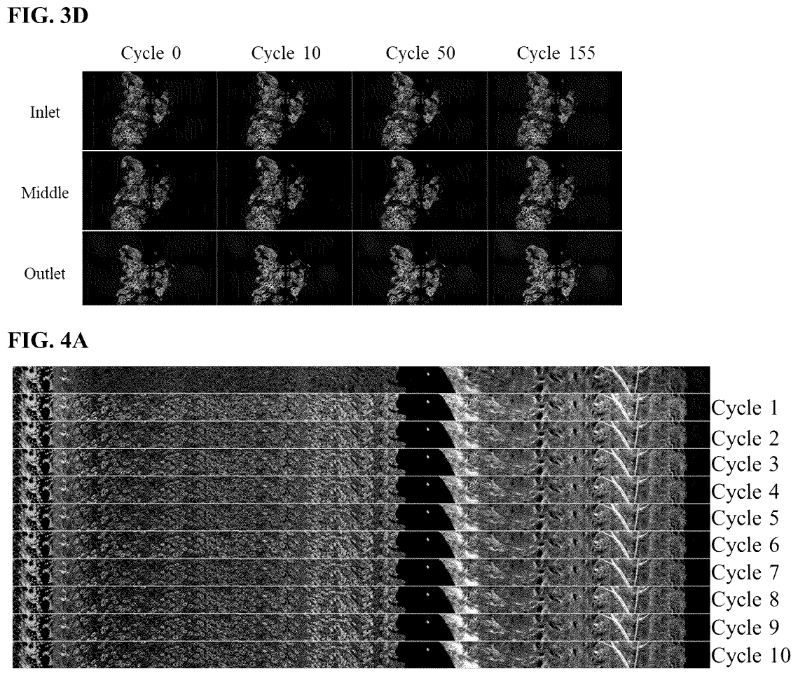

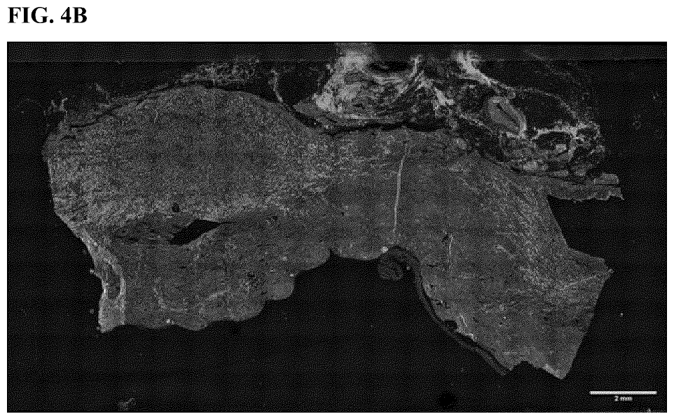

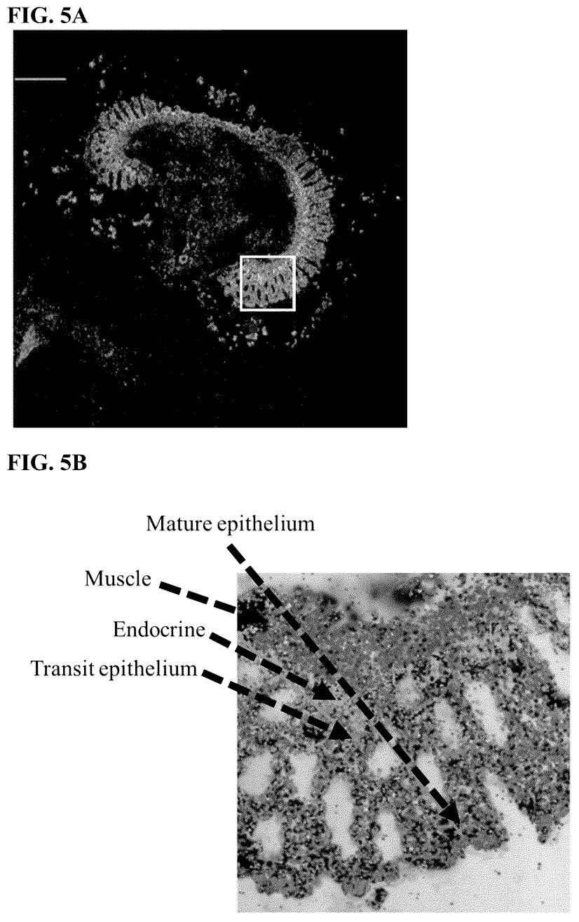

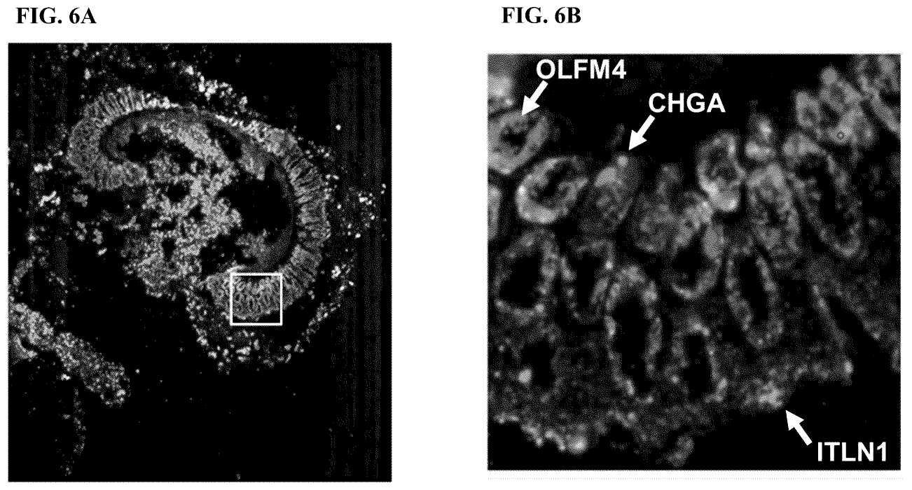

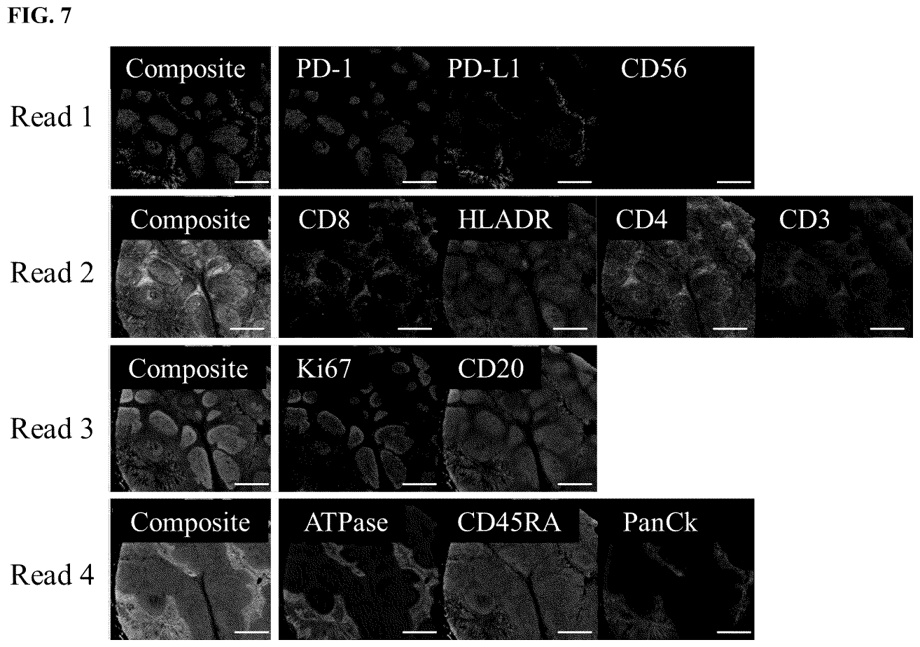

Following sample preparation and sequencing, the biomolecules from the tissue section may be detected. Illustrated in FIG. 1B is a magnified view of an embodiment of the flow cell assembly including a tissue section (depicted as a cloud shape) prepared using the protocol described herein (e.g., in FIG. 1A). In embodiments, the tissue section is attached to the coupling agent attached to the polymer on the first solid support. In embodiments, the tissue section is attached to the coupling agent attached to the resist on the first solid support. In embodiments, the tissue is not attached to, nor in contact with the second solid support. The second solid support includes ports (e.g., inlet and outlet ports) to facilitate fluidic communication with the biological sample adhered onto the functionalized tissue slide. The second solid support is affixed onto to the functionalized tissue slide using a pressure sensitive adhesive (PSA) to create a fluidic leak-free seal between the two solid slides.

FIGS. 2A-2B. FIG. 2A provides a schematic to prepare a second solid support described herein for its attachment to a first solid support described herein by affixing a gasket (e.g., a gasket described herein) onto the second solid support to define two distinct reaction chambers or channels. FIG. 2B provides a schematic to prepare a second solid support described herein for its attachment to a first solid support described herein by affixing a gasket (e.g., a gasket described herein) onto the second solid support to define four distinct reaction chambers or channels on the second solid support described herein. As shown in FIGS. 2A and 2B, prior to affixing the second solid support to the first solid support, the second solid support is placed onto a platform as shown in step 1 of FIGS. 2A and 2B and affixed with a gasket including a peel-off backing as shown in step 2 of FIGS. 2A and 2B. The peel-off backing is removed as shown in step 3 of FIGS. 2A and 2B to affix the second solid support to the first solid support including an attached cell or tissue sample.

FIGS. 3A-3D. FIG. 3A shows tissue section stability and adherence to functionalized glass slide following tissue transfer onto the functionalized glass slide as well as deparaffinization and sequencing cycles in the flow cell assembly. Glass slides were functionalized with poly ethylenimine (PEI); Ormocomp® (an organically-modified ceramic polymer); Ormocomp® and PEI of varying molecular weights (600; 2,000; 25,000; and 750,000); Ormocomp® and polyallylamine; Ormocomp® and spermidine; Ormocomp® and (PEG)₃₂ diamine (abbreviated as P32 DA); Ormocomp® and (PEG)₃ diamine (abbreviated as P3 DA); and Ormocomp® and ethylenediamine (abbreviated as EDA). Two tissue sections were deposited per lane on a given flow cell assembly. Encircled regions indicate tissue sections with partial or complete tissue detachment. FIG. 3B provides images of tissue retention of kidney FFPE on functionalized glass slide as described herein. FIG. 3C provides images tissue retention of bone marrow FFPE on functionalized glass slide as described herein. Arrows shown in FIGS. 3B and 3C are visual aids to show that tissue edges and small tissue islands remain adhered throughout fluidic cycling. FIG. 3D presents data from an evaluation of the effect of location of tissue sections relative to direction of fluidic flow (e.g., near inlet, center, or outlet). Images obtained for bone marrow FFPE tissue section are shown at near the inlet port, middle, and near the outlet port of the flow cell assembly over 155 sequencing cycles.

FIGS. 4A and 4B. An example of a spatial transcriptomic study was performed using kidney tissue adhered onto a functionalized solid support as described herein. The functionalized tissue slide was assembled with a second solid support into a flow cell with two-lane configuration for sequencing, and the first 10 sequencing cycles are depicted in FIG. 4A. Shown in FIG. 4B is a QC image of the kidney tissue sample from FIG. 4A taken using a Nikon microscope following the hybridization of a fluorescently labeled probe to verify lack of tissue delamination and distortion prior to sequencing run.

FIGS. 5A and 5B. FIG. 5A provides an image of a colon tissue attached to the flow cell assembly described herein. Each dot on the image depicts a detected RNA molecule. FIG. 5B shows a magnified view of the region enclosed by the square in FIG. 5A. Using the methods described herein and attaching the colon tissue onto the flow cell assembly described herein enables the detection of rare subpopulations, such as transit amplifying cells, along with a diversity of cell types, such as B cells, plasma cells, T cells, enterocytes, tuft cells, adipocytes, myeloid cells, Paneth cells, endothelial cells, goblet cells, pericytes, neural cells, glial cells, stem cells, stromal cells, epithelial cells, D-cells, and L-cells.

FIGS. 6A and 6B. FIG. 6A provides an image of the same colon tissue section shown in FIGS. 5A and 5B, where proteins of interest, such as CHGA (blue), ITLN1 (green), and OLFM4 (red), were detected using protein-specific antibody-oligo (Ab-O) conjugates.

Following binding of oligonucleotide probes to the Ab-O and subsequent detection, the respective proteins are identified within the tissue, which are shown with arrows as visual aids for the presence of CHGA, ITLN1, and OLFM4 proteins in the colon tissue section. FIG. 6B shows a magnified view of the region enclosed by the square in FIG. 6A.

FIG. 7 provides composite images and representative views of the 12 proteins of interest (PD-1, PD-L1, CD56, CD8, HLADR, CD4, CD3, Ki67, CD20, ATPase, CD45RA, and PanCk) detected in from tonsil tissue in a proteomics workflow using the flow cell assembly described herein during the first four imaging cycles (i.e., read 1, read 2, read 3, and read 4). Scale bars are provided in each image and represent 1000 μm.

### DETAILED DESCRIPTION

The aspects and embodiments described herein relate to compositions and methods of use of solid supports useful for tissue adherence. As described herein, the methods and compositions of this disclosure have many advantages, including providing a robust surface for tissue adherence for spatial biology applications.

### I. Definitions

All patents, patent applications, articles and publications mentioned herein, both supra and infra, are hereby expressly incorporated herein by reference in their entireties.

Unless defined otherwise herein, all technical and scientific terms used herein have the same meaning as commonly understood by one of ordinary skill in the art to which this disclosure belongs. Various scientific dictionaries that include the terms included herein are well known and available to those in the art. Although any methods and materials similar or equivalent to those described herein find use in the practice or testing of the disclosure, some preferred methods and materials are described. Accordingly, the terms defined immediately below are more fully described by reference to the specification as a whole. It is to be understood that this disclosure is not limited to the particular methodology, protocols, and reagents described, as these may vary, depending upon the context in which they are used by those of skill in the art. The following definitions are provided to facilitate understanding of certain terms used frequently herein and are not meant to limit the scope of the present disclosure.

As used herein, the singular terms “a”, “an”, and “the” include the plural reference unless the context clearly indicates otherwise. Reference throughout this specification to, for example, “one embodiment”, “an embodiment”, “another embodiment”, “a particular embodiment”, “a related embodiment”, “a certain embodiment”, “an additional embodiment”, or “a further embodiment” or combinations thereof means that a particular feature, structure or characteristic described in connection with the embodiment is included in at least one embodiment of the present disclosure. Thus, the appearances of the foregoing phrases in various places throughout this specification are not necessarily all referring to the same embodiment. Furthermore, the particular features, structures, or characteristics may be combined in any suitable manner in one or more embodiments.

As used herein, the term “about” means a range of values including the specified value, which a person of ordinary skill in the art would consider reasonably similar to the specified value. In embodiments, the term “about” means within a standard deviation using measurements generally acceptable in the art. In embodiments, about means a range extending to +/−10% of the specified value. In embodiments, about means the specified value.

Throughout this specification, unless the context requires otherwise, the words “comprise”, “comprises” and “comprising” will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that no other elements are optional and may or may not be present depending upon whether or not they affect the activity or action of the listed elements.

As used herein, the term “associated” or “associated with” can mean that two or more species are identifiable as being co-located at a point in time. An association can mean that two or more species are or were within a similar container. An association can be an informatics association, where for example digital information regarding two or more species is stored and can be used to determine that one or more of the species were co-located at a point in time. An association can also be a physical association. In some instances two or more associated species are “tethered”, “coated”, “attached”, or “immobilized” to one another or to a common solid or semisolid support. An association may refer to a relationship, or connection, between two entities. Associated may refer to the relationship between a sample and the DNA molecules, RNA molecules, or polynucleotides originating from or derived from that sample. These relationships may be encoded in a label of a detection agent, as described herein. A polynucleotide (e.g., a label) is associated with a particular protein or nucleic acid of interest if the sequence of the polynucleotide is determined a priori and such sequence is associated with a target protein or nucleic acid of interest. A polynucleotide is associated with a sample if it is an endogenous polynucleotide, i.e., it occurs in the sample at the time the sample is obtained, or is derived from an endogenous polynucleotide. For example, the RNAs endogenous to a cell are associated with that cell. cDNAs resulting from reverse transcription of these RNAs, and DNA amplicons resulting from PCR amplification of the cDNAs, contain the sequences of the RNAs and are also associated with the cell. The polynucleotides associated with a sample need not be located or synthesized in the sample, and are considered associated with the sample even after the sample has been destroyed (for example, after a cell has been lysed).

In the description, relative terms such as “before,” “after,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing or figure under discussion. These relative terms are for convenience of description and do not require that the system be constructed or operated in a particular orientation.

As used herein, the term “contacting” is used in accordance with its plain ordinary meaning and refers to the process of allowing at least two distinct species (e.g., chemical compounds, biomolecules, nucleotides, binding reagents, or cells) to become sufficiently proximal to react, interact or physically touch. However, the resulting reaction product can be produced directly from a reaction between the added reagents or from an intermediate from one or more of the added reagents that can be produced in the reaction mixture. The term “contacting” may include allowing two species to react, interact, or physically touch, wherein the two species may be a compound, a protein (e.g., an antibody), substrate, device, or enzyme. In some embodiments contacting includes allowing a tissue slide described herein including a tissue sample to interact with a flow cell.

As used herein, the term “complement,” as used herein, refers to a nucleotide (e.g., RNA or DNA) or a sequence of nucleotides capable of base pairing with a complementary nucleotide or sequence of nucleotides. As described herein and commonly known in the art the complementary (matching) nucleotide of adenosine is thymidine and the complementary (matching) nucleotide of guanosine is cytosine. Thus, a complement may include a sequence of nucleotides that base pair with corresponding complementary nucleotides of a second nucleic acid sequence. The nucleotides of a complement may partially or completely match the nucleotides of the second nucleic acid sequence. Where the nucleotides of the complement completely match each nucleotide of the second nucleic acid sequence, the complement forms base pairs with each nucleotide of the second nucleic acid sequence.

Where the nucleotides of the complement partially match the nucleotides of the second nucleic acid sequence, only some of the nucleotides of the complement form base pairs with nucleotides of the second nucleic acid sequence. Examples of complementary sequences include coding and non-coding sequences, wherein the non-coding sequence contains complementary nucleotides to the coding sequence and thus forms the complement of the coding sequence. A further example of complementary sequences are sense and antisense sequences, wherein the sense sequence contains complementary nucleotides to the antisense sequence and thus forms the complement of the antisense sequence. Another example of complementary sequences are a template sequence and an amplicon sequence polymerized by a polymerase along the template sequence.

As described herein, the complementarity of sequences may be partial, in which only some of the nucleic acids match according to base pairing, or complete, where all the nucleic acids match according to base pairing. Thus, two sequences that are complementary to each other, may have a specified percentage of nucleotides that complement one another (e.g., about 60%, preferably 65%, 70%, 75%, 80%, 85%, 90%, 91%, 92%, 93%, 94%, 95%, 96%, 97%, 98%, 99%, or higher complementarity over a specified region). In embodiments, two sequences are complementary when they are completely complementary, having 100% complementarity. In embodiments, one or both sequences in a pair of complementary sequences form portions of longer polynucleotides, which may or may not include additional regions of complementarity.

As used herein, the term “hybridize” or “specifically hybridize” refers to a process where two complementary nucleic acid strands anneal to each other under appropriately stringent conditions. Hybridizations are typically and preferably conducted with oligonucleotides. Non-limiting examples of nucleic acid hybridization techniques are described in, for example, Sambrook, et al., Molecular Cloning: A Laboratory Manual (2nd Edition, 1989). Those skilled in the art understand how to estimate and adjust the stringency of hybridization conditions such that sequences having at least a desired level of complementarity will stably hybridize, while those having lower complementarity will not. Hybridization reactions can be performed under conditions of different “stringency”. For example, a low stringency hybridization reaction is carried out at about 40° C. in 10×SSC. A moderate stringency hybridization may be performed at about 50° C. in 6×SSC. A high stringency hybridization reaction is generally performed at about 60° C. in 1×SSC. Hybridization reactions can also be performed under “physiological conditions” which is well known to one of skill in the art (e.g., a physiological condition is the temperature, ionic strength, pH and concentration of Mg²⁺ normally found in vivo). The propensity for hybridization between nucleic acids depends on the temperature and ionic strength of their milieu, the length of the nucleic acids and the degree of complementarity. The effect of these parameters on hybridization is described in, for example, Sambrook J., Fritsch E. F., Maniatis T., Molecular cloning: a laboratory manual, Cold Spring Harbor Laboratory Press, New York (1989). As used herein, hybridization of a primer, or of a DNA extension product, respectively, is extendable by creation of a phosphodiester bond with an available nucleotide or nucleotide analogue capable of forming a phosphodiester bond, therewith. For example, hybridization can be performed at a temperature ranging from 15° C. to 95° C. In some embodiments, the hybridization is performed at a temperature of about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., or about 95° C. In other embodiments, the stringency of the hybridization can be further altered by the addition or removal of components of the buffered solution. As used herein, the term “stringent condition” refers to condition(s) under which a polynucleotide probe or primer will hybridize preferentially to its target sequence, and to a lesser extent to, or not at all to, other sequences. A “stringent hybridization” and “stringent hybridization wash conditions” in the context of nucleic acid hybridization are sequence dependent, and are different under different environmental parameters. In some embodiments nucleic acids, or portions thereof, that are configured to specifically hybridize are often about 80% or more, 81% or more, 82% or more, 83% or more, 84% or more, 85% or more, 86% or more, 87% or more, 88% or more, 89% or more, 90% or more, 91% or more, 92% or more, 93% or more, 94% or more, 95% or more, 96% or more, 97% or more, 98% or more, 99% or more or 100% complementary to each other over a contiguous portion of nucleic acid sequence. A specific hybridization discriminates over non-specific hybridization interactions (e.g., two nucleic acids that a not configured to specifically hybridize, e.g., two nucleic acids that are 80% or less, 70% or less, 60% or less or 50% or less complementary) by about 2-fold or more, often about 10-fold or more, and sometimes about 100-fold or more, 1000-fold or more, 10,000-fold or more, 100,000-fold or more, or 1,000,000-fold or more. Two nucleic acid strands that are hybridized to each other can form a duplex which includes a double-stranded portion of nucleic acid. The phrase “stringent hybridization conditions” refers to conditions under which a primer will hybridize to its target subsequence, typically in a complex mixture of nucleic acids, but to no other sequences. Stringent conditions are sequence-dependent and will be different in different circumstances. Longer sequences hybridize specifically at higher temperatures. An extensive guide to the hybridization of nucleic acids is found in Tijssen, Techniques in Biochemistry and Molecular Biology—Hybridization with Nucleic Probes, “Overview of principles of hybridization and the strategy of nucleic acid assays” (1993). Generally, stringent conditions are selected to be about 5-10° C. lower than the thermal melting point (Tₘ) for the specific sequence at a defined ionic strength pH. The Tₘ is the temperature (under defined ionic strength, pH, and nucleic concentration) at which 50% of the probes complementary to the target hybridize to the target sequence at equilibrium (as the target sequences are present in excess, at Tₘ, 50% of the probes are occupied at equilibrium). Stringent conditions may also be achieved with the addition of destabilizing agents such as formamide. For selective or specific hybridization, a positive signal is at least two times background, preferably 10 times background hybridization. Exemplary stringent hybridization conditions can be as following: 50% formamide, 5×SSC, and 1% SDS, incubating at 42° C., or, 5×SSC, 1% SDS, incubating at 65° C., with wash in 0.2×SSC, and 0.1% SDS at 65° C.

As used herein, “specifically hybridizes” refers to preferential hybridization under hybridization conditions where two nucleic acids, or portions thereof, that are substantially complementary, hybridize to each other and not to other nucleic acids that are not substantially complementary to either of the two nucleic acids. For example, specific hybridization includes the hybridization of a primer or capture nucleic acid to a portion of a target nucleic acid (e.g., a template, or adapter portion of a template) that is substantially complementary to the primer or capture nucleic acid. In some embodiments nucleic acids, or portions thereof, that are configured to specifically hybridize are often about 80% or more, 810% or more, 82% or more, 83% or more, 84% or more, 85% or more, 86% or more, 87% or more, 88% or more, 89% or more, 90% or more, 91% or more, 92% or more, 93% or more, 94% or more, 95% or more, 96% or more, 97% or more, 98% or more, 99% or more or 100% complementary to each other over a contiguous portion of nucleic acid sequence. A specific hybridization discriminates over non-specific hybridization interactions (e.g., two nucleic acids that a not configured to specifically hybridize, e.g., two nucleic acids that are 80% or less, 70% or less, 60% or less or 50% or less complementary) by about 2-fold or more, often about 10-fold or more, and sometimes about 100-fold or more, 1000-fold or more, 10,000-fold or more, 100,000-fold or more, or 1,000,000-fold or more. Two nucleic acid strands that are hybridized to each other can form a duplex which includes a double stranded portion of nucleic acid.

As may be used herein, the terms “nucleic acid,” “nucleic acid molecule,” “nucleic acid sequence,” “nucleic acid fragment” and “polynucleotide” are used interchangeably and are intended to include, but are not limited to, a polymeric form of nucleotides covalently linked together that may have various lengths, either deoxyribonucleotides or ribonucleotides, or analogs, derivatives or modifications thereof. Different polynucleotides may have different three-dimensional structures, and may perform various functions, known or unknown. Non-limiting examples of polynucleotides include a gene, a gene fragment, an exon, an intron, intergenic DNA (including, without limitation, heterochromatic DNA), messenger RNA (mRNA), transfer RNA, ribosomal RNA, a ribozyme, cDNA, a recombinant polynucleotide, a branched polynucleotide, a plasmid, a vector, isolated DNA of a sequence, isolated RNA of a sequence, a nucleic acid probe, and a primer. Polynucleotides useful in the methods of the disclosure may include natural nucleic acid sequences and variants thereof, artificial nucleic acid sequences, or a combination of such sequences. As may be used herein, the terms “nucleic acid oligomer” and “oligonucleotide” are used interchangeably and are intended to include, but are not limited to, nucleic acids having a length of 200 nucleotides or less. In some embodiments, an oligonucleotide is a nucleic acid having a length of 2 to 200 nucleotides, 2 to 150 nucleotides, 5 to 150 nucleotides or 5 to 100 nucleotides. The terms “polynucleotide,” “oligonucleotide,” “oligo” or the like refer, in the usual and customary sense, to a linear sequence of nucleotides. Oligonucleotides are typically from about 5, 6, 7, 8, 9, 10, 12, 15, 25, 30, 40, 50 or more nucleotides in length, up to about 100 nucleotides in length. In some embodiments, an oligonucleotide is a primer configured for extension by a polymerase when the primer is annealed completely or partially to a complementary nucleic acid template. A primer is often a single stranded nucleic acid. In certain embodiments, a primer, or portion thereof, is substantially complementary to a portion of an adapter. In some embodiments, a primer has a length of 200 nucleotides or less. In certain embodiments, a primer has a length of 10 to 150 nucleotides, 15 to 150 nucleotides, 5 to 100 nucleotides, 5 to 50 nucleotides or 10 to 50 nucleotides. In some embodiments, an oligonucleotide may be immobilized to a solid support.

The term “messenger RNA” or “mRNA” refers to an RNA that is without introns and is capable of being translated into a polypeptide. The term “RNA” refers to any ribonucleic acid, including but not limited to mRNA, tRNA (transfer RNA), rRNA (ribosomal RNA), and/or noncoding RNA (such as lncRNA (long noncoding RNA)). The term “cDNA” refers to a DNA that is complementary or identical to an RNA, in either single stranded or double stranded form.

A polynucleotide is typically composed of a specific sequence of four nucleotide bases: adenine (A); cytosine (C); guanine (G); and thymine (T) (uracil (U) for thymine (T) when the polynucleotide is RNA). Thus, the term “polynucleotide sequence” is the alphabetical representation of a polynucleotide molecule; alternatively, the term may be applied to the polynucleotide molecule itself. This alphabetical representation can be input into databases in a computer having a central processing unit and used for bioinformatics applications such as functional genomics and homology searching. Polynucleotides may optionally include one or more non-standard nucleotide(s), nucleotide analog(s) and/or modified nucleotides.

As used herein, the term “polynucleotide template” or “template nucleic acid” refers to any polynucleotide molecule that may be bound by a polymerase and utilized as a template for nucleic acid synthesis. As used herein, the term “polynucleotide primer” refers to any polynucleotide molecule that may hybridize to a polynucleotide template, be bound by a polymerase, and be extended in a template-directed process for nucleic acid synthesis, such as in a PCR or sequencing reaction. A primer can be of any length depending on the particular technique it will be used for. For example, PCR primers are generally between 10 and 40 nucleotides in length. The length and complexity of the nucleic acid fixed onto the nucleic acid template may vary. One of skill can adjust these factors to provide optimum hybridization and signal production for a given hybridization procedure. The primer permits the addition of a nucleotide residue thereto, or oligonucleotide or polynucleotide synthesis therefrom, under suitable conditions. In an embodiment the primer is a DNA primer, i.e., a primer consisting of, or largely consisting of, deoxyribonucleotide residues. The primers are designed to have a sequence that is the complement of a region of template/target DNA to which the primer hybridizes. The addition of a nucleotide residue to the 3′ end of a primer by formation of a phosphodiester bond results in a DNA extension product. The addition of a nucleotide residue to the 3′ end of the DNA extension product by formation of a phosphodiester bond results in a further DNA extension product. In another embodiment the primer is an RNA primer. In embodiments, a primer is hybridized to a target polynucleotide.

In general, the term “target polynucleotide” refers to a nucleic acid molecule or polynucleotide in a starting population of nucleic acid molecules having a target sequence whose presence, amount, and/or nucleotide sequence, or changes in one or more of these, are desired to be determined. In general, the term “target sequence” refers to a nucleic acid sequence on a single strand of nucleic acid. The target sequence may be a portion of a gene, a regulatory sequence, genomic DNA, cDNA, RNA including mRNA, miRNA, rRNA, or others. The target sequence may be a target sequence from a sample or a secondary target such as a product of an amplification reaction. A target polynucleotide is not necessarily any single molecule or sequence. For example, a target polynucleotide may be any one of a plurality of target polynucleotides in a reaction, or all polynucleotides in a given reaction, depending on the reaction conditions. For example, in a nucleic acid amplification reaction with random primers, all polynucleotides in a reaction may be amplified. As a further example, a collection of targets may be simultaneously assayed using polynucleotide primers directed to a plurality of targets in a single reaction. As yet another example, all or a subset of polynucleotides in a sample may be modified by the addition of a primer-binding sequence (such as by the ligation of adapters containing the primer binding sequence), rendering each modified polynucleotide a target polynucleotide in a reaction with the corresponding primer polynucleotide(s).

In some embodiments, a nucleic acid includes a label. As used herein, the term “label” or “labels” is used in accordance with their plain and ordinary meanings and refer to molecules that can directly or indirectly produce or result in a detectable signal either by themselves or upon interaction with another molecule. In embodiments, a label is a nucleic acid sequence associated with a detection agent for the detection of biomolecules of interest in tissue sections or cells. Non-limiting examples of detectable labels include fluorescent dyes, biotin, digoxin, haptens, and epitopes. In general, a dye is a molecule, compound, or substance that can provide an optically detectable signal, such as a colorimetric, luminescent, bioluminescent, chemiluminescent, phosphorescent, or fluorescent signal. In embodiments, the label is a dye. In embodiments, the dye is a fluorescent dye. Non-limiting examples of dyes, some of which are commercially available, include CF® dyes (Biotium, Inc.), Alexa Fluor® dyes (Thermo Fisher), DyLight® dyes (Thermo Fisher), Cy® dyes (GE Healthscience), IRDye® dyes (Li-Cor Biosciences, Inc.), and HiLyte™ dyes (Anaspec, Inc.). In embodiments, a particular nucleotide type is associated with a particular label, such that identifying the label identifies the nucleotide with which it is associated. In embodiments, the label is luciferin that reacts with luciferase to produce a detectable signal in response to one or more bases being incorporated into an elongated complementary strand, such as in pyrosequencing. In embodiment, a nucleotide includes a label (such as a dye). In embodiments, the label is not associated with any particular nucleotide, but detection of the label identifies whether one or more nucleotides having a known identity were added during an extension step (such as in the case of pyrosequencing). Examples of detectable agents (i.e., labels) include imaging agents, including fluorescent and luminescent substances, molecules, or compositions, including, but not limited to, a variety of organic or inorganic small molecules commonly referred to as “dyes,” “labels,” or “indicators.” Examples include fluorescein, rhodamine, acridine dyes, Alexa Fluor® dyes, and cyanine dyes. In embodiments, the detectable moiety is a fluorescent molecule (e.g., acridine dye, cyanine, dye, fluorine dye, oxazine dye, phenanthridine dye, or rhodamine dye). In embodiments, the detectable moiety is a fluorescent molecule (e.g., acridine dye, cyanine, dye, fluorine dye, oxazine dye, phenanthridine dye, or rhodamine dye). The term “cyanine” or “cyanine moiety” as described herein refers to a detectable moiety containing two nitrogen groups separated by a polymethine chain. In embodiments, the cyanine moiety has 3 methine structures (i.e., cyanine 3 or Cy3®). In embodiments, the cyanine moiety has 5 methine structures (i.e., cyanine 5 or Cy5®). In embodiments, the cyanine moiety has 7 methine structures (i.e., cyanine 7 or Cy7®).

As used herein, the term “biomolecule” refers to an agent (e.g., a compound, macromolecule, or small molecule), and the like derived from a biological system (e.g., an organism). The biomolecule may contain multiple individual components that collectively construct the biomolecule, for example, in embodiments, the biomolecule is a polynucleotide wherein the polynucleotide is composed of nucleotide monomers. The biomolecule may be or may include DNA, RNA, organelles, carbohydrates, lipids, proteins, or any combination thereof. These components may be extracellular. In some examples, the biomolecule may be referred to as a clump or aggregate of combinations of components. In some instances, the biomolecule may include one or more constituents of a cell but may not include other constituents of the cell. In embodiments, a biomolecule is a molecule produced by a biological system (e.g., an organism). In embodiments, a biomolecule may be referred to as an analyte. Analytes can be broadly classified into one of two groups: nucleic acid analytes, and non-nucleic acid analytes. Examples of non-nucleic acid analytes include, but are not limited to, lipids, carbohydrates, peptides, proteins, glycoproteins (N-linked or O-linked), lipoproteins, phosphoproteins, specific phosphorylated or acetylated variants of proteins, amidation variants of proteins, hydroxylation variants of proteins, methylation variants of proteins, ubiquitylation variants of proteins, sulfation variants of proteins, viral proteins (e.g., viral capsid, viral envelope, viral coat, viral accessory, viral glycoproteins, viral spike, etc.), extracellular and intracellular proteins, antibodies, and antigen binding fragments. In embodiments, the analytes within a cell can be localized to subcellular locations, including, for example, organelles, e.g., mitochondria, Golgi apparatus, endoplasmic reticulum, chloroplasts, endocytic vesicles, exocytic vesicles, vacuoles, lysosomes, etc. In embodiments, analyte(s) can be peptides or proteins, including antibodies and/or enzymes. In embodiments, an analyte can be detected indirectly, such as through detection of an intermediate agent, for example, a ligation product or an analyte capture agent (e.g., an oligonucleotide-conjugated antibody), such as those described herein.

The term “organelle” as used herein refers to an entity of cell associated with a particular function. In embodiments, an organelle refers to a specialized subunit within a cell that has a specific function, and is usually separately enclosed within its own lipid bilayer. Examples of organelles include the nucleus, mitochondria, endoplasmic reticulum, Golgi apparatus, lysosomes, and chloroplasts (in plant cells). Although most organelles are functional units within cells, some organelles function extend outside of cells, such as cilia, flagellum, archaellum, and the trichocyst. In embodiments, the organelle is a membrane bound organelle. In embodiments, the organelle is a non-membrane bound organelle. Non-membrane bounded organelles, also called biomolecular complexes, are assemblies of macromolecules such as the ribosome, the spliceosome, the proteasome, the nucleosome, and the centriole. Commonly detected organelles includes the nucleus, which is often visualized using dyes such as DAPI, Hoechst, and SYTO Green, mitochondria are with MitoTracker™ dyes and Rhodamine 123, endoplasmic reticulum (ER) utilizing dyes like ER-Tracker® Green/Red or DiOC6, the Golgi apparatus is stained with BODIPY™ FL C5-Ceramide and NBD C6-Ceramide, lysosomes are typically stained using LysoTracker™ dyes and Acridine Orange, and peroxisomes may be stained with Peroxisome-Tracker® Red and Peroxy Green dyes. Although not membrane-bound, ribosomes may detected using antibodies such as anti-RPL10 or anti-RPS6. Additionally, the cytoskeleton, specifically actin filaments, is frequently stained to study cell shape with Phalloidin conjugates and Alexa Fluor® Phalloidin being widely used. In embodiments, the organelle is a biomolecular complex including a plurality of subunits. In embodiments, the organelle is a macromolecule. In embodiments, the organelle is a eukaryotic organelle. In embodiments, the organelle is the cell membrane, the endoplasmic reticulum, a flagellum, a Golgi apparatus, a mitochondria, the nucleus, a vacuole. In embodiments, the organelle is a lysosome. In embodiments, the organelle is the nucleolus.

As used herein, the term “biological system” refers to a virus, cell, cell derivative, cell nucleus, cell organelle, cell constituent and the like derived from a biological sample. Examples of a cell organelle include, without limitation, a nucleus, endoplasmic reticulum, a ribosome, a Golgi apparatus, an endoplasmic reticulum, a chloroplast, an endocytic vesicle, an exocytic vesicle, a vacuole, and a lysosome. The biological system (e.g., an organism) may contain multiple individual components, such as viruses, cells, cell derivatives, cell nuclei, cell organelles and cell constituents, including combinations of different of these and other components. The biological system may include DNA, RNA, organelles, proteins, or any combination thereof. These components may be extracellular. In some examples, the biological system may be referred to as a clump or aggregate of combinations of components. In some instances, the biological system may include one or more constituents of a cell but may not include other constituents of the cell. An example of such constituents include nucleus or an organelle. A cell may be a live or viable cell. The live cell may be capable of being cultured, for example, being cultured when enclosed in a gel or polymer matrix or cultured when including a gel or polymer matrix. A biological system may include a single cell and/or a single nuclei from a cell.

The terms “particle” and “bead” are used interchangeably and mean a small body made of a rigid or semi-rigid material. The body can have a shape characterized, for example, as a sphere, oval, microsphere, or other recognized particle shape whether having regular or irregular dimensions. The term “particle” does not indicate any particular shape. The shapes and sizes of a collection of particles may be different or about the same (e.g., within a desired range of dimensions, or having a desired average or minimum dimension). A particle may be substantially spherical (e.g., microspheres) or have a non-spherical or irregular shape, such as cubic, cuboid, pyramidal, cylindrical, conical, oblong, or disc-shaped, and the like. In embodiments, the particle has the shape of a sphere, cylinder, spherocylinder, or ellipsoid. In embodiments, a particle is a microsphere used as a calibration tool to calibrate and assess the z-axis used in imaging-based methods for in situ spatial sequencing applications. In embodiments, the methods described herein include focusing on the beads at different depths to calibrate and image in three dimensions.

A “functionalized” solid support, as used herein, may refer to the post hoc conjugation of a moiety to a functional group on the surface of a solid support.

Lengths and sizes of nanoparticles and functionalized particles as described herein may be measured using Transmission Electron Microscopy. For example, transmission electron microscopy measurements of the various particle samples may be drop coated (5 μL) onto 200 mesh copper EM grids, air-dried and imaged using a FEI Tecnai 12 TEM equipped with a Gatan Ultrascan 2K CCD camera at an accelerating voltage of 120 kV. The average size distributions of the particles may then be obtained from the TEM images using Image J software that were plotted using software (e.g., Origin Pro 8) to obtain the histogram size distributions of the particles. In embodiment, the length of a nanoparticle refers to the longest dimension of the particle.

As used herein, the term “polymer” refers to macromolecules having one or more structurally unique repeating units. The repeating units are referred to as “monomers,” which are polymerized for the polymer. Typically, a polymer is formed by monomers linked in a chain-like structure. A polymer formed entirely from a single type of monomer is referred to as a “homopolymer.” A polymer formed from two or more unique repeating structural units may be referred to as a “copolymer.” A polymer may be linear or branched, and may be random, block, polymer brush, hyperbranched polymer, bottlebrush polymer, dendritic polymer, or polymer micelles. The term “polymer” includes homopolymers, copolymers, tripolymers, tetra polymers and other polymeric molecules made from monomeric subunits.

Copolymers include alternating copolymers, periodic copolymers, statistical copolymers, random copolymers, block copolymers, linear copolymers and branched copolymers. The term “polymerizable monomer” is used in accordance with its meaning in the art of polymer chemistry and refers to a compound that may covalently bind chemically to other monomer molecules (such as other polymerizable monomers that are the same or different) to form a polymer.

Polymers can be hydrophilic, hydrophobic or amphiphilic, as known in the art. Thus, “hydrophilic polymers” are substantially miscible with water and include, but are not limited to, polyethylene glycol and the like. “Hydrophobic polymers” are substantially immiscible with water and include, but are not limited to, polyethylene, polypropylene, polybutadiene, polystyrene, polymers disclosed herein, and the like. “Amphiphilic polymers” have both hydrophilic and hydrophobic properties and are typically copolymers having hydrophilic segment(s) and hydrophobic segment(s). Polymers include homopolymers, random copolymers, and block copolymers, as known in the art. The term “homopolymer” refers, in the usual and customary sense, to a polymer having a single monomeric unit. The term “copolymer” refers to a polymer derived from two or more monomeric species. The term “random copolymer” refers to a polymer derived from two or more monomeric species with no preferred ordering of the monomeric species. The term “block copolymer” refers to polymers having two or homopolymer subunits linked by covalent bond. Thus, the term “hydrophobic homopolymer” refers to a homopolymer which is hydrophobic. The term “hydrophobic block copolymer” refers to two or more homopolymer subunits linked by covalent bonds and which is hydrophobic.

As used herein, the term “infrared (IR) reflective coating” refers to a material deposited onto a solid support capable of reflecting some or all infrared light. The effectiveness of an IR reflective coating is noted in its capability to reflect light that falls within the infrared spectrum, specifically light with wavelengths ranging from about 750 nanometers (nm) to about 1,000 micrometers (μm). Examples of IR reflective coating include, but are not limited to, metal oxides and silver. In embodiments, the infrared (IR) reflective coatings may include materials such as gold, aluminum, tantalum oxide, chromium, zinc sulfide, and titanium dioxide. Gold is known for its excellent reflectivity, particularly in the near-infrared range; aluminum is a lightweight metal with a natural oxide layer that enhances its IR reflectivity; chromium, a metal noted for its durable and reflective characteristics, zinc sulfide, a compound frequently used in optical components due to its transparency and reflectivity in the infrared range, and titanium dioxide, a compound widely used for its high refractive index and strong IR reflective properties, are exemplary of the diverse range of materials that can be employed as IR reflective coatings. In embodiments, the infrared (IR) reflective coating includes one or more layers of silicon dioxide (SiO₂) and tantalum pentoxide (Ta₂O₅). The IR reflective coating may reflect a portion of the total radiation.

As used herein, the term “coupling agent” refers to a molecule capable of attaching two distinct entities such as molecules, surfaces, or materials, together by forming a chemical bond or complex. A coupling agent typically possesses functional groups (e.g., bioconjugate reactive groups) that allow it to interact with and bind to specific sites on both entities, thereby bridging them together. In embodiments, the coupling agent is (i) attached to the polymer attached to the first solid support and (ii) attached to a component of the cell or tissue (e.g., attached to a biomolecule of a cell). In embodiments, the coupling agent modifies the surface hydrophilicity of the first solid support to provide a surface useful for cell adhesion via electrostatic and/or covalent interactions between the coupling agents and the macromolecules in the cell or tissue to be detected. Non-limiting examples of a coupling agent, includes but is not limited to, (3-aminopropyl)triethoxysilane (APTES), (3-Aminopropyl)trimethoxysilane (APTMS), γ-Aminopropylsilatrane (APS), N-(6-aminohexyl)aminomethyltriethoxysilane (AHAMTES), and polyethylenimine (PEI). In embodiments, the coupling agent is a bioconjugate linker. In embodiments, the coupling agent is collagen (e.g., (Sigma-Aldrich, catalog #C3867-1VL), fibronectin (e.g., Sigma-Aldrich, catalog #F1141-2MG), gelatin (e.g., Sigma-Aldrich, catalog #1393-20ML), Matrigel (e.g., Corning Matrigel Basement Membrane Matrix, catalog #356237), or laminin (e.g., Gibco Laminin Mouse Protein, Natural, catalog #23017-015).

As used herein, the term “interfacial”, or “interfacial layer”, is used in accordance with its plain ordinary meaning and refers to the boundary between any two bulk phases (gas, liquid, or solid) in contact where the properties differ from the properties of the bulk phases. In embodiments, an interfacial layer includes water. Interfacial water differs from bulk water in a number of properties, for example, interfacial water has a higher heat capacity than bulk water because more energy is necessary to break its hydrogen bonds. The arrangement and structure of the interfacial water layer varies depending on the structure of the hydrophilic and/or hydrophobic surface(s) the water layer is in contact with. Additional properties of interfacial water may be found in, e.g., Mentre P. J. Biol. Phys. and Chem. 2004; 4: 115-123 and Tanaka M. Front. Chem. 2020; 8:165, which are incorporated herein by reference in their entirety.

As used herein, the terms “solid support” and “substrate” and “substrate surface” and “solid surface” refers to discrete solid or semi-solid substrate including a surface. In embodiments, a plurality of functional groups (e.g., bioconjugate reactive moieties or specific binding reagents) may be attached to the substrate. A solid support may encompass any type of solid, porous, or hollow sphere, ball, cylinder, or other similar configuration composed of plastic, ceramic, metal, or polymeric material (e.g., hydrogel) onto which a nucleic acid may be immobilized (e.g., covalently or non-covalently). A solid support may include a discrete particle that may be spherical (e.g., microspheres) or have a non-spherical or irregular shape, such as cubic, cuboid, pyramidal, cylindrical, conical, oblong, or disc-shaped, and the like. A bead can be non-spherical in shape. A solid support may be used interchangeably with the term “bead.” A solid support may further include a polymer or hydrogel on the surface to which the primers are attached. Exemplary solid supports include, but are not limited to, glass and modified or functionalized glass, plastics (including acrylics, polystyrene and copolymers of styrene and other materials, polypropylene, polyethylene, polybutylene, polyurethanes, Teflon™, cyclic olefin copolymers, polyimides etc.), nylon, ceramics, resins, Zeonor®, silica or silica-based materials including silicon and modified silicon, carbon, metals, inorganic glasses, optical fiber bundles, photopatternable dry film resists, UV-cured adhesives and polymers. Particularly useful solid supports for some embodiments have at least one surface located on a microplate. Particularly useful solid supports for some embodiments have at least one surface located on a microplate within a flow cell. Solid surfaces can also be varied in their shape depending on the application in a method described herein. For example, a solid surface useful herein can be planar, or contain regions which are concave or convex. In embodiments, the geometry of the concave or convex regions (e.g., wells) of the solid surface conform to the size and shape of a substantially circular particle to maximize the contact between the particle. In embodiments, the wells of an array are randomly located such that nearest neighbor wells have random spacing between each other. Alternatively, in embodiments the spacing between the wells can be ordered, for example, forming a regular pattern. The term solid substrate is encompassing of a substrate (e.g., a microplate or flow cell) having a surface including a polymer coating covalently attached thereto.

Broadly speaking, for nucleic acid sequencing applications, a flow cell may be considered a reaction chamber that contains one or more nucleic acid templates tethered to a solid support, to which nucleotides and ancillary reagents are iteratively applied and washed away. The flow cell allows for imaging of the sites at which the nucleic acids are bound, and resulting image data is used for the desired analysis.

In embodiments, the solid substrate is a flow cell. The term “flow cell” as used herein refers to a chamber including a solid surface across which one or more fluid reagents can be flowed. Examples of flow cells and related fluidic systems and detection platforms that can be readily used in the methods of the present disclosure are described, for example, in Bentley et al., Nature 456:53-59 (2008). In certain embodiments a substrate includes a surface (e.g., a surface of a flow cell, a surface of a tube, a surface of a chip), for example a metal surface (e.g., steel, gold, silver, aluminum, silicon and copper). In embodiments a substrate (e.g., a substrate surface) is coated and/or includes functional groups and/or inert materials. In certain embodiments a substrate includes a bead, a chip, a capillary, a plate, a membrane, a wafer (e.g., silicon wafers), a comb, or a pin for example. In some embodiments a substrate includes a bead and/or a nanoparticle. A substrate can be made of a suitable material, non-limiting examples of which include a plastic or a suitable polymer (e.g., polycarbonate, poly(vinyl alcohol), poly(divinylbenzene), polystyrene, polyamide, polyester, polyvinylidene difluoride (PVDF), polyethylene, polyurethane, polypropylene, and the like), borosilicate, glass, nylon, Wang resin, Merrifield resin, metal (e.g., iron, a metal alloy, sepharose, agarose, polyacrylamide, dextran, cellulose and the like or combinations thereof. In embodiments a substrate includes a magnetic material (e.g., iron, nickel, cobalt, platinum, aluminum, and the like). In embodiments a substrate includes a magnetic bead (e.g., DYNABEADS®, hematite, AMPure XP). Magnets can be used to purify and/or capture nucleic acids bound to certain substrates (e.g., substrates including a metal or magnetic material). The flow cell is typically a glass slide containing small fluidic channels (e.g., a glass slide 75 mm×25 mm×1 mm having one or more channels), through which sequencing solutions (e.g., polymerases, nucleotides, and buffers) may traverse. Though typically glass, suitable flow cell materials may include polymeric materials, plastics, silicon, quartz (fused silica), Borofloat® glass, silica, silica-based materials, carbon, metals, an optical fiber or optical fiber bundles, sapphire, or plastic materials such as COCs and epoxies. The particular material can be selected based on properties desired for a particular use. For example, materials that are transparent to a desired wavelength of radiation are useful for analytical techniques that will utilize radiation of the desired wavelength. Conversely, it may be desirable to select a material that does not pass radiation of a certain wavelength (e.g., being opaque, absorptive, or reflective). In embodiments, the material of the flow cell is selected due to the ability to conduct thermal energy. In embodiments, the flow cell includes glass (e.g., borosilicate glass, soda lime glass, etc.), fused silica (quartz), polymer (e.g., polystyrene (PS), macroporous polystyrene (MPPS), polymethylmethacrylate (PMMA), polycarbonate (PC), polypropylene (PP), polyethylene (PE), high density polyethylene (HDPE), cyclic olefin polymers (COP), cyclic olefin copolymers (COC), polyethylene terephthalate (PET), polydimethylsiloxane (PDMS), etc.), or polyetherimide (PEI), or any combination thereof. In embodiments, a flow cell includes inlet and outlet ports and a flow channel extending there between. In embodiments, the term “flow cell” refers to a vessel having a chamber (e.g., a flow channel or “lane”) where a reaction can be carried out, an inlet for delivering reagent(s) to the chamber, and an outlet for removing reagent(s) from the chamber. Typically, the flow cell shape includes flat surfaces that can reside within the focal depth of the FOV of the microscope imaging system.

As used herein, the term “channel” refers to a passage in or on a substrate material that directs the flow of a fluid. A channel may run along the surface of a substrate, or may run through the substrate between openings in the substrate. A channel can have a cross section that is partially or fully surrounded by substrate material (e.g., a fluid impermeable substrate material). For example, a partially surrounded cross section can be a groove, trough, furrow or gutter that inhibits lateral flow of a fluid. The transverse cross section of an open channel can be, for example, U-shaped, V-shaped, curved, angular, polygonal, or hyperbolic. A channel can have a fully surrounded cross section such as a tunnel, tube, or pipe. A fully surrounded channel can have a rounded, circular, elliptical, square, rectangular, or polygonal cross section. In particular embodiments, a channel can be located in a flow cell, for example, being embedded within the flow cell. A channel in a flow cell can include one or more windows that are transparent to light in a particular region of the wavelength spectrum. In embodiments, the channel contains one or more polymers of the disclosure. In embodiments, the channel is filled by the one or more polymers, and flow through the channel (e.g., as in a sample fluid) is directed through the polymer in the channel. In embodiments, the tissue is in a channel of a flow cell.

As used herein, the term “inlet” or “inlet port” refers to the location on a flow cell assembly where the reagents and fluids used for methods described herein enters the flow cell. As used herein, the term “outlet” or “outlet port” refers to the location on a flow cell assembly where the reagents and fluids used for methods described herein exits the flow cell after contacting the reaction chamber containing the cell or tissue to be analyzed.

As used herein, the term “gasket” refers to an element that separates the first solid support and the second solid support to define a reaction chamber on the second solid support, wherein the reaction chamber includes a defined gap or channel through which liquid can flow or be contained. In embodiments, a gasket is a spacer element. In embodiments, the thickness (also referred herein as the “depth” or “height” of the channel) may be altered by modulating the height of the gasket or spacer element. In embodiments, the gasket or spacer element includes a peel-off backing designed to form a sealed reaction chamber on the second solid support when adhered to the first solid support. This design ensures the creation of defined channels necessary for fluid flow and biochemical reactions within the assembled flow cell (e.g., flow cell assembly described herein). An example of a gasket or spacer element includes, but is not limited to, those used in the NovaSeq™6000 S4 flow cells, commercialized by Illumina®, which is depicted in Poovathingal et al. (Cell Rep Methods. 2024 Aug. 19; 4(8):100831.).

Typically, the nucleic acids need to be amplified. In embodiments the term “amplified” refers to a method that includes a polymerase chain reaction (PCR). Conditions conducive to amplification (i.e., amplification conditions) are well known and often include at least a suitable polymerase, a suitable template, a suitable primer or set of primers, suitable nucleotides (e.g., dNTPs), a suitable buffer, and application of suitable annealing, hybridization and/or extension times and temperatures. Amplification conditions may cycle between different temperatures, often involving a large temperature gradient (e.g., 20° C.-40° C.). Additionally, samples embedded in formalin may require additional protocols to render biomolecules available. Heat induced epitope retrieval (HIER) uses heat coupled with buffered solutions to recover antigen reactivity in formalin fixed paraffin embedded tissue samples. Typical HIER methods include increasing the temperature from 25° C. to 95° C.-120° C., if utilizing a water bath or pressure enhanced temperature device (e.g., a pressure cooker). In embodiments, the microplate includes a microplate insert and a planar support attached to the microplate insert. In embodiments, the planar support can include glass (e.g., a glass slide) that has been coated with a substance or otherwise modified to confer conductive properties to the glass. In some embodiments, a glass slide can be coated with a conductive coating. In some embodiments, a conductive coating includes tin oxide (TO) or indium tin oxide (ITO). In some embodiments, a conductive coating includes a transparent conductive oxide (TCO). In some embodiments, a conductive coating includes aluminum doped zinc oxide (AZO). In some embodiments, a conductive coating includes fluorine doped tin oxide (FTO).

As used herein, the term “reaction chamber” refers to a contained space or vessel designed for conducting chemical, biological, or physical reactions. A reaction chamber may include features such as inlets and outlets for introducing and removing substances, sensors for monitoring reaction conditions, and mechanisms for agitation or mixing. In embodiments, the reaction chamber is a part of the flow cell where the cell or tissue is in contact with the fluids (e.g., buffers), polymerases, nucleotides, and reagents used for the methods described herein. In embodiments, the reaction chamber is formed when a first solid support and a second solid support configured to provide a channel are attached together. In embodiments, the reaction chamber is an enclosed (i.e., closed) container containing one or two openings for introducing and removing fluids and reagents.

The term “surface” is intended to mean an external part or external layer of a substrate. The surface can be in contact with another material such as a gas, liquid, gel, polymer, organic polymer, second surface of a similar or different material, metal, or coat. The surface, or regions thereof, can be substantially flat. The substrate and/or the surface can have surface features such as wells, pits, channels, ridges, raised regions, pegs, posts or the like.

As used herein, the term “feature” refers a point or area in a pattern that can be distinguished from other points or areas according to its relative location. An individual feature can include one or more polynucleotides. For example, a feature can include a single target nucleic acid molecule having a particular sequence or a feature can include several nucleic acid molecules having the same sequence (and/or complementary sequence, thereof). Different molecules that are at different features of a pattern can be differentiated from each other according to the locations of the features in the pattern. Non-limiting examples of features include wells in a substrate, particles (e.g., beads) in or on a substrate, polymers in or on a substrate, projections from a substrate, ridges on a substrate, or channels in a substrate. In embodiments, the one or more features include a reaction chamber and its contents. In embodiments, the one or more features includes a target (e.g., a nucleic acid, protein, or biomarker), a cell, or a tissue sample. In embodiments, the feature is a nucleotide (e.g., a fluorescently labeled nucleotide). In embodiments, the feature is a nucleic acid. In embodiments, the feature is a protein. In embodiments, the feature is a biomolecule.

As used herein, the terms “sequencing”, “sequence determination”, and “determining a nucleotide sequence”, are used in accordance with their ordinary meaning in the art, and refer to determination of partial as well as full sequence information of the nucleic acid being sequenced, and particular physical processes for generating such sequence information. That is, the term includes sequence comparisons, fingerprinting, and like levels of information about a target nucleic acid, as well as the express identification and ordering of nucleotides in a target nucleic acid. The term also includes the determination of the identification, ordering, and locations of one, two, or three of the four types of nucleotides within a target nucleic acid. As used herein, the term “sequencing cycle” is used in accordance with its plain and ordinary meaning and refers to incorporating one or more nucleotides (e.g., nucleotide analogues) to the 3′ end of a polynucleotide with a polymerase, and detecting one or more labels that identify the one or more nucleotides incorporated. In embodiments, one nucleotide (e.g., a modified nucleotide) is incorporated per sequencing cycle. The sequencing may be accomplished by, for example, sequencing by synthesis, pyrosequencing, and the like. In embodiments, a sequencing cycle includes extending a complementary polynucleotide by incorporating a first nucleotide using a polymerase, wherein the polynucleotide is hybridized to a template nucleic acid, detecting the first nucleotide, and identifying the first nucleotide. In embodiments, to begin a sequencing cycle, one or more differently labeled nucleotides and a DNA polymerase can be introduced.

Following nucleotide addition, signals produced (e.g., via excitation and emission of a detectable label) can be detected to determine the identity of the incorporated nucleotide (based on the labels on the nucleotides). Reagents can then be added to remove the 3′ reversible terminator and to remove labels from each incorporated base. Reagents, enzymes, and other substances can be removed between steps by washing. Cycles may include repeating these steps, and the sequence of each cluster is read over the multiple repetitions.

As used herein, the term “extension” or “elongation” is used in accordance with its plain and ordinary meanings and refer to synthesis by a polymerase of a new polynucleotide strand complementary to a template strand by adding free nucleotides (e.g., dNTPs) from a reaction mixture that are complementary to the template in the 5′-to-3′ direction. Extension includes condensing the 5′-phosphate group of the dNTPs with the 3′-hydroxy group at the end of the nascent (elongating) polynucleotide strand.

As used herein, the term “sequencing read” is used in accordance with its plain and ordinary meaning and refers to an inferred sequence of nucleotide bases (or nucleotide base probabilities) corresponding to all or part of a single polynucleotide fragment. A sequencing read may include 1, 5, 10, 20, 30, 40, 50, 60, 70, 80, 90, 100, 150, 200, 250, or more nucleotide bases. In embodiments, a sequencing read includes reading a barcode sequence and a template nucleotide sequence. In embodiments, a sequencing read includes reading a template nucleotide sequence. In embodiments, a sequencing read includes reading a barcode and not a template nucleotide sequence. Reads of length 20-40 base pairs (bp) are referred to as ultra-short. Typical sequencers produce read lengths in the range of 100-500 bp. Read length is a factor which can affect the results of biological studies. For example, longer read lengths improve the resolution of de novo genome assembly and detection of structural variants. In embodiments, a sequencing read includes reading a barcode and a template nucleotide sequence. In embodiments, a sequencing read includes reading a template nucleotide sequence. In embodiments, a sequencing read includes reading a barcode and not a template nucleotide sequence. In embodiments, a sequencing read includes a computationally derived string corresponding to the detected label. In some embodiments, a sequencing read may include 500, 600, 700, 800, 900, 1,000, 1,100, 1,200, 1,300, 1,400, 1,500, or more nucleotide bases.

Where a range of values is provided, it is understood that each intervening value, to the tenth of the unit of the lower limit unless the context clearly indicates otherwise, between the upper and lower limit of that range, and any other stated or unstated intervening value in, or smaller range of values within, that stated range is encompassed within the invention. The upper and lower limits of any such smaller range (within a more broadly recited range) may independently be included in the smaller ranges, or as particular values themselves, and are also encompassed within the invention, subject to any specifically excluded limit in the stated range. Where the stated range includes one or both of the limits, ranges excluding either or both of those included limits are also included in the invention.

The abbreviations used herein have their conventional meaning within the chemical and biological arts. The chemical structures and formulae set forth herein are constructed according to the standard rules of chemical valency known in the chemical arts.

As used herein, the term “barcode” refers to a known nucleic acid sequence that allows some feature with which the barcode is associated to be identified. Typically, a barcode is unique to a particular feature in a pool of barcodes that differ from one another in sequence, and each of which is associated with a different feature. In embodiments, barcodes are about or at least about 1, 2, 3, 4, 5, 6, 7, 8, 9, 10, 15, 20, 25, 30, 40, 50, 75 or more nucleotides in length. In embodiments, barcodes are shorter than 20, 15, 10, 9, 8, 7, 6, or 5 nucleotides in length. In embodiments, barcodes are 10-50 nucleotides in length, such as 15-40 or 20-30 nucleotides in length. In a pool of different barcodes, barcodes may have the same or different lengths. In general, barcodes are of sufficient length and include sequences that are sufficiently different to allow the identification of associated features (e.g., a binding moiety or analyte) based on barcodes with which they are associated. In embodiments, a barcode can be identified accurately after the mutation, insertion, or deletion of one or more nucleotides in the barcode sequence, such as the mutation, insertion, or deletion of 1, 2, 3, 4, 5, or more nucleotides. In embodiments, a detection agent described herein has a barcode, wherein the barcode is an oligonucleotide label. In embodiments, the barcode is a sample barcode. In embodiments, a plurality of nucleotides (e.g., all nucleotides from a particular sample source, or sub-sample thereof) are joined to a first sample barcode, while a different plurality of nucleotides (e.g., all nucleotides from a different sample source, or different subsample) are joined to a second sample barcode, thereby associating each plurality of polynucleotides with a different sample barcode indicative of sample source. In embodiments, each sample barcode in a plurality of sample barcodes differs from every other sample barcode in the plurality by at least three nucleotide positions, such as at least 3, 4, 5, 6, 7, 8, 9, 10, or more nucleotide positions. In some embodiments, substantially degenerate sample barcodes may be known as random. In some embodiments, a sample barcode may include a nucleic acid sequence from within a pool of known sequences. In some embodiments, the sample barcodes may be pre-defined. In embodiments, the sample barcode includes about 1 to about 10 nucleotides. In embodiments, the sample barcode includes about 3, 4, 5, 6, 7, 8, 9, or about 10 nucleotides. In embodiments, the sample barcode includes about 3 nucleotides. In embodiments, the sample barcode includes about 5 nucleotides. In embodiments, the sample barcode includes about 7 nucleotides. In embodiments, the sample barcode includes about 10 nucleotides. In embodiments, the sample barcode includes about 6 to about 10 nucleotides.

As used herein, the term “detection agent” refers to an agent with a label that is capable of specifically binding to a biomolecule of interest to facilitate the detection of the biomolecule of interest. Binding the detection agent to the biomolecule of interest facilitates detecting the label and thus, detection of the biomolecule of interest. An example of a detection agent with a label (e.g., a detectable label) include fluorescently labeled antibodies used for flow cytometry applications. An additional example of a detection agent with a label is a padlock probe capable of hybridizing to a nucleic acid of interest, where the padlock probe harbors an oligonucleotide label that is sequenced to facilitate the detection of the nucleic acid of interest. In embodiments, the detection agent is a biomolecule-specific binding agent, wherein the biomolecule-specific binding agent specifically binds a target biomolecule.

The terms “detect” and “detecting” as used herein refer to the act of viewing (e.g., imaging, indicating the presence of, quantifying, or measuring (e.g., spectroscopic measurement), an agent based on an identifiable characteristic of the agent, for example, the light emitted from the present compounds. For example, the compound described herein can be bound to an agent, and, upon being exposed to an absorption light, will emit an emission light. The presence of an emission light can indicate the presence of the agent. Likewise, the quantification of the emitted light intensity can be used to measure the concentration of the agent.

As used herein, the term “protein-specific binding agent” refers to a molecule or agent that recognizes and binds to a protein or specific part of a protein with high affinity and specificity. Examples of a protein-specific protein binding agent include, but are not limited to, antibodies, aptamers, enzyme inhibitors, ligands for receptors, affinity tags, peptide-based protein binding agents, chelating agents for metalloproteins, and RNA interference agents. In embodiments, a protein-specific binding agent includes a protein-specific antibody conjugated to an oligonucleotide (referred herein as “protein-specific antibody-oligo (Ab-O) conjugates”), wherein the oligonucleotide in the protein-specific antibody-oligo is an oligonucleotide label as described herein.

As used herein, the term “oligonucleotide-specific binding agent” refers to a molecule (e.g., an oligonucleotide) capable of hybridizing to specific sequences of nucleotides. Examples include but are not limited to antisense oligonucleotides, aptamers, and small interfering RNA molecules.

As used herein, the term “oligonucleotide label” or “label” refers to a known nucleic acid sequence that is associated with a detection agent and that allows the target of the detection agent with which the oligonucleotide label or label is associated to be identified. In embodiments, the oligonucleotide label is a detectable label. The sequence oligonucleotide label or label is determined a priori and the identity of a biomolecule of interest (e.g., a protein or nucleic acid) is determined following the binding of the detection agent to the biomolecule of interest, detecting the sequence of the label, and associating the detection of the sequence of the label with the biomolecule of interest. In embodiments, detecting the sequence of the oligonucleotide label or label includes sequencing.

The terms “bind” and “bound” as used herein are used in accordance with their plain and ordinary meanings and refer to an association between atoms or molecules. The association can be direct or indirect. For example, bound atoms or molecules may be directly bound to one another, e.g., by a covalent bond or non-covalent bond (e.g. electrostatic interactions (e.g. ionic bond, hydrogen bond, halogen bond), van der Waals interactions (e.g. dipole-dipole, dipole-induced dipole, London dispersion), ring stacking (pi effects), hydrophobic interactions and the like). As a further example, two molecules may be bound indirectly to one another by way of direct binding to one or more intermediate molecules (e.g., as in a substrate, bound to a first antibody, bound to an analyte, bound to a second antibody), thereby forming a complex. As used herein, the term “attached” refers to the state of two things being joined, fastened, adhered, connected or bound to each other. For example, a sample such as a cell or tissue, can be attached to a material, such as a hydrogel, polymer, or solid support, by a covalent or non-covalent bond. In embodiments, attachment is a covalent attachment.

Where a range of values is provided, it is understood that each intervening value, to the tenth of the unit of the lower limit unless the context clearly indicates otherwise, between the upper and lower limit of that range, and any other stated or unstated intervening value in, or smaller range of values within, that stated range is encompassed by such disclosure herein. The upper and lower limits of any such smaller range (within a more broadly recited range) may independently be included in the smaller ranges, or as particular values themselves, and are also encompassed by such disclosure herein, subject to any specifically excluded limit in the stated range. Where the stated range includes one or both of the limits, ranges excluding either or both of those included limits are also included by such disclosure herein.

Provided herein are methods, systems, and compositions for analyzing a sample (e.g., sequencing nucleic acids within a sample) in situ. The term “in situ” is used in accordance with its ordinary meaning in the art and refers to a sample surrounded by at least a portion of its native environment, such as may preserve the relative position of two or more elements. For example, an extracted human cell obtained is considered in situ when the cell is retained in its local microenvironment so as to avoid extracting the target (e.g., nucleic acid molecules or proteins) away from their native environment. An in situ sample (e.g., a cell) can be obtained from a suitable subject. An in situ cell sample may refer to a cell and its surrounding milieu, or a tissue. A sample can be isolated or obtained directly from a subject or part thereof. In embodiments, the methods described herein (e.g., sequencing a plurality of target nucleic acids of a cell in situ) are applied to an isolated cell (i.e., a cell not surrounded by least a portion of its native environment). For the avoidance of any doubt, when the method is performed within a cell (e.g., an isolated cell) the method may be considered in situ. In some embodiments, a sample is obtained indirectly from an individual or medical professional. A sample can be any specimen that is isolated or obtained from a subject or part thereof. A sample can be any specimen that is isolated or obtained from multiple subjects. Non-limiting examples of specimens include fluid or tissue from a subject, including, without limitation, blood or a blood product (e.g., serum, plasma, platelets, buffy coats, or the like), umbilical cord blood, chorionic villi, amniotic fluid, cerebrospinal fluid, spinal fluid, lavage fluid (e.g., lung, gastric, peritoneal, ductal, ear, arthroscopic), a biopsy sample, celocentesis sample, cells (blood cells, lymphocytes, placental cells, stem cells, bone marrow derived cells, embryo or fetal cells) or parts thereof (e.g., mitochondrial, nucleus, extracts, or the like), urine, feces, sputum, saliva, nasal mucous, prostate fluid, lavage, semen, lymphatic fluid, bile, tears, sweat, breast milk, breast fluid, the like or combinations thereof. Non-limiting examples of tissues include organ tissues (e.g., liver, kidney, lung, thymus, adrenals, skin, bladder, reproductive organs, intestine, colon, spleen, brain, the like or parts thereof), epithelial tissue, hair, hair follicles, ducts, canals, bone, eye, nose, mouth, throat, ear, nails, the like, parts thereof or combinations thereof. A sample may include cells or tissues that are normal, healthy, diseased (e.g., infected), and/or cancerous (e.g., cancer cells). A sample obtained from a subject may include cells or cellular material (e.g., nucleic acids) of multiple organisms (e.g., virus nucleic acid, fetal nucleic acid, bacterial nucleic acid, parasite nucleic acid). A sample may include a cell and RNA transcripts. A sample may include a cell and DNA. A sample may include a cell and target proteins. A sample may include DNA, RNA, organelles, carbohydrates, lipids, proteins, or any combination thereof. These components may be extracellular. A sample may include a “target” of the method described herein or any embodiments of the method described herein. A sample may include any compound that may be desired to be detected, for example a peptide or protein, or nucleic acid molecule or a small molecule, including organic and inorganic molecules. A sample may include proteinaceous molecules such as peptides, polypeptides, proteins or prions or any molecule which includes a protein or polypeptide component, etc., or fragments thereof. A sample may include a single molecule or a complex that contains two or more molecular subunits, which may or may not be covalently bound to one another, and which may be the same or different. Thus, in addition to cells or microorganisms, a sample may also include a protein complex. Such a complex may thus be a homo- or hetero-multimer. Aggregates of molecules e.g., proteins may also be target analytes, for example aggregates of the same protein or different proteins. A sample may include a complex between proteins or peptides and nucleic acid molecules such as DNA or RNA. Of particular interest may be the interactions between proteins and nucleic acids, e.g., regulatory factors, such as transcription factors, and interactions between DNA or RNA molecules. A sample can include nucleic acids obtained from one or more subjects. In some embodiments a sample includes nucleic acid obtained from a single subject. A subject can be any living or non-living organism, including but not limited to a human, non-human animal, plant, bacterium, fungus, virus, or protist. A subject may be any age (e.g., an embryo, a fetus, infant, child, adult). A subject can be of any sex (e.g., male, female, or combination thereof). A subject may be pregnant. In some embodiments, a subject is a mammal. In some embodiments, a subject is a plant. In some embodiments, a subject is a human subject. A subject can be a patient (e.g., a human patient). In some embodiments a subject is suspected of having a genetic variation or a disease or condition associated with a genetic variation. A “tissue section” as used herein refers to a portion of a biological tissue derived from a biological sample, typically from an organism (e.g., a human or animal subject or patient).

As used herein, the term “fresh,” generally in the context of a fresh tissue means that the tissue has recently been obtained from an organism, generally before any subsequent fixation steps, for example, flash freezing or chemical fixation. In embodiments, a fresh tissue is obtained from an organism about 1 second up to about 20 minutes before any fixation steps are performed. In embodiments, a fresh tissue is obtained from an organism about 1 second up to about 60 seconds before any fixation steps are performed. In embodiments, afresh tissue is obtained from an organism about 30 seconds up to about 60 seconds before any fixation steps are performed. In embodiments, a fresh tissue is obtained from an organism about 1 minutes up to about 20 minutes before any fixation steps are performed. In embodiments, a fresh tissue is obtained from an organism about 1 minutes up to about 10 minutes before any fixation steps are performed. In embodiments, a fresh tissue is obtained from an organism about 1 minutes up to about 5 minutes before any fixation steps are performed. In embodiments, a fresh tissue is obtained from an organism about 30 seconds, about 1 minute, about 2 minutes, about 3 minutes, about 4 minutes, about 5 minutes, about 10 minutes, about 15 minutes, or about 20 minutes before any fixation steps are performed.

As used herein, the term “fix,” refers to formation of covalent bonds, such as crosslinks, between biomolecules or within molecules. The process of fixing tissue samples or biological samples (e.g., cells and nuclei) for example, is called “fixation.” The agent that causes fixation is generally referred to as a “fixative” or “fixing agent.” “Fixed biological samples” (e.g., fixed cells or nuclei) or “fixed tissues” refers to biological samples (e.g., cells or nuclei) or tissues that have been in contact with a fixative under conditions sufficient to allow or result in formation of intra- and inter-molecular crosslinks between biomolecules in the biological sample. Fixation may be reversed and the process of reversing fixation may be referred to as “un-fixing” or “decrosslinking.” Unfixing or decrosslinking refers to breaking or reversing the formation of covalent bonds in biomolecules formed by fixatives. In some examples, the tissue fixed is fresh tissue. In some examples, the tissue fixed may be frozen tissue. In some examples, the tissue fixed may not be dissociated. In some examples, the tissue fixed may be dissociated or partially dissociated (e.g., chopped, cut). In some examples, tissue that has been rapidly frozen and, perhaps, cut or chopped into pieces (e.g., small enough to fit into a tube or container used for fixation) may be used. In some examples, tissue may be dissociated or partially dissociated (e.g., cut, chopped) before or during fixation. In some examples, tissue that is fixed may not be dissociated. The frozen biological tissue can be fixed using a fixing agent, which is suitably an organic fixing agent. Suitable organic fixing agents include without limitation alcohols, ketones, aldehydes (e.g., glutaraldehyde), cross-linking agents, disuccinimidyl suberate (DSS), dimethylsuberimidate (DMS), formalin, dimethyladipimidate (DMA), dithio-bis(-succinimidyl propionate) (DSP), disuccinimidyl tartrate (DST), ethylene glycol bis(succinimidyl succinate) (EGS), bis(sulfosuccinimidyl)suberate (BS3) and combinations thereof. A particularly suitable fixing agent is a formaldehyde-based fixing agent such as formalin, which is a mixture of formaldehyde and water. The formalin may include about 1% to about 15% by weight formaldehyde and about 85% to about 99% by weight water, suitable about 2% to about 8% by weight formaldehyde and about 92% to about 98% by weight water, or about 4% by weight formaldehyde and about 96% by weight water. In some examples, tissues may be fixed in 4% paraformaldehyde. Other suitable fixing agents will be appreciated by those of ordinary skill in the art (e.g., International PCT App. No. PCT/US2020/066705, which is incorporated herein by reference in its entirety).

As used herein, the term “permeable” refers to a property of a substance that allows certain materials to pass through the substance. “Permeable” may be used to describe a biological sample, such as a cell or nucleus, in which analytes in the biological sample can leave the biological sample. “Permeabilize” is an action taken to cause, for example, a biological sample (e.g., a cell) to release its analytes. In some examples, permeabilization of a biological sample is accomplished by affecting the integrity (e.g., compromising) of a biological sample membrane (e.g., a cellular or nuclear membrane) such as by application of a protease or other enzyme capable of disturbing a membrane allowing analytes to diffuse out of the biological sample. In some embodiments, permeabilizing a biological sample does not release the biomolecules (e.g., proteins and/or nucleic acids) contained within the sample.

As used herein, the term “single biological sample”, such as a single cell or a single nucleus generally refers to a biological sample that is not present in an aggregated form or clump. Single biological samples, such as cells and/or nuclei may be the result of dissociating a tissue sample.

As used herein, the term “tissue freezing” is used in accordance with its plain and ordinary meaning and refers to different methods for freezing tissues. In some examples, the methods used may be rapid methods (e.g., “flash freezing” or “snap freezing”). In some examples, tissues may be lowered to temperatures below about −70° C. using these methods. In some examples, rapid freezing may use ultracold media. In some examples, an ultracold medium may be liquid nitrogen. In some examples, this type of freezing may preserve tissue integrity, in part by preventing the formation of ice crystals that would affect the tissue morphology. In some examples, an ultracold medium may be dry ice.

As used herein, a “single cell” refers to one cell. Single cells useful in the methods described herein can be obtained from a tissue of interest, or from a biopsy, blood sample, or cell culture. Additionally, cells from specific organs, tissues, tumors, neoplasms, or the like can be obtained and used in the methods described herein. In general, cells from any population can be used in the methods, such as a population of prokaryotic or eukaryotic organisms, including bacteria or yeast.

As used herein, the term “tissue” is used in accordance with its plain and ordinary meaning and refers to an organization of cells in a structure, where the structure generally functions as a unit in an organism (e.g., mammals) and may carry out specific functions. In some examples, cells in a tissue are configured in a mass and may not be free from one another. This disclosure describes methods of obtaining single biological samples (e.g., cells or nuclei) from tissues that can be used in various single biological samples (e.g., single-cell/nucleus) workflows. In some examples, blood cells (e.g., lymphocytes) can be considered a tissue. However, blood cells, like lymphocytes, generally are free from one another in the blood. The methods disclosed herein can be used to process those cells to obtain cells and/or nuclei, although dissociation steps may not be necessary when using those types of tissues. Generally, any type of tissue can be used in the methods described herein. Examples of tissues that may be used in the disclosed methods include, but are not limited to connective, epithelial, muscle and nervous tissue. In some examples, the tissues are from mammals. Tissues that contain any type of cells may be used. For example, tissues from abdomen, bladder, brain, esophagus, heart, intestine, kidney, liver, lung, lymph node, olfactory bulb, ovary, pancreas, skin, spleen, stomach, testicle, and the like. The tissue may be normal or tumor tissue (e.g., malignant). This example is not meant to be limiting. Although the conditions used in the disclosed may not be identical for different types of tissue, the methods may be applied to any tissue. The tissues used in the disclosed methods may be in various states. In some examples, the tissues used in the disclosed methods may be fresh, frozen, or fixed.

The term “cellular component” is used in accordance with its ordinary meaning in the art and refers to any organelle, nucleic acid, protein, or analyte that is found in a prokaryotic, eukaryotic, archaeal, or other organismic cell type. Examples of cellular components (e.g., a component of a cell) include RNA transcripts, proteins, membranes, lipids, and other analytes. In embodiments, a cellular component is a biomolecule.

A “gene” refers to a polynucleotide that is capable of conferring biological function after being transcribed and/or translated.

As used herein, the term “kit” refers to any delivery system for delivering materials. In the context of reaction assays, such delivery systems include systems that allow for the storage, transport, or delivery of reaction reagents (e.g., oligonucleotides, enzymes, etc. in the appropriate containers) and/or supporting materials (e.g., buffers, written instructions for performing the assay, etc.) from one location to another. For example, kits include one or more enclosures (e.g., boxes) containing the relevant reaction reagents and/or supporting materials. As used herein, the term “fragmented kit” refers to a delivery system including two or more separate containers that each contain a subportion of the total kit components. The containers may be delivered to the intended recipient together or separately. For example, a first container may contain an enzyme for use in an assay, while a second container contains oligonucleotides. In contrast, a “combined kit” refers to a delivery system containing all of the components of a reaction assay in a single container (e.g., in a single box housing each of the desired components). The term “kit” includes both fragmented and combined kits.

As used herein the term “determine” can be used to refer to the act of ascertaining, establishing or estimating. A determination can be probabilistic. For example, a determination can have an apparent likelihood of at least 50%, 75%, 90%, 95%, 98%, 99%, 99.9% or higher. In some cases, a determination can have an apparent likelihood of 100%. An exemplary determination is a maximum likelihood analysis or report. As used herein, the term “identify,” when used in reference to a thing, can be used to refer to recognition of the thing, distinction of the thing from at least one other thing or categorization of the thing with at least one other thing. The recognition, distinction or categorization can be probabilistic. For example, a thing can be identified with an apparent likelihood of at least 50%, 75%, 90%, 950%, 98%, 99%, 99.9% or higher. A thing can be identified based on a result of a maximum likelihood analysis. In some cases, a thing can be identified with an apparent likelihood of 100%.

The terms “bioconjugate group,” “bioconjugate reactive moiety,” and “bioconjugate reactive group” refer to a chemical moiety which participates in a reaction to form a bioconjugate linker (e.g., covalent linker).

As used herein, the term “bioconjugate reactive moiety” and “bioconjugate reactive group” refers to a moiety or group capable of forming a bioconjugate (e.g., covalent linker) as a result of the association between atoms or molecules of bioconjugate reactive groups. The association can be direct or indirect. For example, a conjugate between a first bioconjugate reactive group (e.g., —NH2, —COOH, —N-hydroxysuccinimide, or -maleimide) and a second bioconjugate reactive group (e.g., sulfhydryl, sulfur-containing amino acid, amine, amine sidechain containing amino acid, or carboxylate) provided herein can be direct, e.g., by covalent bond or linker (e.g., a first linker of second linker), or indirect, e.g., by non-covalent bond (e.g., electrostatic interactions (e.g., ionic bond, hydrogen bond, halogen bond), van der Waals interactions (e.g., dipole-dipole, dipole-induced dipole, London dispersion), ring stacking (pi effects), hydrophobic interactions and the like). In embodiments, bioconjugates or bioconjugate linkers are formed using bioconjugate chemistry (i.e., the association of two bioconjugate reactive groups) including, but are not limited to nucleophilic substitutions (e.g, reactions of amines and alcohols with acyl halides, active esters), electrophilic substitutions (e.g., enamine reactions) and additions to carbon-carbon and carbon-heteroatom multiple bonds (e.g., Michael reaction, Diels-Alder addition). These and other useful reactions are discussed in, for example, March, ADVANCED ORGANIC CHEMISTRY, 3^{rd} Ed., John Wiley & Sons, New York, 1985; Hermanson, BIOCONJUGATE TECHNIQUES, Academic Press, San Diego, 1996; and Feeney et al., MODIFICATION OF PROTEINS; Advances in Chemistry Series, Vol. 198, American Chemical Society, Washington, D.C., 1982. In embodiments, the first bioconjugate reactive group (e.g., maleimide moiety) is covalently attached to the second bioconjugate reactive group (e.g., a sulfhydryl). In embodiments, the first bioconjugate reactive group (e.g., haloacetyl moiety) is covalently attached to the second bioconjugate reactive group (e.g., a sulfhydryl). In embodiments, the first bioconjugate reactive group (e.g., pyridyl moiety) is covalently attached to the second bioconjugate reactive group (e.g., a sulfhydryl). In embodiments, the first bioconjugate reactive group (e.g., —N-hydroxysuccinimide moiety) is covalently attached to the second bioconjugate reactive group (e.g., an amine). In embodiments, the first bioconjugate reactive group (e.g., maleimide moiety) is covalently attached to the second bioconjugate reactive group (e.g., a sulfhydryl). In embodiments, the first bioconjugate reactive group (e.g., -sulfo-N-hydroxysuccinimide moiety) is covalently attached to the second bioconjugate reactive group (e.g., an amine).

Useful bioconjugate reactive groups used for bioconjugate chemistries herein include, for example: (a) carboxyl groups and various derivatives thereof including, but not limited to, N-hydroxysuccinimide esters, N-hydroxybenztriazole esters, acid halides, acyl imidazoles, thioesters, p-nitrophenyl esters, alkyl, alkenyl, alkynyl and aromatic esters; (b) hydroxyl groups which can be converted to esters, ethers, aldehydes, etc.; (c) haloalkyl groups wherein the halide can be later displaced with a nucleophilic group such as, for example, an amine, a carboxylate anion, thiol anion, carbanion, or an alkoxide ion, thereby resulting in the covalent attachment of a new group at the site of the halogen atom; (d) dienophile groups which are capable of participating in Diels-Alder reactions such as, for example, maleimido or maleimide groups; (e) aldehyde or ketone groups such that subsequent derivatization is possible via formation of carbonyl derivatives such as, for example, imines, hydrazones, semicarbazones or oximes, or via such mechanisms as Grignard addition or alkyllithium addition; (f) sulfonyl halide groups for subsequent reaction with amines, for example, to form sulfonamides; (g) thiol groups, which can be converted to disulfides, reacted with acyl halides, or bonded to metals such as gold, or react with maleimides; (h) amine or sulfhydryl groups (e.g., present in cysteine), which can be, for example, acylated, alkylated or oxidized; (i) alkenes, which can undergo, for example, cycloadditions, acylation, Michael addition, etc.; (j) epoxides, which can react with, for example, amines and hydroxyl compounds; (k) phosphoramidites and other standard functional groups useful in nucleic acid synthesis; (l) metal silicon oxide bonding; (m) metal bonding to reactive phosphorus groups (e.g., phosphines) to form, for example, phosphate diester bonds; (n) azides coupled to alkynes using copper catalyzed cycloaddition click chemistry; (o) biotin conjugate can react with avidin or streptavidin to form a avidin-biotin complex or streptavidin-biotin complex.

The term “covalent linker” is used in accordance with its ordinary meaning and refers to a divalent moiety which connects at least two moieties to form a molecule.

The term “non-covalent linker” is used in accordance with its ordinary meaning and refers to a divalent moiety which includes at least two molecules that are not covalently linked to each other but are capable of interacting with each other via a non-covalent bond (e.g., electrostatic interactions (e.g., ionic bond, hydrogen bond, halogen bond) or van der Waals interactions (e.g., dipole-dipole, dipole-induced dipole, London dispersion). In embodiments, the non-covalent linker is the result of two molecules that are not covalently linked to each other that interact with each other via a non-covalent bond.

An “antibody” (Ab) is a protein that binds specifically to a particular substance, known as an “antigen” (Ag). An “antibody” or “antigen-binding fragment” is an immunoglobulin that binds a specific “epitope.” The term encompasses polyclonal, monoclonal, and chimeric antibodies. In nature, antibodies are generally produced by lymphocytes in response to immune challenge, such as by infection or immunization. An “antigen” (Ag) is any substance that reacts specifically with antibodies or T lymphocytes (T cells). An antibody may include the entire antibody as well as any antibody fragments capable of binding the antigen or antigenic fragment of interest. Examples include complete antibody molecules, antibody fragments, such as Fab, F(ab′)₂, CDRs, VL, VH, and any other portion of an antibody which is capable of specifically binding to an antigen. Antibodies used herein are immunospecific for, and therefore specifically and selectively bind to, for example, proteins either detected (e.g., biological targets of interest) or used for detection (e.g., probes containing oligonucleotide barcodes) in the methods and devices as described herein.

As used herein, the term “control” or “control experiment” is used in accordance with its plain and ordinary meaning and refers to an experiment in which the subjects, cells, tissues, or reagents of the experiment are treated as in a parallel experiment except for omission of a procedure, reagent, or variable of the experiment. In some instances, the control is used as a standard of comparison in evaluating experimental effects. In embodiments, a control cell is the same cell type as the cell being examined, wherein the control cell does not include the variable or is subjected to conditions being examined.

The term “image” is used according to its ordinary meaning and refers to a representation of all or part of an object. The representation may be an optically detected reproduction. For example, an image can be obtained from fluorescent, luminescent, scatter, or absorption signals. The part of the object that is present in an image can be the surface or other xy plane of the object. Typically, an image is a 2 dimensional representation of a 3 dimensional object. An image may include signals at differing intensities (i.e., signal levels). An image can be provided in a computer readable format or medium. An image is derived from the collection of focus points of light rays coming from an object (e.g., the sample), which may be detected by any image sensor.

As used herein, the term “signal” is intended to include, for example, fluorescent, luminescent, scatter, or absorption impulse or electromagnetic wave transmitted or received. Signals can be detected in the ultraviolet (UV) range (about 200 to 390 nm), visible (VIS) range (about 391 to 770 nm), infrared (IR) range (about 0.771 to 25 microns), or other range of the electromagnetic spectrum. The term “signal level” refers to an amount or quantity of detected energy or coded information. For example, a signal may be quantified by its intensity, wavelength, energy, frequency, power, luminance, or a combination thereof. Other signals can be quantified according to characteristics such as voltage, current, electric field strength, magnetic field strength, frequency, power, temperature, etc. Absence of signal is understood to be a signal level of zero or a signal level that is not meaningfully distinguished from noise.

The term “xy coordinates” refers to information that specifies location, size, shape, and/or orientation in an xy plane. The information can be, for example, numerical coordinates in a Cartesian system. The coordinates can be provided relative to one or both of the x and y axes or can be provided relative to another location in the xy plane (e.g., a fiducial). The term “xy plane” refers to a 2 dimensional area defined by straight line axes x and y. When used in reference to a detecting apparatus and an object observed by the detector, the xy plane may be specified as being orthogonal to the direction of observation between the detector and object being detected.

As used herein, the term “feature” refers a site (i.e., a physical location) in a tissue or cell on a solid support for one or more molecule(s). A feature can contain only a single molecule or it can contain a population of several molecules of the same species (i.e., a cluster). Features of an array are typically discrete. The discrete features can be contiguous, or they can have spaces between each other. An “optically resolved volume” refers to a three-dimensional region in a cell or tissue with a feature or plurality of features capable of being distinguished from other features.

The term “adhesion strength” or “attachment strength” as used herein refers to the interfacial force bonding two materials together. The adhesion strength may refer to the minimal amount of force necessary to detach and/or remove the two materials. Means for quantifying adhesion strength are known in the art, for example with a pull-off adhesion test. A pull-off adhesion test measures the resistance of a substance (e.g., a tissue sample) from a substrate (e.g., a carrier substrate) when a perpendicular tensile force is applied to the substance. As outlined in the American Society for Testing and Materials (ASTM) D4541 (and similarly in BS EN ISO 4624), the test may include attaching a test dolly to the substance (e.g., the tissue sample) and then pulling the dolly by exerting a force perpendicular to the surface in an effort to remove the dolly with the substance from the substrate. An alternative testing approach is outlined in ASTM D6677 which utilizes a utility knife to peel the substance away from the substrate and ASTM D3359 which uses a pressure sensitive tape. The peel strength tests employed for examining the strength of Band-Aid® bonds is provided in ASTM D903, ASTM D1876, and ASTM F2258, each of which are incorporated herein by reference and may be used for measuring the adhesion strength as described herein. Instruments for performing such measurements include the monotonic uniaxial tensile testing device provided by Bose® Biodynamic Test Instrument, Minnetonka, MN, for example by employing at a constant rate (e.g., 0.05 mm/sec) and continuously recording the load response (e.g., 200 measurements/sec) to the point of macroscopic failure, or the Avery Adhesive Test (AAT).

The term “port” is used in accordance with its plain ordinary meaning and refers to a designated entry or exit point on the device where fluids, gases, or other substances can be introduced into or removed from the microfluidic system. Ports are typically small and precise to accommodate the scaled-down dimensions of microfluidic channels and chambers. For example, the solid support may include an inlet port, that is, a port through which fluids (such as reagents, samples, or solvents) are introduced into the microfluidic device. The solid support may include an outlet port through which fluids exit the microfluidic device. In embodiments, the inlet and outlet ports are distinct and separate. In embodiments, the inlet port and the outlet ports are the same.

As used herein, the term “resected” or “resection” is used in accordance with its plain and ordinary meaning and refers to removal of part or all of a tissue or an organ from a subject, typically through surgical removal.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### II. Compositions & Kits

In an aspect is provided a flow cell assembly. In embodiments, the flow cell assembly includes a first solid support; a polymer attached to the first solid support; a coupling agent attached to the polymer; a cell or tissue attached to the coupling agent; a second solid support attached to the first solid support, wherein the second solid support is configured to define a reaction chamber. In embodiments, the polymer is a resist described herein. In embodiments, the polymer is indirectly attached to the first solid support by way of being in direct contact with one or more intermediate layers between the first solid support and the polymer. In embodiments, one or more intermediate layers between the first solid support and the polymer includes an infrared (IR) reflective coating (e.g., an infrared reflective coating described herein). In embodiments, the polymer is directly attached to the first solid support. In embodiments, the second solid support is configured to define a reaction chamber when attached to the first solid support.

In embodiments, the flow cell assembly includes a first solid support; a resist attached to the first solid support, wherein the resist is a polydimethylsiloxane (PDMS), poly(methyl methacrylate) (PMMA), cyclic olefin copolymer (COC), silsesquioxane resist, an epoxy-based polymer resist, poly(vinylpyrrolidone-vinyl acrylic acid) copolymer resist, an Off-stoichiometry thiol-enes (OSTE) resist, amorphous fluoropolymer resist, a crystalline fluoropolymer resist, polysiloxane resist, or an organically modified ceramic polymer resist a coupling agent attached to the resist; a cell or tissue attached to the coupling agent; a second solid support attached to the first solid support, wherein the second solid support is configured to define a reaction chamber when attached to the first solid support. In embodiments, the resist is indirectly attached to the first solid support by way of being in direct contact with one or more intermediate layers between the first solid support and the resist. In embodiments, one or more intermediate layers between the first solid support and the resist includes an infrared (IR) reflective coating (e.g., an infrared reflective coating described herein). In embodiments, the resist is directly attached to the first solid support.

In embodiments, the flow cell assembly includes a frame configured to retain the flow cell assembly. Suitable flow cell frames and handles are described in U.S. Pat. No. 11,747,262. The frame can be configured to retain the flow cell such that a maximal surface area of the flow cell can be available to be exposed to an optical lens (e.g., the optical lens of a nucleic acid sequencing device). The optical lens (e.g., the optical lens of the sequencing device) can be configured to detect excitation, emission, or other signals present on the flow cell. The frame can be configured to retain the flow cell such that a maximal surface area of the flow cell can be available to be in contact with the receiver of a nucleic acid sequencer. The retaining of the flow cell further can include constraining a first, a second, a third, a fourth, a fifth, and a sixth degree of freedom of the flow cell. The frame can be an injection molded frame. The handle can be a raised handle. The frame can be further configured to provide a gap between a work surface and the flow cell. The frame further can include at least one ferromagnetic pin. The at least one biasing feature can be a spring finger. The at least one biasing feature can be a tab. The flow cell can further include a microchip. The microchip can be an electronically erasable programmable read only memory (EEPROM) chip.

The solid supports for some embodiments have at least one surface located within a flow cell. Flow cells provide a convenient format for housing an array of clusters produced by the methods described herein, in particular when subjected to an SBS or other detection technique that involves repeated delivery of reagents in cycles.

In embodiments, the first solid support includes a glass substrate. In embodiments, the second solid support includes a glass substrate. In embodiments, the glass substrate is a borosilicate glass substrate with a composition including SiO₂, Al₂O₃, B₂O₃, Li₂O, Na₂O, K₂O, MgO, CaO, SrO, BaO, ZnO, TiO₂, ZrO₂, P₂O₅, or a combination thereof (see e.g., U.S. Pat. No. 10,974,990). In embodiments, the glass substrate is an alkaline earth boro-aluminosilicate glass substrate.

In embodiments, the first solid support includes one or more channel(s). In embodiments, the first solid support includes a channel bored into the first solid support. In embodiments, the first solid support includes a plurality of channels bored into the first solid support. In embodiments, the first solid support includes 2 channels bored into the first solid support. In embodiments, the first solid support includes 3 channels bored into the first solid support. In embodiments, the first solid support includes 4 channels bored into the first solid support. In embodiments, the width of the channel is from about 1 to 5 mm. In embodiments, the width of the channel is from about 5 to 10 mm. In embodiments, the width of the channel is from about 10 to 15 mm. In embodiments, the width of the channel is from about 5 mm. In embodiments, the width of the channel is from about 11 mm.

In embodiments, the second solid support includes one or more channel(s). In embodiments, the second solid support includes a channel bored into the second solid support. In embodiments, the second solid support includes a plurality of channels bored into the second solid support. In embodiments, the second solid support includes 2 channels bored into the second solid support. In embodiments, the second solid support includes 3 channels bored into the second solid support. In embodiments, the second solid support includes 4 channels bored into the second solid support. In embodiments, the width of the channel is from about 1 to 5 mm. In embodiments, the width of the channel is from about 5 to 10 mm. In embodiments, the width of the channel is from about 10 to 15 mm. In embodiments, the width of the channel is from about 5 mm. In embodiments, the width of the channel is from about 11 mm.

In embodiments, the second solid support includes a gasket, wherein the gasket defines the reaction chamber. In embodiments, the gasket is a spacer element or spacer described herein. In embodiments, the gasket defines a perimeter of a channel. In embodiments, the gasket defines a perimeter of two or more channels. In embodiments, the gasket includes silicone, polyimide, fluorocarbon elastomer, ethylene propylene diene, poly chloroprene, polytetrafluoroethylene, nitrile rubber, butyl rubber, natural rubber, thermoplastic elastomer, or a combination thereof. In embodiments, the second solid support includes a spacer element to form an offset surface. In embodiments, the second solid support includes one or more channels. The channel(s) may be formed by affixing a spacer element to create a defined gap or channel through which liquid can flow or be contained. The spacer element may be made of any suitable material, for example resin, glass, plastic, silicon, an adhesive, or a combination thereof. In embodiments, the spacer element includes a first adhesive in contact with the functionalized glass slide (e.g., a functionalized glass slide described herein) and second adhesive in contact with the second solid support. In embodiments, the spacer element includes a first adhesive in contact with the functionalized glass slide (e.g., a functionalized glass slide described herein), a second adhesive in contact with the second solid support, and a carrier material in contact with the first adhesive and the second adhesive. The depth of the resulting channel may be controlled by including a carrier material (e.g., one or more polymer or copolymer layers) between the adhesives. In embodiments, the spacer element may form the walls of the reaction chamber, wherein the reaction chamber includes the sample. In embodiments, the spacer element is further attached to the coupling agent attached the polymer of the first solid support. In embodiments, the gasket is referred to as a spacer element (e.g., see FIG. TA).

In embodiments, the flow cell assembly further includes 2, 3, 4, 5, 6, 7, 8, 9, 10, 11, or 12 reaction chambers (e.g., channels). In embodiments, the flow cell assembly includes 2 distinct reaction chambers (e.g., channels). In embodiments, the flow cell assembly includes 4 distinct reaction chambers (e.g., channels). In embodiments, each reaction chamber includes a depth of about 50 μm to about 150 μm. In embodiments, the reaction chamber includes a depth of about 80 μm to about 110 μm. In embodiments, the reaction chamber includes a width of about 4 μm to about 15 μm.

In embodiments, the reaction chamber is a channel on the flow cell. In embodiments, the channel includes a depth of about 50 μm to about 150 μm. In embodiments, the channel includes a depth of about 50 μm. In embodiments, the channel includes a depth of about 60 μm. In embodiments, the channel includes a depth of about 70 μm. In embodiments, the channel includes a depth of about 80 μm. In embodiments, the channel includes a depth of about 90 μm. In embodiments, the channel includes a depth of about 100 μm. In embodiments, the channel includes a depth of about 110 μm. In embodiments, the channel includes a depth of about 120 μm. In embodiments, the channel includes a depth of about 130 μm. In embodiments, the channel includes a depth of about 140 μm. In embodiments, the channel includes a depth of about 71 μm. In embodiments, the channel includes a depth of about 72 μm. In embodiments, the channel includes a depth of about 73 μm. In embodiments, the channel includes a depth of about 74 μm. In embodiments, the channel includes a depth of about 75 μm. In embodiments, the channel includes a depth of about 76 μm. In embodiments, the channel includes a depth of about 77 μm. In embodiments, the channel includes a depth of about 78 μm. In embodiments, the channel includes a depth of about 79 μm. In embodiments, the channel includes a depth of 50 μm to 150 μm. For example, the depth of the channel is illustrated in FIG. 1B, and may be referred to as the height of the channel or the distance between the first and second solid supports. In embodiments, the channel includes a depth of 50 μm. In embodiments, the channel includes a depth of 60 μm. In embodiments, the channel includes a depth of 70 μm. In embodiments, the channel includes a depth of 80 μm. In embodiments, the channel includes a depth of 90 μm. In embodiments, the channel includes a depth of 100 μm. In embodiments, the channel includes a depth of 110 μm. In embodiments, the channel includes a depth of 120 μm. In embodiments, the channel includes a depth of 130 μm. In embodiments, the channel includes a depth of 140 μm. In embodiments, the channel includes a depth of 150 μm. In embodiments, the channel includes a depth of 160 μm. In embodiments, the channel includes a depth of 170 μm. In embodiments, the channel includes a depth of 180 μm. In embodiments, the channel includes a depth of 190 μm. In embodiments, the channel includes a depth of 200 μm.

In embodiments, the tissue includes a thickness of about 1 μm to about 20 μm. In embodiments, the tissue includes a thickness of about 1 μm to about 10 μm. In embodiments, the tissue includes a thickness of about 2 μm to about 3 μm. In embodiments, the tissue includes a thickness of about 4 μm to about 6 μm. In embodiments, the tissue includes a thickness of about 4 μm. In embodiments, the tissue includes a thickness of about 5 μm. In embodiments, the tissue includes a thickness of about 6 μm. In embodiments, the tissue includes a thickness of about 7 μm. In embodiments, the tissue includes a thickness of about 8 μm. In embodiments, the tissue includes a thickness of about 9 μm. In embodiments, the tissue includes a thickness of about 10 μm.

In embodiments, the tissue section includes a tissue or a cell (e.g., a plurality of cells such as blood cells). In embodiments, the tissue section includes one or more cells. In embodiments, the tissue section is embedded in an embedding material including paraffin wax, polyepoxide polymer, polyacrylic polymer, agar, gelatin, celloidin, cryogel, optimal cutting temperature (OCT) compositions, glycols, or a combination thereof. In embodiments, the tissue section is embedded in an embedding material including paraffin wax. In embodiments, the tissue section is embedded in an embedding material including a polyepoxide polymer. In embodiments, the tissue section is embedded in an embedding material including polyacrylic polymer. In embodiments, the tissue section is embedded in an embedding material including agar. In embodiments, the tissue section is embedded in an embedding material including gelatin. In embodiments, the tissue section is embedded in an embedding material including celloidin. In embodiments, the tissue section is embedded in an embedding material including a cryogel. In embodiments, the tissue section is embedded in an embedding material including an optimal cutting temperature (OCT) compositions. In embodiments, the tissue section is embedded in an embedding material including one or more glycols. Tissue sections may be obtained from a subject by any means known and available in the art. In particular embodiments, a tissue section, e.g., a tumor tissue sample, is obtained from a subject by fine needle aspiration, core needle biopsy, stereotactic core needle biopsy, vacuum-assisted core biopsy, or surgical biopsy. In particular embodiments, the surgical biopsy is an incisional biopsy, which removes only part of the suspicious area.

In embodiments, the first solid support or the second solid support includes a port. In embodiments, the first solid support or the second solid support includes an inlet port and an outlet port. In embodiments, the first solid support includes an inlet port and an outlet port. In embodiments, the second solid support includes an inlet port and an outlet port. In embodiments, the first solid support includes an inlet port. In embodiments, the second solid support includes an inlet port. In embodiments, the first solid support includes an outlet port. In embodiments, the second solid support includes an outlet port. In embodiments, each port is about 50 to about 100 mm in diameter. In embodiments, each port is 50 to 100 mm in diameter. In embodiments, each port is about 50, 55, 60, 65, 70, 75, 80, 85, 90, 95, or 100 mm in diameter. In embodiments, each port is about 70, 75, or 80 mm in diameter. The size and shape of the inlet and outlet can be customized to suite various sequencing applications. For example, the size and shape can be determined based on the specific sequencing application(s), such as, a minimal flush volume, a contamination threshold, the parameters of the flow cell, e.g., the size of the flow cell channels, or the parameters of the dispenser, e.g., the size of the dispensing tip.

In embodiments, the first solid support includes a pressure sensitive adhesive (PSA) attached to a glass slide, wherein the glass slide includes inlet and outlet ports. In embodiments, first solid support includes a pressure sensitive adhesive (PSA) laminated to a glass slide, wherein the glass slide includes inlet and outlet ports. In embodiments, the second solid support is attached to the first solid support via a pressure sensitive adhesive (PSA). In embodiments, the second solid support includes a pressure sensitive adhesive (PSA) attached to a glass slide, wherein the glass slide includes inlet and outlet ports. In embodiments, second solid support includes a pressure sensitive adhesive (PSA) laminated to a glass slide, wherein the glass slide includes inlet and outlet ports. Each substrate (e.g., the first solid support, the second solid support, the pressure sensitive adhesive, the carrier, etc.) can have a predetermined thickness, and different substrate can have different thickness. In embodiments, each substrate can have a uniform thickness along the z direction. In embodiments, each substrate can have a uniform thickness along the z direction in at least a portion of the substrate. For example, the portion with uniform thickness can encompass the channel(s) or the imaging areas of the flow cell device. In embodiments, the pressure sensitive adhesive has a thickness of about 10 μm to about 100 μm. In embodiments, the pressure sensitive adhesive has a thickness of about 70 μm to about 100 μm. In embodiments, the pressure sensitive adhesive has a thickness of about 100 μm to about 200 μm. In embodiments, the pressure sensitive adhesive has a thickness of about 200 μm to about 500 μm. In embodiments, the pressure sensitive adhesive has a thickness of about 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, 100 μm, 101 μm, 102 μm, 103 μm, 104 μm, 105 μm, 106 μm, 107 μm, 108 μm, 109 μm, 110 μm, 111 μm, 112 μm, 113 μm, 114 μm, 115 μm, 116 μm, 117 μm, 118 μm, 119 μm, 120 μm, 121 μm, 122 μm, 123 μm, 124 μm, 125 μm, 126 μm, 127 μm, 128 μm, 129 μm, 130 μm, 131 μm, 132 μm, 133 μm, 134 μm, 135 μm, 136 μm, 137 μm, 138 μm, 139 μm, 140 μm, 141 μm, 142 μm, 143 μm, 144 μm, 145 μm, 146 μm, 147 μm, 148 μm, 149 μm, 150 μm or greater. In embodiments, the pressure sensitive adhesive has a thickness of about 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, 200 μm, 205 μm, 210 μm, 215 μm, 220 μm, 225 μm, 230 μm, 235 μm, 240 μm, 245 μm, 250 μm, or greater.

In embodiments, the pressure sensitive adhesive (PSA) includes to a first adhesive attached to a carrier polymer, where the carrier polymer is further attached to a second adhesive. In embodiments, the carrier polymer is between the first adhesive and the second adhesive. In embodiments, the adhesive includes an acrylic material. In embodiments, the adhesive includes rubber. In embodiments, the adhesive includes silicone. In embodiments, a variety of adhesive materials are utilized for fabricating leak-free chambers in a flow cell, each selected based on their unique properties and the specific requirements of the application. Acrylic-based adhesives are favored for their strong bond and resistance to environmental factors, while rubber-based adhesives are chosen for their flexibility and resilience in applications requiring movement. Silicone adhesives are notable for their high-temperature resistance and moisture-proof sealing capabilities. Epoxy resins offer unparalleled strength and chemical resistance, making them ideal for demanding industrial applications. Polyurethane adhesives, known for their balance of strength, flexibility, and chemical resistance, are versatile in bonding diverse materials. Lastly, cyanoacrylates, are valued for their rapid setting and strong bonding properties, essential for quick and reliable leak prevention.

In embodiments, the carrier structure includes polyimide, polyester (PET), polypropylene (PP), polyvinyl chloride (PVC), paper, acrylic foam, polyethylene foam, urethane foam, polyvinyl chloride form, glass, or a combination thereof. In embodiments, the carrier structure is a carrier polymer. In embodiments, the carrier polymer of the PSA includes polyester (PET). In embodiments, the carrier polymer of the PSA includes polyimide. In embodiments, the carrier polymer is chemically inert. In embodiments, the carrier polymer does not react with reagents used for sample preparation. In embodiments, the carrier polymer does not react with reagents used for amplification. In embodiments, the carrier polymer does not react with reagents used for sequencing. In embodiments, the carrier polymer does not react with reagents used for imaging. In embodiments, the carrier polymer does not react with reagents used for detection of the biomolecule of the tissue section or cell as described herein.

In embodiments, the first adhesive and second adhesive includes silicone and the carrier polymer includes polyimide. In embodiments, the first adhesive and second adhesive includes silicone and the carrier polymer includes polyester.

In embodiments, the adhesive has a thickness of about 10 μm to about 100 μm. In embodiments, the adhesive has a thickness of about 10 μm to about 30 μm. In embodiments, the adhesive has a thickness of about 30 μm to about 60 μm. In embodiments, the adhesive has a thickness of about 70 μm to about 100 μm. In embodiments, the adhesive has a thickness of about 100 μm to about 200 μm. In embodiments, the adhesive has a thickness of about 10 μm. In embodiments, the adhesive has a thickness of about 11 μm. In embodiments, the adhesive has a thickness of about 12 μm. In embodiments, the adhesive has a thickness of about 13 μm. In embodiments, the adhesive has a thickness of about 14 μm. In embodiments, the adhesive has a thickness of about 15 μm. In embodiments, the adhesive has a thickness of about 16 μm. In embodiments, the adhesive has a thickness of about 17 μm. In embodiments, the adhesive has a thickness of about 18 μm. In embodiments, the adhesive has a thickness of about 19 μm. In embodiments, the adhesive has a thickness of about 20 μm. In embodiments, the adhesive has a thickness of about 21 μm. In embodiments, the adhesive has a thickness of about 22 μm. In embodiments, the adhesive has a thickness of about 23 μm. In embodiments, the adhesive has a thickness of about 24 μm. In embodiments, the adhesive has a thickness of about 25 μm. In embodiments, the adhesive has a thickness of about 26 μm. In embodiments, the adhesive has a thickness of about 27 μm. In embodiments, the adhesive has a thickness of about 28 μm. In embodiments, the adhesive has a thickness of about 29 μm. In embodiments, the adhesive has a thickness of about 30 μm. In embodiments, the adhesive has a thickness of about 31 μm. In embodiments, the adhesive has a thickness of about 32 μm. In embodiments, the adhesive has a thickness of about 33 μm. In embodiments, the adhesive has a thickness of about 34 μm. In embodiments, the adhesive has a thickness of about 35 μm. In embodiments, the adhesive has a thickness of about 36 μm. In embodiments, the adhesive has a thickness of about 37 μm. In embodiments, the adhesive has a thickness of about 38 μm. In embodiments, the adhesive has a thickness of about 39 μm. In embodiments, the adhesive has a thickness of about 40 μm. In embodiments, the adhesive has a thickness of about 41 μm. In embodiments, the adhesive has a thickness of about 42 μm. In embodiments, the adhesive has a thickness of about 43 μm. In embodiments, the adhesive has a thickness of about 44 μm. In embodiments, the adhesive has a thickness of about 45 μm. In embodiments, the adhesive has a thickness of about 46 μm. In embodiments, the adhesive has a thickness of about 47 μm. In embodiments, the adhesive has a thickness of about 48 μm. In embodiments, the adhesive has a thickness of about 49 μm. In embodiments, the adhesive has a thickness of about 50 μm. In embodiments, the adhesive has a thickness of about 51 μm. In embodiments, the adhesive has a thickness of about 52 μm. In embodiments, the adhesive has a thickness of about 53 μm. In embodiments, the adhesive has a thickness of about 54 μm. In embodiments, the adhesive has a thickness of about 55 μm. In embodiments, the adhesive has a thickness of about 56 μm. In embodiments, the adhesive has a thickness of about 57 μm. In embodiments, the adhesive has a thickness of about 58 μm. In embodiments, the adhesive has a thickness of about 59 μm. In embodiments, the adhesive has a thickness of about 60 μm. In embodiments, the adhesive has a thickness of about 61 μm. In embodiments, the adhesive has a thickness of about 62 μm. In embodiments, the adhesive has a thickness of about 63 μm. In embodiments, the adhesive has a thickness of about 64 μm. In embodiments, the adhesive has a thickness of about 65 μm. In embodiments, the adhesive has a thickness of about 66 μm. In embodiments, the adhesive has a thickness of about 67 μm. In embodiments, the adhesive has a thickness of about 68 μm. In embodiments, the adhesive has a thickness of about 69 μm. In embodiments, the adhesive has a thickness of about 70 μm. In embodiments, the adhesive has a thickness of about 71 μm. In embodiments, the adhesive has a thickness of about 72 μm. In embodiments, the adhesive has a thickness of about 73 μm. In embodiments, the adhesive has a thickness of about 74 μm. In embodiments, the adhesive has a thickness of about 75 μm. In embodiments, the adhesive has a thickness of about 76 μm. In embodiments, the adhesive has a thickness of about 77 μm. In embodiments, the adhesive has a thickness of about 78 μm. In embodiments, the adhesive has a thickness of about 79 μm. In embodiments, the adhesive has a thickness of about 80 μm. In embodiments, the adhesive has a thickness of about 81 μm. In embodiments, the adhesive has a thickness of about 82 μm. In embodiments, the adhesive has a thickness of about 83 μm. In embodiments, the adhesive has a thickness of about 84 μm. In embodiments, the adhesive has a thickness of about 85 μm. In embodiments, the adhesive has a thickness of about 86 μm. In embodiments, the adhesive has a thickness of about 87 μm. In embodiments, the adhesive has a thickness of about 88 μm. In embodiments, the adhesive has a thickness of about 89 μm. In embodiments, the adhesive has a thickness of about 90 μm. In embodiments, the adhesive has a thickness of about 91 μm. In embodiments, the adhesive has a thickness of about 92 μm. In embodiments, the adhesive has a thickness of about 93 μm. In embodiments, the adhesive has a thickness of about 94 μm. In embodiments, the adhesive has a thickness of about 95 μm. In embodiments, the adhesive has a thickness of about 96 μm. In embodiments, the adhesive has a thickness of about 97 μm. In embodiments, the adhesive has a thickness of about 98 μm. In embodiments, the adhesive has a thickness of about 99 μm. In embodiments, the adhesive has a thickness of about 100 μm.

In embodiments, the adhesive has a thickness of about 100 μm to about 200 μm. In embodiments, the adhesive has a thickness of about 101 μm, 102 μm, 103 μm, 104 μm, 105 μm, 106 μm, 107 μm, 108 μm, 109 μm, 110 μm, 111 μm, 112 μm, 113 μm, 114 μm, 115 μm, 116 μm, 117 μm, 118 μm, 119 μm, 120 μm, 121 μm, 122 μm, 123 μm, 124 μm, 125 μm, 126 μm, 127 μm, 128 μm, 129 μm, 130 μm, 131 μm, 132 μm, 133 μm, 134 μm, 135 μm, 136 μm, 137 μm, 138 μm, 139 μm, 140 μm, 141 μm, 142 μm, 143 μm, 144 μm, 145 μm, 146 μm, 147 μm, 148 μm, 149 μm, 150 μm, 151 μm, 152 μm, 153 μm, 154 μm, 155 μm, 156 μm, 157 μm, 158 μm, 159 μm, 160 μm, 161 μm, 162 μm, 163 μm, 164 μm, 165 μm, 166 μm, 167 μm, 168 μm, 169 μm, 170 μm, 171 μm, 172 μm, 173 μm, 174 μm, 175 μm, 176 μm, 177 μm, 178 μm, 179 μm, 180 μm, 181 μm, 182 μm, 183 μm, 184 μm, 185 μm, 186 μm, 187 μm, 188 μm, 189 μm, 190 μm, 191 μm, 192 μm, 193 μm, 194 μm, 195 μm, 196 μm, 197 μm, 198 μm, 199 μm, or 200 μm.

In embodiments, the carrier has a thickness of about 10 μm to about 100 μm. In embodiments, the carrier has a thickness of about 10 μm to about 30 μm. In embodiments, the carrier has a thickness of about 30 μm to about 60 μm. In embodiments, the carrier has a thickness of about 70 μm to about 100 μm. In embodiments, the carrier has a thickness of about 100 μm to about 200 μm. In embodiments, the carrier has a thickness of about 10 μm. In embodiments, the carrier has a thickness of about 11 μm. In embodiments, the carrier has a thickness of about 12 μm. In embodiments, the carrier has a thickness of about 13 μm. In embodiments, the carrier has a thickness of about 14 μm. In embodiments, the carrier has a thickness of about 15 μm. In embodiments, the carrier has a thickness of about 16 μm. In embodiments, the carrier has a thickness of about 17 μm. In embodiments, the carrier has a thickness of about 18 μm. In embodiments, the carrier has a thickness of about 19 μm. In embodiments, the carrier has a thickness of about 20 μm. In embodiments, the carrier has a thickness of about 21 μm. In embodiments, the carrier has a thickness of about 22 μm. In embodiments, the carrier has a thickness of about 23 μm. In embodiments, the carrier has a thickness of about 24 μm. In embodiments, the carrier has a thickness of about 25 μm. In embodiments, the carrier has a thickness of about 26 μm. In embodiments, the carrier has a thickness of about 27 μm. In embodiments, the carrier has a thickness of about 28 μm. In embodiments, the carrier has a thickness of about 29 μm. In embodiments, the carrier has a thickness of about 30 μm. In embodiments, the carrier has a thickness of about 31 μm. In embodiments, the carrier has a thickness of about 32 μm. In embodiments, the carrier has a thickness of about 33 μm. In embodiments, the carrier has a thickness of about 34 μm. In embodiments, the carrier has a thickness of about 35 μm. In embodiments, the carrier has a thickness of about 36 μm. In embodiments, the carrier has a thickness of about 37 μm. In embodiments, the carrier has a thickness of about 38 μm. In embodiments, the carrier has a thickness of about 39 μm. In embodiments, the carrier has a thickness of about 40 μm. In embodiments, the carrier has a thickness of about 41 μm. In embodiments, the carrier has a thickness of about 42 μm. In embodiments, the carrier has a thickness of about 43 μm. In embodiments, the carrier has a thickness of about 44 μm. In embodiments, the carrier has a thickness of about 45 μm. In embodiments, the carrier has a thickness of about 46 μm. In embodiments, the carrier has a thickness of about 47 μm. In embodiments, the carrier has a thickness of about 48 μm. In embodiments, the carrier has a thickness of about 49 μm. In embodiments, the carrier has a thickness of about 50 μm. In embodiments, the carrier has a thickness of about 51 μm. In embodiments, the carrier has a thickness of about 52 μm. In embodiments, the carrier has a thickness of about 53 μm. In embodiments, the carrier has a thickness of about 54 μm. In embodiments, the carrier has a thickness of about 55 μm. In embodiments, the carrier has a thickness of about 56 μm. In embodiments, the carrier has a thickness of about 57 μm. In embodiments, the carrier has a thickness of about 58 μm. In embodiments, the carrier has a thickness of about 59 μm. In embodiments, the carrier has a thickness of about 60 μm. In embodiments, the carrier has a thickness of about 61 μm. In embodiments, the carrier has a thickness of about 62 μm. In embodiments, the carrier has a thickness of about 63 μm. In embodiments, the carrier has a thickness of about 64 μm. In embodiments, the carrier has a thickness of about 65 μm. In embodiments, the carrier has a thickness of about 66 μm. In embodiments, the carrier has a thickness of about 67 μm. In embodiments, the carrier has a thickness of about 68 μm. In embodiments, the carrier has a thickness of about 69 μm. In embodiments, the carrier has a thickness of about 70 μm. In embodiments, the carrier has a thickness of about 71 μm. In embodiments, the carrier has a thickness of about 72 μm. In embodiments, the carrier has a thickness of about 73 μm. In embodiments, the carrier has a thickness of about 74 μm. In embodiments, the carrier has a thickness of about 75 μm. In embodiments, the carrier has a thickness of about 76 μm. In embodiments, the carrier has a thickness of about 77 μm. In embodiments, the carrier has a thickness of about 78 μm. In embodiments, the carrier has a thickness of about 79 μm. In embodiments, the carrier has a thickness of about 80 μm. In embodiments, the carrier has a thickness of about 81 μm. In embodiments, the carrier has a thickness of about 82 μm. In embodiments, the carrier has a thickness of about 83 μm. In embodiments, the carrier has a thickness of about 84 μm. In embodiments, the carrier has a thickness of about 85 μm. In embodiments, the carrier has a thickness of about 86 μm. In embodiments, the carrier has a thickness of about 87 μm. In embodiments, the carrier has a thickness of about 88 μm. In embodiments, the carrier has a thickness of about 89 μm. In embodiments, the carrier has a thickness of about 90 μm. In embodiments, the carrier has a thickness of about 91 μm. In embodiments, the carrier has a thickness of about 92 μm. In embodiments, the carrier has a thickness of about 93 μm. In embodiments, the carrier has a thickness of about 94 μm. In embodiments, the carrier has a thickness of about 95 μm. In embodiments, the carrier has a thickness of about 96 μm. In embodiments, the carrier has a thickness of about 97 μm. In embodiments, the carrier has a thickness of about 98 μm. In embodiments, the carrier has a thickness of about 99 μm. In embodiments, the carrier has a thickness of about 100 μm.

In embodiments, the carrier has a thickness of about 100 μm to about 200 μm. In embodiments, the carrier has a thickness of about 101 μm, 102 μm, 103 μm, 104 μm, 105 μm, 106 μm, 107 μm, 108 μm, 109 μm, 110 μm, 111 μm, 112 μm, 113 μm, 114 μm, 115 μm, 116 μm, 117 μm, 118 μm, 119 μm, 120 μm, 121 μm, 122 μm, 123 μm, 124 μm, 125 μm, 126 μm, 127 μm, 128 μm, 129 μm, 130 μm, 131 μm, 132 μm, 133 μm, 134 μm, 135 μm, 136 μm, 137 μm, 138 μm, 139 μm, 140 μm, 141 μm, 142 μm, 143 μm, 144 μm, 145 μm, 146 μm, 147 μm, 148 μm, 149 μm, 150 μm, 151 μm, 152 μm, 153 μm, 154 μm, 155 μm, 156 μm, 157 μm, 158 μm, 159 μm, 160 μm, 161 μm, 162 μm, 163 μm, 164 μm, 165 μm, 166 μm, 167 μm, 168 μm, 169 μm, 170 μm, 171 μm, 172 μm, 173 μm, 174 μm, 175 μm, 176 μm, 177 μm, 178 μm, 179 μm, 180 μm, 181 μm, 182 μm, 183 μm, 184 μm, 185 μm, 186 μm, 187 μm, 188 μm, 189 μm, 190 μm, 191 μm, 192 μm, 193 μm, 194 μm, 195 μm, 196 μm, 197 μm, 198 μm, 199 μm, or 200 μm.

In embodiments, the spacer element (e.g., the combination of the first adhesive, carrier polymer, and second adhesive) has a total thickness of about 50 μm to about 150 μm. In embodiments, the spacer element including the first adhesive, carrier polymer, and second adhesive has a total thickness of about 50 μm to about 60 μm. In embodiments, the spacer element including the first adhesive, carrier polymer, and second adhesive has a total thickness of about 60 μm to about 70 μm. In embodiments, the spacer element including the first adhesive, carrier polymer, and second adhesive has a total thickness of about 70 μm to about 80 μm. In embodiments, the spacer element including the first adhesive, carrier polymer, and second adhesive has a total thickness of about 80 μm to about 90 μm. In embodiments, the spacer element including the first adhesive, carrier polymer, and second adhesive has a total thickness of about 90 μm to about 100 μm. In embodiments, the spacer element including the first adhesive, carrier polymer, and second adhesive has a total thickness of about 100 μm to about 110 μm. In embodiments, the spacer element including the first adhesive layer, carrier polymer, and second adhesive has a total thickness of about 110 μm to about 120 μm. In embodiments, the spacer element including the first adhesive, carrier polymer, and second adhesive has a total thickness of about 120 μm to about 130 μm. In embodiments, the spacer element including the first adhesive, carrier polymer, and second adhesive has a total thickness of about 130 m to about 140 μm. In embodiments, the spacer element including the first adhesive, carrier polymer, and second adhesive has a total thickness of about 140 μm to about 150 μm. In embodiments, the spacer element (e.g., the combination of the first adhesive, carrier polymer, and second adhesive) has a total thickness of about 70 μm. In embodiments, the spacer element (e.g., the combination of the first adhesive, carrier polymer, and second adhesive) has a total thickness of about 71 μm. In embodiments, the spacer element (e.g., the combination of the first adhesive, carrier polymer, and second adhesive) has a total thickness of about 72 μm. In embodiments, the spacer element (e.g., the combination of the first adhesive, carrier polymer, and second adhesive) has a total thickness of about 73 μm. In embodiments, the spacer element (e.g., the combination of the first adhesive, carrier polymer, and second adhesive) has a total thickness of about 74 μm. In embodiments, the spacer element (e.g., the combination of the first adhesive, carrier polymer, and second adhesive) has a total thickness of about 75 μm. In embodiments, the spacer element (e.g., the combination of the first adhesive, carrier polymer, and second adhesive) has a total thickness of about 76 μm. In embodiments, the spacer element (e.g., the combination of the first adhesive, carrier polymer, and second adhesive) has a total thickness of about 77 μm. In embodiments, the spacer element (e.g., the combination of the first adhesive, carrier polymer, and second adhesive) has a total thickness of about 78 μm. In embodiments, the spacer element (e.g., the combination of the first adhesive, carrier polymer, and second adhesive) has a total thickness of about 79 μm. In embodiments, the spacer element (e.g., the combination of the first adhesive, carrier polymer, and second adhesive) has a total thickness of about 80 μm. In embodiments, the spacer element (e.g., the combination of the first adhesive, carrier polymer, and second adhesive) has a total thickness of about 81 μm. In embodiments, the spacer element (e.g., the combination of the first adhesive, carrier polymer, and second adhesive) has a total thickness of about 82 μm. In embodiments, the spacer element (e.g., the combination of the first adhesive, carrier polymer, and second adhesive) has a total thickness of about 83 μm. In embodiments, the spacer element (e.g., the combination of the first adhesive, carrier polymer, and second adhesive) has a total thickness of about 84 μm. In embodiments, the spacer element (e.g., the combination of the first adhesive, carrier polymer, and second adhesive) has a total thickness of about 85 μm. In embodiments, the spacer element (e.g., the combination of the first adhesive, carrier polymer, and second adhesive) has a total thickness of about 86 μm. In embodiments, the spacer element (e.g., the combination of the first adhesive, carrier polymer, and second adhesive) has a total thickness of about 87 μm. In embodiments, the spacer element (e.g., the combination of the first adhesive, carrier polymer, and second adhesive) has a total thickness of about 88 μm. In embodiments, the spacer element (e.g., the combination of the first adhesive, carrier polymer, and second adhesive) has a total thickness of about 89 μm. In embodiments, the spacer element (e.g., the combination of the first adhesive, carrier polymer, and second adhesive) has a total thickness of about 90 μm. In embodiments, the spacer element (e.g., the combination of the first adhesive, carrier polymer, and second adhesive) has a total thickness of about 91 μm. In embodiments, the spacer element (e.g., the combination of the first adhesive, carrier polymer, and second adhesive) has a total thickness of about 92 μm. In embodiments, the spacer element (e.g., the combination of the first adhesive, carrier polymer, and second adhesive) has a total thickness of about 93 μm. In embodiments, the spacer element (e.g., the combination of the first adhesive, carrier polymer, and second adhesive) has a total thickness of about 94 μm. In embodiments, the spacer element (e.g., the combination of the first adhesive, carrier polymer, and second adhesive) has a total thickness of about 95 μm. In embodiments, the spacer element (e.g., the combination of the first adhesive, carrier polymer, and second adhesive) has a total thickness of about 96 μm. In embodiments, the spacer element (e.g., the combination of the first adhesive, carrier polymer, and second adhesive) has a total thickness of about 97 μm. In embodiments, the spacer element (e.g., the combination of the first adhesive, carrier polymer, and second adhesive) has a total thickness of about 98 μm. In embodiments, the spacer element (e.g., the combination of the first adhesive, carrier polymer, and second adhesive) has a total thickness of about 99 μm. In embodiments, the spacer element (e.g., the combination of the first adhesive, carrier polymer, and second adhesive) has a total thickness of about 100 μm. In embodiments, the spacer element (e.g., the combination of the first adhesive, carrier polymer, and second adhesive) has a total thickness of about 101 μm. In embodiments, the spacer element (e.g., the combination of the first adhesive, carrier polymer, and second adhesive) has a total thickness of about 102 μm. In embodiments, the spacer element (e.g., the combination of the first adhesive, carrier polymer, and second adhesive) has a total thickness of about 103 μm. In embodiments, the spacer element (e.g., the combination of the first adhesive, carrier polymer, and second adhesive) has a total thickness of about 104 μm. In embodiments, the spacer element (e.g., the combination of the first adhesive, carrier polymer, and second adhesive) has a total thickness of about 105 μm. In embodiments, the spacer element (e.g., the combination of the first adhesive, carrier polymer, and second adhesive) has a total thickness of about 106 μm. In embodiments, the spacer element (e.g., the combination of the first adhesive, carrier polymer, and second adhesive) has a total thickness of about 107 μm. In embodiments, the spacer element (e.g., the combination of the first adhesive, carrier polymer, and second adhesive) has a total thickness of about 108 μm. In embodiments, the spacer element (e.g., the combination of the first adhesive, carrier polymer, and second adhesive) has a total thickness of about 109 μm. In embodiments, the spacer element (e.g., the combination of the first adhesive, carrier polymer, and second adhesive) has a total thickness of about 110 μm. In embodiments, the spacer element (e.g., the combination of the first adhesive, carrier polymer, and second adhesive) has a total thickness of about 111 μm. In embodiments, the spacer element (e.g., the combination of the first adhesive, carrier polymer, and second adhesive) has a total thickness of about 112 μm. In embodiments, the spacer element (e.g., the combination of the first adhesive, carrier polymer, and second adhesive) has a total thickness of about 113 μm. In embodiments, the spacer element (e.g., the combination of the first adhesive, carrier polymer, and second adhesive) has a total thickness of about 114 μm. In embodiments, the spacer element (e.g., the combination of the first adhesive, carrier polymer, and second adhesive) has a total thickness of about 115 μm. In embodiments, the spacer element (e.g., the combination of the first adhesive, carrier polymer, and second adhesive) has a total thickness of about 116 μm. In embodiments, the spacer element (e.g., the combination of the first adhesive, carrier polymer, and second adhesive) has a total thickness of about 117 μm. In embodiments, the spacer element (e.g., the combination of the first adhesive, carrier polymer, and second adhesive) has a total thickness of about 118 μm. In embodiments, the spacer element (e.g., the combination of the first adhesive, carrier polymer, and second adhesive) has a total thickness of about 119 μm. In embodiments, the spacer element (e.g., the combination of the first adhesive, carrier polymer, and second adhesive) has a total thickness of about 120 μm. In embodiments, the spacer element (e.g., the combination of the first adhesive, carrier polymer, and second adhesive) has a total thickness of about 121 μm. In embodiments, the spacer element (e.g., the combination of the first adhesive, carrier polymer, and second adhesive) has a total thickness of about 122 μm. In embodiments, the spacer element (e.g., the combination of the first adhesive, carrier polymer, and second adhesive) has a total thickness of about 123 μm. In embodiments, the spacer element (e.g., the combination of the first adhesive, carrier polymer, and second adhesive) has a total thickness of about 124 μm. In embodiments, the spacer element (e.g., the combination of the first adhesive, carrier polymer, and second adhesive) has a total thickness of about 125 μm. In embodiments, the spacer element (e.g., the combination of the first adhesive, carrier polymer, and second adhesive) has a total thickness of about 126 μm. In embodiments, the spacer element (e.g., the combination of the first adhesive, carrier polymer, and second adhesive) has a total thickness of about 127 μm. In embodiments, the spacer element (e.g., the combination of the first adhesive, carrier polymer, and second adhesive) has a total thickness of about 128 μm. In embodiments, the spacer element (e.g., the combination of the first adhesive, carrier polymer, and second adhesive) has a total thickness of about 129 μm. In embodiments, the spacer element (e.g., the combination of the first adhesive, carrier polymer, and second adhesive) has a total thickness of about 130 μm. In embodiments, the spacer element (e.g., the combination of the first adhesive, carrier polymer, and second adhesive) has a total thickness of about 131 μm. In embodiments, the spacer element (e.g., the combination of the first adhesive, carrier polymer, and second adhesive) has a total thickness of about 132 μm. In embodiments, the spacer element (e.g., the combination of the first adhesive, carrier polymer, and second adhesive) has a total thickness of about 133 μm. In embodiments, the spacer element (e.g., the combination of the first adhesive, carrier polymer, and second adhesive) has a total thickness of about 134 μm. In embodiments, the spacer element (e.g., the combination of the first adhesive, carrier polymer, and second adhesive) has a total thickness of about 135 μm. In embodiments, the spacer element (e.g., the combination of the first adhesive, carrier polymer, and second adhesive) has a total thickness of about 136 μm. In embodiments, the spacer element (e.g., the combination of the first adhesive, carrier polymer, and second adhesive) has a total thickness of about 137 μm. In embodiments, the spacer element (e.g., the combination of the first adhesive, carrier polymer, and second adhesive) has a total thickness of about 138 μm. In embodiments, the spacer element (e.g., the combination of the first adhesive, carrier polymer, and second adhesive) has a total thickness of about 139 μm. In embodiments, the spacer element (e.g., the combination of the first adhesive, carrier polymer, and second adhesive) has a total thickness of about 140 μm. In embodiments, the spacer element (e.g., the combination of the first adhesive, carrier polymer, and second adhesive) has a total thickness of about 141 μm. In embodiments, the spacer element (e.g., the combination of the first adhesive, carrier polymer, and second adhesive) has a total thickness of about 142 μm. In embodiments, the spacer element (e.g., the combination of the first adhesive, carrier polymer, and second adhesive) has a total thickness of about 143 μm. In embodiments, the spacer element (e.g., the combination of the first adhesive, carrier polymer, and second adhesive) has a total thickness of about 144 μm. In embodiments, the spacer element (e.g., the combination of the first adhesive, carrier polymer, and second adhesive) has a total thickness of about 145 μm. In embodiments, the spacer element (e.g., the combination of the first adhesive, carrier polymer, and second adhesive) has a total thickness of about 146 μm. In embodiments, the spacer element (e.g., the combination of the first adhesive, carrier polymer, and second adhesive) has a total thickness of about 147 μm. In embodiments, the spacer element (e.g., the combination of the first adhesive, carrier polymer, and second adhesive) has a total thickness of about 148 μm. In embodiments, the spacer element (e.g., the combination of the first adhesive, carrier polymer, and second adhesive) has a total thickness of about 149 μm. In embodiments, the spacer element (e.g., the combination of the first adhesive, carrier polymer, and second adhesive) has a total thickness of about 150 μm.

In embodiments, the spacer element (e.g., the combination of the first adhesive, carrier polymer, and second adhesive) has a total thickness of about 150 μm to about 300 μm. In embodiments, the spacer element (e.g., the combination of the first adhesive, carrier polymer, and second adhesive) has a total thickness of about 151 μm, about 152 μm, about 153 μm, about 154 μm, about 155 μm, about 156 μm, about 157 μm, about 158 μm, about 159 μm, about 160 μm, about 161 μm, about 162 μm, about 163 μm, about 164 μm, about 165 μm, about 166 μm, about 167 μm, about 168 μm, about 169 μm, about 170 μm, about 171 μm, about 172 μm, about 173 μm, about 174 μm, about 175 μm, about 176 μm, about 177 μm, about 178 μm, about 179 μm, about 180 μm, about 181 μm, about 182 μm, about 183 μm, about 184 μm, about 185 μm, about 186 μm, about 187 μm, about 188 μm, about 189 μm, about 190 μm, about 191 μm, about 192 μm, about 193 μm, about 194 μm, about 195 μm, about 196 μm, about 197 μm, about 198 μm, about 199 μm, about 200 μm, about 201 μm, about 202 μm, about 203 μm, about 204 μm, about 205 μm, about 206 μm, about 207 μm, about 208 μm, about 209 μm, about 210 μm, about 211 μm, about 212 μm, about 213 μm, about 214 μm, about 215 μm, about 216 μm, about 217 μm, about 218 μm, about 219 μm, about 220 μm, about 221 μm, about 222 μm, about 223 μm, about 224 μm, about 225 μm, about 226 μm, about 227 μm, about 228 μm, about 229 μm, about 230 μm, about 231 μm, about 232 μm, about 233 μm, about 234 μm, about 235 μm, about 236 μm, about 237 μm, about 238 μm, about 239 μm, about 240 μm, about 241 μm, about 242 μm, about 243 μm, about 244 μm, about 245 μm, about 246 μm, about 247 μm, about 248 μm, about 249 μm, about 250 μm, about 251 μm, about 252 μm, about 253 μm, about 254 μm, about 255 μm, about 256 μm, about 257 μm, about 258 μm, about 259 μm, about 260 μm, about 261 μm, about 262 μm, about 263 μm, about 264 μm, about 265 μm, about 266 μm, about 267 μm, about 268 μm, about 269 μm, about 270 μm, about 271 μm, about 272 μm, about 273 μm, about 274 μm, about 275 μm, about 276 μm, about 277 μm, about 278 μm, about 279 μm, about 280 μm, about 281 μm, about 282 μm, about 283 μm, about 284 μm, about 285 μm, about 286 μm, about 287 μm, about 288 μm, about 289 μm, about 290 μm, about 291 μm, about 292 μm, about 293 μm, about 294 μm, about 295 μm, about 296 μm, about 297 μm, about 298 μm, about 299 μm, or about 300 μm.

In embodiments, the spacer element is a pressure sensitive adhesive (PSA). In embodiments, the PSA is attached to the first solid support and second solid support, and the distance between the first solid support and second solid support is between about 50 μm to about 120 μm. In embodiments, the distance between the first solid support and second solid support is between about 60 μm to about 70 μm. In embodiments, the distance between the first solid support and second solid support is about 70 μm to about 80 μm. In embodiments, the distance between the first solid support and second solid support is about 80 μm to about 90 μm. In embodiments, the distance between the first solid support and second solid support is about 90 μm to about 100 μm.

In embodiments, the spacer element is a pressure sensitive adhesive (PSA). In embodiments, the PSA is attached to the first solid support and second solid support, and the distance between the first solid support and second solid support is between about 50 μm, about 60 μm, about 70 μm, about 80 μm, about 90 μm, about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, about 250 μm, about 260 μm, about 270 μm, about 280 μm, about 290 μm, about 300 μm, about 310 μm, about 320 μm, about 330 μm, about 340 μm, about 350 μm, about 360 μm, about 370 μm, about 380 μm, about 390 μm, about 400 μm, about 410 μm, about 420 μm, about 430 μm, about 440 μm, about 450 μm, about 460 μm, about 470 μm, about 480 μm, about 490 μm, or about 500 μm.

In embodiments, the first solid support includes a plurality of channels etched in glass that is capable of being in contact with a UV-curable adhesive. In embodiments, the second solid support includes a plurality of channels etched in glass that is capable of being in contact with a UV-curable adhesive. A UV-curable adhesive is an adhesive that hardens or sets when exposed to ultraviolet light. In embodiments, the UV-curing adhesive cures when exposed to wavelengths between about 365 nm to about 405 nm. In embodiments, the UV-curing adhesive cures when exposed to wavelength of about 405 nm. In embodiments, the UV-curable adhesive is chemically compatible with glass. The UV-curing adhesive includes a mixture of photo-initiator that, upon exposure to UV light, initiates a polymerization reaction that converts the liquid adhesive into a solid polymer, resulting in a rapid curing process. In embodiments, use of a UV-curing adhesive on the first solid support provides channel depth consistency and a leak-free seal. In embodiments, use of a UV-curing adhesive on the second solid support provides channel depth consistency and a leak-free seal.

In embodiments, the first solid support or the second solid support further includes an infrared (IR) reflective coating. In embodiments, the first solid support further includes an IR reflective coating. In embodiments, the second solid support further includes an IR reflective coating. In embodiments, the IR reflective coating is attached to the first solid support. In embodiments, the IR reflective coating is attached to the first solid support, wherein the IR reflective coating is in contact with the polymer or resist described herein. In embodiments, the IR reflective coating is attached to the second solid support. In embodiments, the IR reflective coating includes metal oxides. In embodiments, the IR reflective coating includes titanium dioxide, zinc oxide, tin oxide, tantalum pentoxide, silicon dioxide, indium tin oxide, silver-based coating, ceramic-based coating or a combination thereof. In embodiments, the IR reflective coating includes SiO₂, TiO₂, Al₂O₃ and Ta₂O₅ and fluorides such as MgF₂, LaF₃ and AlF₃. In embodiments, the IR reflective coating includes tantalum pentoxide (Ta₂O₅) and silicon dioxide (SiO₂). In embodiments, the infrared (IR) reflective coating includes one or more layers of silicon dioxide (SiO₂) and tantalum pentoxide (Ta₂O₅). In embodiments, the infrared (IR) reflective coating includes alternating layers of silicon dioxide (SiO₂) and tantalum pentoxide (Ta₂O₅), wherein the layer of silicon dioxide (SiO₂) is in direct or indirect contact with the polymer (e.g., the polymer described herein) or resist (e.g., a resist described herein). In embodiments, the infrared (IR) reflective coating includes alternating layers of silicon dioxide (SiO₂) and tantalum pentoxide (Ta₂O₅), wherein the layer of tantalum pentoxide (Ta₂O₅) is in direct or indirect contact with the polymer (e.g., the polymer described herein) or resist (e.g., a resist described herein).

In embodiments, the IR reflective coating reflects near-infrared radiation (NIR). In embodiments, the IR reflective coating reflects mid- or far-infrared radiation. In embodiments, the IR reflective coating reflects wavelengths greater than 750 nm. In embodiments, the IR reflective coating reflects wavelengths greater than 760 nm. In embodiments, the IR reflective coating reflects wavelengths greater than 770 nm. In embodiments, the IR reflective coating reflects wavelengths greater than 780 nm. In embodiments, the IR reflective coating reflects wavelengths greater than 790 nm. In embodiments, the IR reflective coating reflects wavelengths greater than 800 nm. In embodiments, the IR reflective coating reflects wavelengths from about 750 nm to 1,000 μm. In embodiments, the infrared (IR) reflective coating includes one or more layers of silicon dioxide (SiO₂) and tantalum pentoxide (Ta₂O₅). A multilayer configuration leverages the distinct optical properties of both materials to enhance the IR reflectivity. Silicon dioxide, known for its low refractive index, and tantalum pentoxide, recognized for its high refractive index, are alternately layered to create a stack that exhibits high reflectance in the infrared spectrum. The alternating layers of SiO₂ and Ta₂O₅ result in constructive interference of light at specific wavelengths, thereby enhancing the IR reflective capability of the coating. The number and thickness of these layers can be tailored to target specific wavelengths within the IR range, or permitting a certain percentage of radiation to transmit. For example, the IR reflective coating may reflect 2-3%, 2-6%, or 2 to 10% of the total IR radiation, and it absorbs or transmits the remaining IR radiation (e.g., greater than about 90% of the IR radiation). In embodiments, the IR reflective coating reflects about 1%, about 2%, about 3%, about 4%, about 5%, about 6%, about 7%, about 8%, about 9%, or about 10% of the total IR radiation.

In embodiments, the IR reflective coating aids autofocus mechanisms in optical instruments (e.g., fluorescence microscopy instruments) to provide consistent signal across various z-heights (e.g., the depth of an image). In embodiments, the IR reflective coating increases the amount of light reflected to the autofocus sensor to provide consistent signal across various z-heights. In embodiments, the IR reflective coating improves the signal to noise ratio of an image acquired by an optical instrument.

In embodiments, the polymer attached to the first solid support includes a plurality of particles. In embodiments, the coupling agent attached to the polymer of the first solid support includes a plurality of particles. In embodiments, the first solid support further includes a plurality of particles. In embodiments, the resist attached to the first solid support includes a plurality of particles. In embodiments, the coupling agent attached to the resist of the first solid support includes a plurality of particles. In embodiments, the particle is a solid particle. In embodiments, the particle is rigid and includes a shape. In embodiments, the particle is substantially spherical. In embodiments, the particle is substantially cuboidal. In embodiments, the particle is not an emulsion or droplet. In embodiments, the particle is a functionalized particle including pluralities of fluorescent moieties on its surface. In embodiments, the particle is a functionalized particle including pluralities of two fluorescent moieties on its surface. In embodiments, the particle has a silica core. In embodiments, the particle has a polystyrene core. In embodiments, the particle has a gold core. In embodiments, the particle has a metal oxide core. In embodiments, the particle has an iron oxide core. In embodiments, the particle has a core that can be manipulated using magnetic fields. In embodiments, the particle has a nickel core. In embodiments, the particle has a cobalt core. In embodiments, the particle has a core with reflective properties. In embodiments, the particle has a silver core. In embodiments, the particle includes a polymer shell surrounding the particle core (e.g., a polymer shell that is attached to the particle core), wherein the polymer shell includes bioconjugate reactive moieties. In embodiments, the particle includes a polymer shell surrounding the particle core (e.g., a polymer shell that is attached to the particle core), wherein the polymer shell includes azide moieties. In embodiments, a fluorescent moiety is covalently attached to the polymer shell surrounding the particle core via a bioconjugate linker. In embodiments, the fluorescent moiety including a reactive bioconjugate moiety is allowed to contact the polymer shell surrounding the particle and form a bioconjugate linker, thereby covalently immobilizing the fluorescent moiety to the particle. In embodiments, a plurality of fluorescent moieties including reactive bioconjugate moieties are allowed to contact the polymer shell surrounding the particle and form a bioconjugate linker, thereby covalently immobilizing the fluorescent moiety to the particle. In embodiments, the particle is a fluorescent particle.

In embodiments, the particles attached to the polymer or the coupling agent aids calibration of optical instruments used herein (e.g., fluorescence microscopy instruments). In embodiments, the particles used herein emit fluorescence at known wavelengths, which aids the calibration of fluorescence detection channels on optical instruments used herein. In embodiments, the particles used herein aids the testing the image quality and spatial resolution across different z-heights (e.g., depth of an image acquired of a tissue section described herein).

The polymer shell may be polymerized from a mixture of functionalized and non-functionalized monomers, such that at least some functionalized monomers that provide attachment points (e.g., azide moieties). In embodiments, the particle includes a plurality of bioconjugate reactive moieties, wherein the bioconjugate reactive moiety is provided by the polymer shell. In embodiments, a bioconjugate reactive moiety includes an amine moiety, aldehyde moiety, alkyne moiety, azide moiety, carboxylic acid moiety, dibenzocyclooctyne (DBCO) moiety, norbornene moiety, tetrazine moiety, epoxy moiety, isocyanate moiety, furan moiety, maleimide moiety, thiol moiety, or transcyclooctene (TCO) moiety. In embodiments, the particle includes a plurality of azide moieties, alkyne moieties, dibenzocyclooctyne (DBCO) moieties, norbornene moieties, epoxy moieties, or isocyanate moieties. In some embodiments, the particle includes a plurality of oligonucleotide moieties (e.g., ssDNA moieties) covalently attached via a bioconjugate linker to the polymer shell. The bioconjugate linker is the product of a reaction between the two bioconjugate group (e.g, click chemistry group). In embodiments, each of the plurality of bioconjugate reactive moieties includes an amine moiety, aldehyde moiety, alkyne moiety, azide moiety, carboxylic acid moiety, dibenzocyclooctyne (DBCO) moiety, norbornene moiety, tetrazine moiety, epoxy moiety, isocyanate moiety, furan moiety, maleimide moiety, thiol moiety, or transcyclooctene (TCO) moiety. In embodiments, each of the plurality of bioconjugate reactive moieties include an amine moiety, azide moiety, dibenzocyclooctyne (DBCO) moiety, epoxy moiety, or isocyanate moiety. In embodiments, each of the plurality of bioconjugate reactive moieties include an amine moiety, azide moiety, alkyne moiety, dibenzocyclooctyne (DBCO) moiety, epoxy moiety, or isocyanate moiety. In embodiments, the bioconjugate reactive moiety is an azido moiety.

In embodiments, the average longest dimension of the particle is from about 100 nm to about 3000 nm. In embodiments, the average longest dimension of the particle is from about 200 nm to about 2900 nm. In embodiments, the average longest dimension of the particle is from about 300 nm to about 2800 nm. In embodiments, the average longest dimension of the particle is from about 400 nm to about 2700 nm. In embodiments, the average longest dimension of the particle is from about 500 nm to about 2600 nm. In embodiments, the average longest dimension of the particle is from about 600 nm to about 2500 nm. In embodiments, the average longest dimension of the particle is from about 700 nm to about 2400 nm. In embodiments, the average longest dimension of the particle is from about 800 nm to about 2300 nm. In embodiments, the average longest dimension of the particle is from about 900 nm to about 2200 nm. In embodiments, the average longest dimension of the particle is from about 1000 nm to about 2100 nm. In embodiments, the average longest dimension of the particle is from about 900 nm to about 2000 nm. In embodiments, the average longest dimension of the particle is from about 150 nm to about 600 nm. In some embodiments, the average longest dimension of the particle is from about 350 nm to about 600 nm. In some embodiments, the average longest dimension of the particle is from about 400 nm to about 500 nm. In some embodiments, the average longest dimension of the particle is about 500 nm. In some embodiments, the average longest dimension of the particle is about 400 nm. In some embodiments, the average longest dimension of the particle is about 400 nm, 450 nm, 500 nm, or 550 nm. In some embodiments, the average longest dimension of the particle is about 410 nm, 420 nm, 430 nm, 440 nm or 450 nm. In some embodiments, the average longest dimension of the particle is about 460 nm, 470 nm, 480 nm, 490 nm or 500 nm. In embodiments, the average longest dimension of the particle is at least, about, or at most 100, 200, 300, 400, 500, 600, 700, 800, 900, 1000 nm or a number or a range between any two of these values. In embodiments, the average longest dimension of the degradable particle core is from about 100 nm to about 3000 nm. In embodiments, the average longest dimension of the degradable particle core is from about 200 nm to about 2900 nm. In embodiments, the average longest dimension of the degradable particle core is from about 300 nm to about 2800 nm. In embodiments, the average longest dimension of the degradable particle core is from about 400 nm to about 2700 nm. In embodiments, the average longest dimension of the degradable particle core is from about 500 nm to about 2600 nm. In embodiments, the average longest dimension of the degradable particle core is from about 600 nm to about 2500 nm. In embodiments, the average longest dimension of the degradable particle core is from about 700 nm to about 2400 nm. In embodiments, the average longest dimension of the degradable particle core is from about 800 nm to about 2300 nm. In embodiments, the average longest dimension of the degradable particle core is from about 900 nm to about 2200 nm. In embodiments, the average longest dimension of the degradable particle core is from about 1000 nm to about 2100 nm. In embodiments, the average longest dimension of the degradable particle core is from about 900 nm to about 2000 nm. In embodiments, the average longest dimension of the degradable particle core is from about 150 nm to about 600 nm. In some embodiments, the average longest dimension of the degradable particle core is from about 350 nm to about 600 nm. In some embodiments, the average longest dimension of the degradable particle core is from about 400 nm to about 500 nm. In some embodiments, the average longest dimension of the degradable particle core is about 500 nm. In some embodiments, the average longest dimension of the degradable particle core is about 400 nm. In some embodiments, the average longest dimension of the degradable particle core is about 400 nm, 450 nm, 500 nm, or 550 nm. In some embodiments, the average longest dimension of the degradable particle core is about 410 nm, 420 nm, 430 nm, 440 nm or 450 nm. In some embodiments, the average longest dimension of the degradable particle core is about 460 nm, 470 nm, 480 nm, 490 nm or 500 nm. In embodiments, the average longest dimension of the degradable particle core is at least, about, or at most 100, 200, 300, 400, 500, 600, 700, 800, 900, 1000 nm or a number or a range between any two of these values. In embodiments, the shell diameter is about 0.1-10 microns, 0.25-5 microns, 0.5-2 microns, 1 micron, or a number or a range between any two of these values. In embodiments, the particle shell diameter is at least, about, or at most 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0 μm or a number or a range between any two of these values. In embodiments, the core diameter is about 150-700 nanometers, and/or the shell diameter is about 0.25-5 μm (microns).

In embodiments, the thickness (i.e., height) of the polymer or the resist (i.e., resist described herein) is about 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, or 1000 nm. In embodiments, the thickness (i.e., height) of the polymer or the resist (i.e., a resist described herein) is about 25 nm. In embodiments, the thickness (i.e., height) of the polymer or the resist (i.e., a resist described herein) is about 50 nm. In embodiments, the thickness (i.e., height) of the polymer or the resist (i.e., a resist described herein) is about 75 nm. In embodiments, the thickness (i.e., height) of the polymer or the resist (i.e., a resist described herein) is about 100 nm. In embodiments, the thickness (i.e., height) of the polymer or the resist (i.e., a resist described herein) is about 200 nm.

In embodiments, the polymer attached to the first solid support is a crosslinked polymer matrix. In embodiments, the polymer is a photoresist, wherein the photoresist is a poly dimethylsiloxane (PDMS), poly(methyl methacrylate) (PMMA), cyclic olefin copolymer (COC), silsesquioxane resist, an epoxy-based polymer resist, poly(vinylpyrrolidone-vinyl acrylic acid) copolymer resist, an Off-stoichiometry thiol-enes (OSTE) resist, amorphous fluoropolymer resist, a crystalline fluoropolymer resist, polysiloxane resist, or an organically modified ceramic polymer resist. In embodiments, the polymer attached to the first solid support includes acrylate silanes and polyamines. In embodiments, the polymer attached to the first solid support includes methacrylic acid N-hydroxysuccinimide ester (NHS-MA). In embodiments, the polymer attached to the first solid support includes (3-aminopropyl)triethoxysilane (APTES). In embodiments, the polymer attached to the first solid support includes a copolymer of (3-aminopropyl)triethoxysilane (APTES) and methacrylic acid N-hydroxysuccinimide ester (NHS-MA).

In embodiments, the resist described herein is a photoresist. In embodiments, the resist is a poly dimethylsiloxane (PDMS). In embodiments, the resist is poly(methyl methacrylate) (PMMA). In embodiments, the resist is cyclic olefin copolymer (COC). In embodiments, the resist is silsesquioxane resist. In embodiments, the resist is an epoxy-based polymer resist. In embodiments, the resist is poly(vinylpyrrolidone-vinyl acrylic acid) copolymer resist. In embodiments, the resist is an Off-stoichiometry thiol-enes (OSTE) resist. In embodiments, the resist is amorphous fluoropolymer resist. In embodiments, the resist is a crystalline fluoropolymer resist. In embodiments, the resist is polysiloxane resist. In embodiments, the resist is or an organically modified ceramic polymer resist. In embodiments, the resist attached to the first solid support includes acrylate silanes and polyamines. In embodiments, the resist attached to the first solid support includes methacrylic acid N-hydroxysuccinimide ester (NHS-MA). In embodiments, the resist attached to the first solid support includes (3-aminopropyl)triethoxysilane (APTES). In embodiments, the resist attached to the first solid support includes a copolymer of (3-aminopropyl)triethoxysilane (APTES) and methacrylic acid N-hydroxysuccinimide ester (NHS-MA).

The photoresist (alternatively referred to as a resist) is an active material layer that can be patterned by selective exposure and must “resist” chemical/physical attach of the underlying substrate. A photoresist is a light-sensitive polymer material used to form a patterned coating on a surface. The process begins by coating a substrate (e.g., a glass substrate) with a light-sensitive organic material. A mask with the desired pattern is used to block light so that only unmasked regions of the material will be exposed to light. In the case of a positive photoresist, the photo-sensitive material is degraded by light and a suitable solvent will dissolve away the regions that were exposed to light, leaving behind a coating where the mask was placed. In the case of a negative photoresist, the photosensitive material is strengthened (either polymerized or cross-linked) by light, and a suitable solvent will dissolve away only the regions that were not exposed to light, leaving behind a coating in areas where the mask was not placed. In embodiments, the solid support includes an epoxy-based photoresist (e.g., SU-8, SU-8 2000, SU-8 3000, SU-8 GLM2060). In embodiments, the solid support includes a negative photoresist. Negative refers to a photoresist whereby the parts exposed to UV become cross-linked (i.e., immobilized), while the remainder of the polymer remains soluble and can be washed away during development.

In embodiments, the solid support includes a glass substrate having a surface coated in silsesquioxane resist (e.g., polyhedral oligosilsesquioxanemethacrylate (POSS)), an epoxy-based polymer resist (e.g., SU-8 as described in U.S. Pat. No. 4,882,245), poly(vinylpyrrolidone-vinyl acrylic acid) copolymer resist (e.g., as described in U.S. Pat. No. 7,467,632), or novolaks resist, bisazides resist, or a combination thereof (e.g., as described in U.S. Pat. No. 4,970,276). In embodiments, the resist is removed prior to loading.

A “resist” as used herein is used in accordance with its ordinary meaning in the art of lithography and refers to a polymer matrix (e.g., a polymer network). In embodiments, the photoresist is a silsesquioxane resist. In embodiments, the photoresist is an epoxy-based polymer resist. In embodiments, the photoresist is a poly(vinylpyrrolidone-vinyl acrylic acid) copolymer resist. In embodiments, the photoresist is an Off-stoichiometry thiol-enes (OSTE) resist. In embodiments, the solid support includes a Hydrogen Silsesquioxane (HSQ) polymer (e.g., HSQ resist). In embodiments, the photoresist is an amorphous fluoropolymer resist. In embodiments, the photoresist is a crystalline fluoropolymer resist. In embodiments, the photoresist is a polysiloxane resist. In embodiments, the photoresist is an organically modified ceramic polymer resist. In embodiments, the photoresist includes polymerized alkoxysilyl methacrylate polymers and metal oxides (e.g., SiO₂, ZrO, MgO, Al₂O₃, TiO₂ or Ta₂O₅). In embodiments, the photoresist includes polymerized alkoxysilyl acrylate polymers and metal oxides (e.g., SiO₂, ZrO, MgO, Al₂O₃, TiO₂ or Ta₂O₅). In embodiments, the photoresist includes metal atoms, such as Si, Zr, Mg, Al, Ti or Ta atoms.

In embodiments, the solid support includes a resist (e.g., a nanoimprint lithography (NIL) resist). Nanoimprint resists can include thermal curable materials (e.g., thermoplastic polymers), and/or UV-curable polymers. In embodiments, the solid support is generated by pressing a transparent mold possessing the pattern of interest (e.g., the pattern of wells) into photo-curable liquid film, followed by solidifying the liquid materials via a UV light irradiation. Typical UV-curable resists have low viscosity, low surface tension, and suitable adhesion to the glass substrate. For example, the solid support surface is coated in an organically modified ceramic polymer (ORMOCER®, registered trademark of Fraunhofer-Gesellschaft zur Förderung der angewandten Forschung e. V. in Germany). Organically modified ceramics contain organic side chains attached to an inorganic siloxane backbone. Several ORMOCER® polymers are now provided under names such as “Ormocore”, “Ormoclad” and “Ormocomp” by Micro Resist Technology GmbH. In embodiments, the solid support includes a resist as described in Haas et al Volume 351, Issues 1-2, 30 Aug. 1999, Pages 198-203, US 2015/0079351A1, US 2008/0000373, US 2010/0160478, or U.S. Pat. No. 10,268,096 B2, each of which is incorporated herein by reference. In embodiments, the solid support surface is coated in an organically modified ceramic polymer including (ORMOCER®, registered trademark of Fraunhofer-Gesellschaft zur Förderung der angewandten Forschung e. V. in Germany). In embodiments, the solid support surface is coated in an organically modified ceramic polymer wherein the organically modified ceramic polymer includes an inorganic-organic hybrid polymer that includes Si—O bonds. In embodiments, the solid support surface is coated in an organically modified ceramic polymer wherein the organically modified ceramic polymer includes an inorganic-organic hybrid polymer that includes Si—C bonds. In embodiments, the solid support surface is coated in an organically modified ceramic polymer wherein the organically modified ceramic polymer includes free acrylate moieties. In embodiments, the polymer described herein or resist described herein is an organically modified ceramic polymer wherein the organically modified ceramic polymer includes an inorganic-organic hybrid polymer that includes Si—O bonds. In embodiments, polymer described herein or resist described herein is an organically modified ceramic polymer wherein the organically modified ceramic polymer includes an inorganic-organic hybrid polymer that includes Si—C bonds. In embodiments, the polymer described herein or resist described herein is an organically modified ceramic polymer wherein the organically modified ceramic polymer includes free acrylate moieties. In embodiments, the polymer described herein or resist described herein contains organically crosslinked heteropolysiloxane moieties.

In embodiments, the polymer described herein or resist described herein is attached to a coupling agent. In embodiments, the coupling agent includes a hydrophilic cationic compound. In embodiments, the coupling agent includes (3-aminopropyl)triethoxysilane (APTES), (3-Aminopropyl)trimethoxysilane (APTMS), γ-Aminopropylsilatrane (APS), N-(6-aminohexyl)aminomethyltriethoxysilane (AHAMTES), polyethylenimine (PEI), 5,6-epoxyhexyltriethoxysilane, 3-(trimethoxysilyl)propylmethacrylate (MAPTMS), or triethoxysilylbutyraldehyde, or a combination thereof. In embodiments, the coupling agent includes N-(2-aminoethyl)-3-aminopropyltriethoxysilane (AEAPTES), N-(2-aminoethyl)-3-aminopropyltrimethoxysilane (AEAPTMS), N-(6-aminohexyl) aminomethyltriethoxysilane (AHAMTES), 3-aminopropyldimethylethoxysilane (APDMES), 3-mercaptopropyltrimethoxysilane (MPTMS), glycidyloxypropyl-trimethoxysilane (GOPS), as described by Sypabekova et al. (Biosensors (Basel). 2022 Dec. 27; 13(1):36), or a combination thereof. In embodiments, the coupling agent includes polyethylenimine (PEI). In embodiments, the coupling agent includes branched polyethylenimine (bPEI). In embodiments, branched polyethylenimine (bPEI) includes about 35% primary, 40% secondary, 25% tertiary amines. In embodiments, branched poly ethylenimine (bPEI) includes 25% primary amines, 50% secondary amines, 25% tertiary amines (see, e.g., Grenada et al. J Appl Polym Sci. 2022; 139:e51657). Examples of commercially available bPEI with primary, secondary, and tertiary amine groups in approximately 25/50/25 ratio include, but are not limited to, bPEI commercialized by Polysciences (see, e.g., bPEI from Polysciences, catalog number: 02371-500). In embodiments, branched polyethylenimine (bPEI) includes hyperbranched poly ethylenimine, which includes about 30% primary amines, 40% secondary amines, 30% tertiary amines (see, e.g., Grenada et al. J Appl Polym Sci. 2022; 139:e51657). In embodiments, the coupling agent includes branched polyethylenimine (bPEI) attached to PEG-acrylamide moieties. In embodiments, the coupling agent includes unbranched polyethylenimine. In embodiments, the coupling agent includes linear polyethylenimine. In embodiments, the coupling agent includes polyethylenimine with an average molecular weight (M_{w}) of about 600. In embodiments, the coupling agent includes polyethylenimine with an average molecular weight (M_{w}) of about 800. In embodiments, the coupling agent includes polyethylenimine with an average molecular weight (M_{w}) of about 1,300. In embodiments, the coupling agent includes polyethylenimine with an average molecular weight (M_{w}) of about 2,000. In embodiments, the coupling agent includes poly ethylenimine with an average molecular weight (M_{w}) of about 25,000. In embodiments, the coupling agent includes polyethylenimine with an average molecular weight (M_{w}) of about 750,000. In embodiments, the coupling agent includes polyethylenimine with number average molecular weight (Mₙ) of about 600. In embodiments, the coupling agent includes polyethylenimine with number average molecular weight (Ma) of about 1,300. In embodiments, the coupling agent includes poly ethylenimine with number average molecular weight (Ma) of about 2,100. In embodiments, the coupling agent includes polyethylenimine with number average molecular weight (Ma) of about 10,000. In embodiments, the coupling agent includes includes polyallylamine. In embodiments, the coupling agent includes poly(ethylene glycol) diamine. In embodiments, the coupling agent includes (PEG)₃₂ diamine. In embodiments, the coupling agent includes (PEG)₃ diamine. In embodiments, the coupling agent includes NH₂-PEG₄-NH₂. In embodiments, the coupling agent includes ethylene diamine. In embodiments, the coupling agent includes chitosan. In embodiments, the coupling agent includes polydiallyldimethylammonium chloride (commonly referred as polyDADMAC or polyDDA). In embodiments, the coupling agent includes triethoxysilylbutyraldehyde (TESBA). In embodiments, the coupling agent includes a combination of triethoxysilylbutyraldehyde (TESBA) and polyethylenimine (PEI). In embodiments, the coupling agent includes a combination of triethoxysilylbutyraldehyde (TESBA) and chitosan. In embodiments, the coupling agent includes 1,5,6-epoxyhexyltriethoxysilane (EHTES). In embodiments, the coupling agent includes bis(2-hydroxyethyl)-3-aminopropyltriethoxysilane (BHEAPTES). In embodiments, the coupling agent includes poly-1-lysine (PLL). In embodiments, the coupling agent includes spermidine. In embodiments, the coupling agent is a second polymer. In embodiments, the coupling agent includes a hydrophilic compound. In embodiments, the coupling agent includes a hydrophilic cationic compound. In embodiments, the coupling agent includes a 4-arm PEG group. In embodiments, the coupling agent includes 4-arm PEG 200, where the terminal moiety of each of the 4 arms is a —NH₂ moiety. As used herein, the term “4-arm PEG” refers to a multi-armed derivative polyethylene glycol with a bioconjugate reactive moiety at each terminus of the four arms, where each arm is connected to a pentaerythritol core. In embodiments, 4-arm PEG has the general formula,

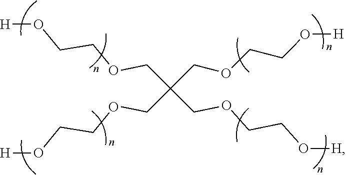

wherein n is an integer from 1 to 10 or more. In embodiments, the coupling agent includes poly(ethylene glycol) methacrylate (PEGMA). In embodiments, the coupling agent includes poly(ethylene glycol) methacrylate (PEGMA) 400, wherein PEGMA terminates with an azide moiety. In embodiments, the coupling agent includes poly(ethylene glycol) methacrylate (PEGMA) 400, wherein PEGMA terminates with a —NH₂ moiety. In embodiments, the coupling agent includes a copolymer of poly(ethylene glycol) methacrylate (PEGMA) 500 and glycidyl methacrylate (GMA). In embodiments, the coupling agent includes poly(methacryloyloxyethyl phosphorylcholine) (polyMPC). In embodiments, the coupling agent includes a copolymer of poly(methacryloyloxyethyl phosphorylcholine) (polyMPC) and glycidyl methacrylate (GMA). In embodiments, the coupling agent includes a copolymer of poly [2-(Methacryloyloxy)ethyl]trimethylammonium chloride and poly(ethylene glycol) methacrylate (PEGMA) 500-azide.

In an aspect is provided a flow cell assembly. In embodiments, the flow cell assembly includes a first solid support; a resist attached to the first solid support; a cell or tissue attached to the resist; a second solid support attached to the first solid support, wherein the second solid support is configured to define a reaction chamber. In embodiments, the resist is indirectly attached to the first solid support by way of being in direct contact with one or more intermediate layers between the first solid support and the polymer. In embodiments, one or more intermediate layers between the first solid support and the polymer includes an infrared (IR) reflective coating (e.g., an infrared reflective coating described herein). In embodiments, the resist is directly attached to the first solid support.

In an aspect is provided a microfluidic device including the flow cell assembly as described herein. In embodiments, the microfluidic device includes one or more flow cell(s) (e.g., 2 to 4 flow cells). In embodiments, the microfluidic device includes a functionalized tissue slide. In embodiments, the microfluidic device includes an imaging system or detection apparatus. Any of a variety of detection apparatus can be configured to detect the reaction vessel or solid support where reagents interact. Examples include luminescence detectors, surface plasmon resonance detectors and others known in the art. Exemplary systems having fluidic and detection components that can be readily modified for use in a system herein include, but are not limited to, those set forth in U.S. Pat. Nos. 8,241,573, 8,039,817; or US Pat. App. Pub. No. 2012/0270305 A1, each of which is incorporated herein by reference. In embodiments, the microfluidic device further includes one or more excitation lasers.

In embodiments, the microfluidic device is a nucleic acid sequencing device including: a stage configured to hold an array or solid support as described herein, including embodiments; an array or solid support as described herein, including embodiments; and a detector for obtaining sequencing data. In some embodiments, the detector is an imaging detector, such as a CCD, EMCCD, or s-CMOS detector. Nucleic acid sequencing devices utilize excitation beams to excite labeled nucleotides in the DNA containing sample to enable analysis of the base pairs present within the DNA. Many of the next-generation sequencing (NGS) technologies use a form of sequencing by synthesis (SBS), wherein modified nucleotides are used along with an enzyme to read the sequence of DNA templates in a controlled manner. In embodiments, sequencing includes a sequencing by synthesis event, where individual nucleotides are identified iteratively (e.g., incorporated and detected into a growing complementary strand), as they are polymerized to form a growing complementary strand. In embodiments, nucleotides added to a growing complementary strand include both a label and a reversible chain terminator that prevents further extension, such that the nucleotide may be identified by the label before removing the terminator to add and identify a further nucleotide. Such reversible chain terminators include removable 3′ blocking groups, for example as described in U.S. Pat. Nos. 10,738,072, 7,541,444 and 7,057,026. Once such a modified nucleotide has been incorporated into the growing polynucleotide chain complementary to the region of the template being sequenced, there is no free 3′-OH group available to direct further sequence extension and therefore the polymerase cannot add further nucleotides. Once the identity of the base incorporated into the growing chain has been determined, the 3′ reversible terminator may be removed to allow addition of the next successive nucleotide. In embodiments, the nucleic acid sequencing device utilizes the detection of four different nucleotides that include four different labels.

The term “nucleic acid sequencing device” means an integrated system of one or more chambers, ports, and channels that are interconnected and in fluid communication and designed for carrying out an analytical reaction or process, either alone or in cooperation with an appliance or instrument that provides support functions, such as sample introduction, fluid and/or reagent driving means, temperature control, detection systems, data collection and/or integration systems, for the purpose of determining the nucleic acid sequence of a template polynucleotide. Nucleic acid sequencing devices may further include valves, pumps, and specialized functional coatings on interior walls. Nucleic acid sequencing devices may include a receiving unit, or platen, that orients the flow cell such that a maximal surface area of the flow cell is available to be exposed to an optical lens. Other nucleic acid sequencing devices include those provided by Singular Genomics™ such as the G4™ sequencing platform, Illumina™, Inc. (e.g., HiSeq™, MiSeq™, NextSeq™, orNovaSeq™ systems), Life Technologies™ (e.g., ABI PRISM™, or SOLiD™ systems), Pacific Biosciences (e.g., systems using SMRT™ Technology such as the Sequel™ or RS II™ systems), or Qiagen (e.g., Genereader™ system). Nucleic acid sequencing devices may further include fluidic reservoirs (e.g., bottles), valves, pressure sources, pumps, sensors, control systems, valves, pumps, and specialized functional coatings on interior walls. In embodiments, the device includes a plurality of a sequencing reagent reservoirs and a plurality of clustering reagent reservoirs. In embodiments, the clustering reagent reservoir includes amplification reagents (e.g., an aqueous buffer containing enzymes, salts, and nucleotides, denaturants, crowding agents, etc.) In embodiments, the reservoirs include sequencing reagents (such as an aqueous buffer containing enzymes, salts, and nucleotides); a wash solution (an aqueous buffer); a cleave solution (an aqueous buffer containing a cleaving agent, such as a reducing agent); or a cleaning solution (a dilute bleach solution, dilute NaOH solution, dilute HCl solution, dilute antibacterial solution, or water). The fluid of each of the reservoirs can vary. The fluid can be, for example, an aqueous solution which may contain buffers (e.g., saline-sodium citrate (SSC), ascorbic acid, tris(hydroxymethyl)aminomethane or “Tris”), aqueous salts (e.g., KCl or (NH₄)₂SO₄)), nucleotides, polymerases, cleaving agent (e.g., tri-n-butyl-phosphine, triphenyl phosphine and its sulfonated versions (i.e., tris(3-sulfophenyl)-phosphine, TPPTS), and tri(carboxyethyl)phosphine (TCEP) and its salts, cleaving agent scavenger compounds (e.g., 2′-Dithiobisethanamine or 11-Azido-3,6,9-trioxaundecane-1-amine), chelating agents (e.g., EDTA), detergents, surfactants, crowding agents, or stabilizers (e.g., PEG, Tween, BSA). Non-limited examples of reservoirs include cartridges, pouches, vials, containers, and eppendorf tubes. In embodiments, the device is configured to perform fluorescent imaging. In embodiments, the device includes one or more light sources (e.g., one or more lasers). In embodiments, the illuminator or light source is a radiation source (i.e., an origin or generator of propagated electromagnetic energy) providing incident light to the sample. A radiation source can include an illumination source producing electromagnetic radiation in the ultraviolet (UV) range (about 200 to 390 nm), visible (VIS) range (about 390 to 770 nm), or infrared (IR) range (about 0.77 to 25 microns), or other range of the electromagnetic spectrum. In embodiments, the illuminator or light source is a lamp such as an arc lamp or quartz halogen lamp. In embodiments, the illuminator or light source is a coherent light source. In embodiments, the light source is a laser, LED (light emitting diode), a mercury or tungsten lamp, or a super-continuous diode. In embodiments, the light source provides excitation beams having a wavelength between 200 nm to 1500 nm. In embodiments, the laser provides excitation beams having a wavelength of 405 nm, 470 nm, 488 nm, 514 nm, 520 nm, 532 nm, 561 nm, 633 nm, 639 nm, 640 nm, 800 nm, 808 nm, 912 nm, 1024 nm, or 1500 nm. In embodiments, the illuminator or light source is a light-emitting diode (LED). The LED can be, for example, an Organic Light Emitting Diode (OLED), a Thin Film Electroluminescent Device (TFELD), or a Quantum dot based inorganic organic LED. The LED can include a phosphorescent OLED (PHOLED). In embodiments, the nucleic acid sequencing device includes an imaging system (e.g., an imaging system as described herein). The imaging system capable of exciting one or more of the identifiable labels (e.g., a fluorescent label) linked to a nucleotide and thereafter obtain image data for the identifiable labels. The image data (e.g., detection data) may be analyzed by another component within the device. The imaging system may include a system described herein and may include a fluorescence spectrophotometer including an objective lens and/or a solid-state imaging device. The solid-state imaging device may include a charge coupled device (CCD) and/or a complementary metal oxide semiconductor (CMOS).

The system may also include circuitry and processors, including systems using microcontrollers, reduced instruction set computers (RISC), application specific integrated circuits (ASICs), field programmable gate array (FPGAs), logic circuits, and any other circuit or processor capable of executing functions described herein. The set of instructions may be in the form of a software program. As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. In embodiments, the device includes a thermal control assembly useful to control the temperature of the reagents. In embodiments, the microfluidic device may include one or more processors or computers. The processor may be a hardware processor such as a central processing unit (CPU), a graphic processing unit (GPU), a general-purpose processing unit, or a computing platform. The processor may include of any of a variety of suitable integrated circuits, microprocessors, logic devices, field-programmable gate arrays (FPGAs) and the like. In some instances, the processor may be a single core or multi core processor, or a plurality of processors may be configured for parallel processing. Although the disclosure is described with reference to a processor, other types of integrated circuits and logic devices are also applicable. The processor may have any suitable data operation capability. For example, the processor may perform 512 bit, 256 bit, 128 bit, 64 bit, 32 bit, or 16 bit data operations. In embodiments, the microfluidic device may further include a computer (or processor) and computer-readable medium that includes code for providing image processing and analysis capability. Examples of image processing and analysis capability that may be provided by the software include manual, semi-automated, or fully-automated image exposure adjustment (e.g. white balance, contrast adjustment, signal-averaging and other noise reduction capability, etc.), automated edge detection and object identification (e.g., for identifying clonally-amplified clusters of fluorescently-labeled oligonucleotides), automated statistical analysis (e.g., for determining the number of clonally-amplified clusters of oligonucleotides identified per unit area, or for automated nucleotide base-calling in nucleic acid sequencing applications), and manual measurement capabilities (e.g. for measuring distances between clusters or other objects, etc.). Optionally, instrument control and image processing/analysis software may be written as separate software modules. In some embodiments, instrument control and image processing/analysis software may be incorporated into an integrated package. Any of a variety of image processing methods known to those of skill in the art may be used for image processing/pre-processing. Examples include, but are not limited to, Canny edge detection methods, Canny-Deriche edge detection methods, first-order gradient edge detection methods (e.g., the Sobel operator), second order differential edge detection methods, phase congruency (phase coherence) edge detection methods, other image segmentation algorithms (e.g., intensity thresholding, intensity clustering methods, intensity histogram-based methods, etc.), feature and pattern recognition algorithms (e.g., the generalized Hough transform for detecting arbitrary shapes, the circular Hough transform, etc.), and mathematical analysis algorithms (e.g., Fourier transform, fast Fourier transform, wavelet analysis, auto-correlation, etc.), or any combination thereof.

In an aspect is a kit, including the flow cell assembly as described herein. In embodiments, the kit includes the first solid support attached to a polymer, which is further attached to an IR reflective coating, coating agent, and/or particles; and a second solid support, configured to define a reaction chamber when attached to the first solid support. In embodiments, the kit includes the first solid support attached to a resist, which is further attached to an IR reflective coating, coating agent, and/or particles; and a second solid support, configured to define a reaction chamber when attached to the first solid support. Generally, the kit includes one or more containers providing a composition and one or more additional reagents (e.g., a buffer suitable for polynucleotide extension). The kit may also include a template nucleic acid (DNA and/or RNA), one or more primer polynucleotides, nucleoside triphosphates (including, e.g., deoxyribonucleotides, ribonucleotides, particles, polymerases, labeled nucleotides, and/or modified nucleotides), buffers, salts, and/or labels (e.g., fluorophores). In embodiments, the kit includes a plurality of detection agents capable of detecting a biomolecule (or plurality thereof) from a tissue section. In embodiments, the kit includes the tissue section including the biomolecule to be detected (or plurality thereof) already immobilized onto the first solid support of the flow cell assembly as described herein. In embodiments, kit includes the flow cell assembly as described herein and a flow cell carrier (e.g., a flow cell carrier as described in U.S. Pat. No. 11,747,262, which is incorporated herein by reference for all purposes).

In embodiments, the kit includes a first solid support (e.g., a first solid support as described herein), wherein a polymer attached to the first solid support; and a coupling agent attached to the first polymer. In embodiments, the kit includes a first solid support (e.g., a first solid support as described herein), wherein a resist attached to the first solid support; and a coupling agent attached to the resist. In embodiments, the first solid support is not attached to the second solid support until the tissue sample is affixed to the first solid support. In embodiments, the first solid support is configured to remain detached from the second solid support until the user affixes the tissue sample to the coupling agent, ensuring precise placement and alignment of the biological material. In embodiments, the first solid support is configured to remain detached from the second solid support until the user affixes the tissue sample to the polymer described herein or resist described herein, ensuring precise placement and alignment of the biological material. In embodiments, the kit includes a second solid support, wherein the second support is configured to define a reaction chamber. In embodiments, the kit includes a second solid support comprising a glass slide with one or more (e.g., eight) pre-drilled ports enabling the introduction and removal of reagents. In embodiments, the second solid support is further equipped with a gasket that is pre-attached to the glass slide. The gasket, having a peel-off backing, is designed to form a sealed reaction chamber when adhered to the first solid support. This design ensures the creation of defined channels necessary for fluid flow and biochemical reactions within the assembled flow cell. Upon receiving the kit, users are instructed to affix one or more tissue sample(s) onto the first solid support, directly onto the exposed coupling agent. After the sample deposition, the user will remove the peel-off backing from the gasket on the second solid support and align it with the first solid support. This alignment and subsequent attachment create a secure and sealed environment, forming the reaction chamber with integrated microfluidic channels as dictated by the configuration of the gasket. The flow cell assembly process is designed to be straightforward, allowing for efficient setup while minimizing the potential for user error and ensuring reproducibility of experimental conditions. In embodiments, the second support includes 1, 2, or 4 distinct reaction chambers. In embodiments, the second solid support includes a gasket, wherein the gasket defines the reaction chamber. In embodiments, the gasket includes silicone, polyimide, fluorocarbon elastomer, ethylene propylene diene, polychloroprene, polytetrafluoroethylene, nitrile rubber, butyl rubber, natural rubber, thermoplastic elastomer, or a combination thereof. In embodiments, the second solid support includes a spacer element to form an offset surface when attached to the first solid support. In embodiments, the second solid support includes one or more channels. The channel(s) may be formed by affixing a spacer element to create a defined gap or channel through which liquid can flow or be contained. The spacer element may be made of any suitable material, for example resin, glass, plastic, silicon, an adhesive, or a combination thereof. In embodiments, the spacer element includes a first adhesive in contact with the functionalized glass slide and second adhesive in contact with the second solid support. In embodiments, the spacer element includes a first adhesive in contact with the first solid support, a second adhesive in contact with the second solid support, and a carrier material in contact with the first adhesive and the second adhesive.

### III. Methods

In an aspect is provided a method of making a flow cell assembly, the method including: binding a polymer to a first solid support; binding a coupling agent to the polymer; attaching a cell or tissue to the coupling agent; and affixing a second solid support to the first solid support, wherein the first solid support or the second solid support includes a port (e.g., an inlet or outlet port). In embodiments, the polymer is a resist described herein. In embodiments, the first solid support includes 2-4 inlet ports and 2-4 outlet ports. In embodiments, the second solid support includes 2-4 inlet ports and 2-4 outlet ports. The inlets and outlets can be ports that are configured to mate with fluidic channels external to the flow cell.

In an aspect is provided a method of making a flow cell assembly, the method including: binding a resist to a first solid support; attaching a cell or tissue to the resist; and affixing a second solid support to the first solid support, wherein the first solid support or the second solid support includes a port (e.g., an inlet or outlet port). In embodiments, the first solid support includes 2-4 inlet ports and 2-4 outlet ports. In embodiments, the second solid support includes 2-4 inlet ports and 2-4 outlet ports.

In an aspect is provided a method of making a flow cell assembly, the method including: binding a resist to a first solid support; binding a coupling agent to the resist; attaching a cell or tissue to the coupling agent; and affixing a second solid support to the first solid support, wherein the first solid support or the second solid support includes a port (e.g., an inlet or outlet port). In embodiments, the first solid support includes 2-4 inlet ports and 2-4 outlet ports. In embodiments, the second solid support includes 2-4 inlet ports and 2-4 outlet ports. Fluid channels and chambers may be sealed by placing the first planar surface of the first solid support in contact with, and bonding to, the planar surface of a second solid support to form the channels and/or chambers (e.g., the interior portion) of the device at the interface of these two components. In embodiments, the assembly includes openings that are oriented such that they are in fluid communication with at least one of the fluid channels and/or fluid chambers formed in the interior portion of the device, thereby forming fluid inlets and/or fluid outlets. In some instances, the openings are formed on the first solid support. In embodiments, the openings are formed on the first and the second solid support. In embodiments, the openings are positioned at the top side of the assembly. In embodiments, the openings are positioned at the bottom side of the assembly. In embodiments, the openings are positioned at the first and/or the second ends of the device, and the channels run along the direction from the first end to the second end.

In embodiments, the method further includes contacting the polymer or coupling agent with a plurality of particles. In embodiments, the method includes contacting the resist with a plurality of particles. In embodiments, the method further includes contacting the polymer attached to the first solid support with a plurality of particles. In embodiments, the method further includes contacting the coupling agent attached to the polymer with a plurality of particles. In embodiments, the method further includes contacting the first solid support with a plurality of particles. In embodiments, the method further includes sonicating the plurality of particles prior to deposition onto the solid support. In embodiments, the method further includes dissolving the particles in an organic solvent to generate a solution of particles, followed by contacting the polymer or coupling agent with the solution of particles for about 1 minute, about 2 minutes, about 3 minutes, about 4 minutes, about 5 minutes, about 6 minutes, about 7 minutes, about 8 minutes, about 9 minutes, about 10 minutes, about 15 minutes, about 20 minutes, about 30 minutes, about 35 minutes, about 40 minutes, about 45 minutes, about 50 minutes, about 55 minutes, or about 60 minutes.

In another aspect is provided a method of making a flow cell assembly. In embodiments, the method includes binding a first solid support and a second solid support together, wherein the first solid support or the second solid support includes an inlet port. In embodiments, the first solid support includes a polymer, a coupling agent, and a cell or tissue. In embodiments, the first solid support includes a resist, a coupling agent, and a cell or tissue. In embodiments, the first solid support includes a polymer and a cell or tissue. In embodiments, the second solid support include an adhesive. In embodiments, the second solid support includes a spacer element. In embodiments, the second solid support is configured to define a reaction chamber when attached to the first solid support.

In embodiments, binding the polymer described herein or resist described herein to the first solid support includes rinsing the solid support with an alcohol, where the concentration of alcohol (v/v) is about 90%, about 91%, about 92%, about 93%, about 94%, about 95%, about 96%, about 97%, about 98%, or about 99% alcohol. In embodiments, the alcohol is ethanol, propanol, isopropanol, methanol, or butanol.

In embodiments, binding the polymer described herein or resist described herein to the first solid support includes rinsing the solid support in ethanol, where the concentration of ethanol (v/v) is about 90%, about 91%, about 92%, about 93%, about 94%, about 95%, about 96%, about 97%, about 98%, or about 99% ethanol. In embodiments, the concentration of ethanol (v/v) is about 95.5% ethanol. In embodiments, the concentration of ethanol (v/v) is about 99.5% ethanol. In embodiments, the concentration of ethanol (v/v) is about 99.9% ethanol.

In embodiments, binding the polymer described herein or resist described herein to the first solid support includes contacting (e.g., incubating) the solid support with the polymer described herein or the resist described herein for about 15 minutes, approximately 30 minutes, about 1 hour, about 2 hours, about 3 hours, about 4 hours, about 5 hours, about 6 hours, about 7 hours, about 8 hours, about 9 hours, about 10 hours or more. In embodiments, binding the polymer described herein or the resist described herein to the first solid support includes contacting the solid support with the polymer described herein or the resist described herein for about 30 minutes. In embodiments, binding the polymer described herein or the resist described herein to the first solid support includes contacting the solid support with the polymer described herein or the resist described herein for about 1 hour. In embodiments, binding the polymer described herein or the resist described herein to the first solid support includes contacting the solid support with the polymer described herein or the resist described herein for about 2 hours.

In embodiments, binding the polymer described herein or the resist described herein to the first solid support further includes rinsing the solid support. In embodiments, rinsing includes contacting with a silane compound (e.g., compounds where silicon may be bonded to groups such as chlorine (as in chlorosilanes), methyl groups (as in alkylsilanes), or a combination of these (as in chlorotrimethylsilane, CTMS). In embodiments, rinsing the solid support includes contacting the solid support with hexamethyldisilazane (HDMS), trimethylchlorosilane (TMCS), tetramethylsilane (TMS), dimethyl sulfoxide (DMSO), trichlorosilane (TMS), cyclohexane, dichlorodimethylsilane, or chlorotrimethylsilane (CTMS).

In embodiments, binding the coupling agent to the polymer described herein or the resist described herein includes contacting polymer layer described herein or the resist described herein on the first solid support with the coupling agent for approximately 5 minutes, about 10 minutes, about 20 minutes, about 30 minutes, about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, about 24 hours or more at room temperature. In embodiments, binding the coupling agent to the polymer described herein or the resist described herein includes contacting polymer layer described herein or the resist described herein on the first solid support with the coupling agent for about 1 to 3 hours at room temperature. In embodiments, binding the coupling agent to the polymer described herein or the resist described herein includes contacting polymer layer described herein or the resist described herein on the first solid support with the coupling agent for about 5 to 10 hours at room temperature. In embodiments, binding the coupling agent to the polymer described herein or the resist described herein includes contacting polymer layer described herein or the resist described herein on the first solid support with the coupling agent for about 8 to 16 hours at room temperature. In embodiments, binding the coupling agent to the polymer described herein or the resist described herein includes contacting polymer layer described herein or the resist described herein on the first solid support with the coupling agent for about 8 to 24 hours at room temperature.

In embodiments, binding the coupling agent to the polymer described herein or the resist described herein includes contacting polymer layer described herein or the resist described herein on the first solid support with coupling agent, where the concentration (in solution) of the coupling agent is 1%, 2%, 3%, 4%, 5%, 66%, 7%, 8%, 9%, 10%, 11%, 12%, 13%, 14%, 15%, 16%, 17%, 18%, 19%, 20%, or greater. In embodiments, binding the coupling agent to the polymer described herein or the resist described herein includes contacting polymer layer described herein or the resist described herein on the first solid support with coupling agent, where the concentration (in solution) of the coupling agent is about 1% to 5% of the coupling agent. In embodiments, binding the coupling agent to the polymer described herein or the resist described herein includes contacting polymer layer described herein or the resist described herein on the first solid support with coupling agent, where the concentration (in solution) of the coupling agent is about 5% to 15% of the coupling agent. In embodiments, binding the coupling agent to the polymer described herein or the resist described herein includes contacting polymer layer described herein or the resist described herein on the first solid support with coupling agent, where the concentration (in solution) of the coupling agent is about 15% to 20% of the coupling agent. In embodiments, binding the coupling agent to the polymer described herein or the resist described herein includes contacting polymer layer described herein or the resist described herein on the first solid support with coupling agent, where the concentration (in solution) of the coupling agent is about 15% to 50% of the coupling agent.

In embodiments, binding the coupling agent to the polymer described herein or the resist described herein includes contacting polymer layer described herein or the resist described herein on the first solid support with coupling agent, where the mass fraction of the coupling agent by weight percent is about 0.010%, about 0.05%, about 0.10%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10% or greater. In embodiments, the mass fraction of the coupling agent by weight percent is a percentage of the quotient of the weight of the coupling agent and the weight of the solvent. In embodiments, binding the coupling agent to the polymer described herein or the resist described herein includes contacting polymer layer described herein or the resist described herein on the first solid support with coupling agent, where the mass fraction of the coupling agent by weight percent is about 0.01%. In embodiments, binding the coupling agent to the polymer described herein or the resist described herein includes contacting polymer layer described herein or the resist described herein on the first solid support with coupling agent, where the mass fraction of the coupling agent by weight percent is about 0.05%. In embodiments, binding the coupling agent to the polymer described herein or the resist described herein includes contacting polymer layer described herein or the resist described herein on the first solid support with coupling agent, where the mass fraction of the coupling agent by weight percent is about 0.1%. In embodiments, binding the coupling agent to the polymer described herein or the resist described herein includes contacting polymer layer described herein or the resist described herein on the first solid support with coupling agent, where the mass fraction of the coupling agent by weight percent is about 0.5%.

In embodiments, binding the coupling agent to the polymer described herein or the resist described herein includes contacting polymer layer described herein or the resist described herein on the first solid support with coupling agent, where the concentration of the coupling agent is 1 mg/mL, 2 mg/mL, 3 mg/mL, 4 mg/mL, 5 mg/mL, 6 mg/mL, 7 mg/mL, 8 mg/mL, 9 mg/mL, 10 mg/mL, 11 mg/mL, 12 mg/mL, 13 mg/mL, 14 mg/mL, 15 mg/mL, 16 mg/mL, 17 mg/mL, 18 mg/mL, 19 mg/mL, 20 mg/mL, or greater. In embodiments, binding the coupling agent to the polymer described herein or the resist described herein includes contacting polymer layer described herein or the resist described herein on the first solid support with coupling agent, where the concentration of the coupling agent is about 1 mg/mL to 5 mg/mL of the coupling agent. In embodiments, binding the coupling agent to the polymer described herein or the resist described herein includes contacting polymer layer described herein or the resist described herein on the first solid support with coupling agent, where the concentration of the coupling agent is about 5 mg/mL to 15 mg/mL of the coupling agent. In embodiments, binding the coupling agent to the polymer described herein or the resist described herein includes contacting polymer layer described herein or the resist described herein on the first solid support with coupling agent, where the concentration of the coupling agent is about 15 mg/mL to 20 mg/mL of the coupling agent.

In embodiments, binding the coupling agent to the polymer described herein or the resist described herein further includes a wash step with sodium hydroxide solution, where the concentration of sodium hydroxide solution is about 0.01 M, 0.1 M, 0.2 M, 0.3 M, 0.4 M, 0.5 M, 0.6 M, 0.7 M, 0.8 M, 0.9 M, 1 M, or greater. In embodiments, binding the coupling agent to the polymer described herein or the resist described herein further includes a wash step with sodium hydroxide solution, where the concentration of sodium hydroxide solution is about between 0.01 M to 0.5 M. In embodiments, binding the coupling agent to the polymer described herein or the resist described herein further includes a wash step with sodium hydroxide solution, where the concentration of sodium hydroxide solution is about between 0.1 M to 0.5 M. In embodiments, binding the coupling agent to the polymer described herein or the resist described herein further includes a wash step with sodium hydroxide solution, where the concentration of sodium hydroxide solution is about between 0.5 M to 1 M.

In embodiments, affixing the second solid support to the first solid support includes applying pressure to create a fluidic leak-free seal between the first and second solid supports. In embodiments, applying pressure forms a bond between the gasket and the first and second solid supports. In embodiments, affixing the second solid support to the first solid support includes using a UV curable adhesive attached to the second solid support, where the UV curable adhesive is cured when exposed to wavelengths between 365 nm to 380 nm. In embodiments, affixing the second solid support to the first solid support includes using a UV curable adhesive attached to the second solid support, where the UV curable adhesive is cured when exposed to wavelengths between 380 nm to 405 nm. In embodiments, affixing the second solid support to the first solid support includes using a UV curable adhesive attached to the second solid support, where the UV curable adhesive is cured when exposed to wavelength of 405 nm.

In embodiments, the UV-curing adhesive cures when exposed to UV light for about 1 minute, about 5 minutes, about 10 minutes, about 15 minutes, about 20 minutes, about 25 minutes, about 30 minutes, about 40 minutes, about 50 minutes, about 60 minutes, about 70 minutes, about 80 minutes, about 90 minutes, or about 100 minutes. In embodiments, the UV-curing adhesive cures when exposed to UV light for about 10 minutes. In embodiments, the UV-curing adhesive cures when exposed to UV light for about 15 minutes. In embodiments, the UV-curing adhesive cures when exposed to UV light for about 20 minutes. In embodiments, the UV-curing adhesive cures when exposed to UV light for about 30 minutes.

In embodiments, affixing the second solid support to the first solid support includes using a spacer element. In embodiments, the spacer element includes an adhesive. In embodiments, the spacer element includes a pressure sensitive adhesive (PSA) attached to the second solid support, where the pressure sensitive adhesive is affixed with the application of pressure of about 5 psi, 6 psi, 7 psi, 8 psi, 9 psi, 10 psi, 11 psi, 12 psi, 13 psi, 14 psi, 15 psi, 16 psi, 17 psi, 18 psi, 19 psi, 20 psi, or more. In embodiments, the spacer element includes a pressure sensitive adhesive (PSA) attached to the second solid support, where the pressure sensitive adhesive is affixed with the application of pressure of about 20 psi, 21 psi, 22 psi, 23 psi, 24 psi, 25 psi, 26 psi, 27 psi, 28 psi, 29 psi, 30 psi, 31 psi, 32 psi, 33 psi, 34 psi, 35 psi, 36 psi, 37 psi, 38 psi, 39 psi, 40 psi, 41 psi, 42 psi, 43 psi, 44 psi, 45 psi, 46 psi, 47 psi, 48 psi, 49 psi, 50 psi, 51 psi, 52 psi, 53 psi, 54 psi, 55 psi, 56 psi, 57 psi, 58 psi, 59 psi, 60 psi, 61 psi, 62 psi, 63 psi, 64 psi, 65 psi, 66 psi, 67 psi, 68 psi, 69 psi, 70 psi, 71 psi, 72 psi, 73 psi, 74 psi, 75 psi, 76 psi, 77 psi, 78 psi, 79 psi, 80 psi, 81 psi, 82 psi, 83 psi, 84 psi, 85 psi, 86 psi, 87 psi, 88 psi, 89 psi, 90 psi, 91 psi, 92 psi, 93 psi, 94 psi, 95 psi, 96 psi, 97 psi, 98 psi, 99 psi, 100 psi, or more. In embodiments, the spacer element includes a pressure sensitive adhesive (PSA) attached to the second solid support, where the pressure sensitive adhesive is affixed with the application of pressure between about 10-15 psi. In embodiments, the spacer element includes a pressure sensitive adhesive (PSA) attached to the second solid support, where the pressure sensitive adhesive is affixed with the application of pressure between about 10-20 psi. In embodiments, the spacer element includes a pressure sensitive adhesive (PSA) attached to the second solid support, where the pressure sensitive adhesive is affixed with the application of pressure of about 10 psi. In embodiments, the spacer element includes a pressure sensitive adhesive (PSA) attached to the second solid support, where the pressure sensitive adhesive is affixed with the application of pressure of about 15 psi. In embodiments, the spacer element includes a pressure sensitive adhesive (PSA) attached to the second solid support, where the pressure sensitive adhesive is affixed with the application of pressure of about 20 psi. In embodiments, the spacer element includes a pressure sensitive adhesive (PSA) attached to the second solid support, where the pressure sensitive adhesive is affixed with the application of pressure of about 25 psi. In embodiments, the spacer element includes a pressure sensitive adhesive (PSA) attached to the second solid support, where the pressure sensitive adhesive is affixed with the application of pressure of about 30 psi. In embodiments, affixing includes heating the assembly (e.g., heating to 40, 50, 60, or 70° C.).

In embodiments, affixing the second solid support to the first solid support placing the first solid support described herein and the second solid support described herein and applying uniform pressure.

In embodiments, the method includes attaching the first solid support and a second solid support with a gasket between the first solid support and the second solid support wherein the gasket is double-sided tape. In embodiments, the method includes attaching the first solid support and a second solid support with a double-sided tape between the first solid support and the second solid support, wherein the first solid support includes drilled ports. In embodiments, the method includes attaching the first solid support and a second solid support with a double-sided tape between the first solid support and the second solid support, wherein the second solid support includes drilled ports.

In embodiments, the thickness of the double-sided tape is 5 about μm, 10 about μm, 15 about μm, 20 about μm, 25 about μm, 30 about μm, 35 about μm, 40 about μm, 45 about μm, or 50 about μm. In embodiments, the thickness of the double-sided tape is 5 about μm. In embodiments, the thickness of the double-sided tape is 10 about μm. In embodiments, the thickness of the double-sided tape is 15 about μm. In embodiments, the thickness of the double-sided tape is 20 about μm.

In an aspect is provided a method of detecting a biomolecule in or on a cell or tissue. In embodiments, the method includes immobilizing a cell or tissue including a biomolecule to a solid support, wherein the solid support includes a polymer attached to the solid support, and a coupling agent attached to the polymer; attaching a second solid support to the first solid support; contacting the biomolecule in or on the cell or tissue with a detection agent including a label; detecting the label, thereby detecting the biomolecule. In embodiments, the method includes imaging the tissue section.

In an aspect is provided a method of detecting a biomolecule in or on a cell or tissue. In embodiments, the method includes immobilizing a cell or tissue including a biomolecule to a first solid support, wherein the first solid support includes a polymer attached to the first solid support, and a coupling agent attached to the polymer; attaching a second solid support to the first solid support; contacting the biomolecule in the cell or tissue with a detection agent including a label; detecting the label, thereby detecting the biomolecule. In embodiments, the method includes imaging the tissue section.

In an aspect is provided a method of detecting a biomolecule in or on a cell or tissue. In embodiments, the method includes immobilizing a cell or tissue including a biomolecule to a first solid support, wherein the first solid support includes a resist attached to the first solid support; attaching a second solid support to the first solid support; contacting the biomolecule in or on the cell or tissue with a detection agent including a label; detecting the label, thereby detecting the biomolecule. In embodiments, the method includes imaging the tissue section.

In an aspect is provided a method of detecting a biomolecule in or on a cell or tissue. In embodiments, the method includes immobilizing a cell or tissue including a biomolecule to a first solid support, wherein the first solid support includes a resist attached to the first solid support, and a coupling agent attached to the resist; attaching a second solid support to the first solid support; contacting the biomolecule in the cell or tissue with a detection agent including a label; detecting the label, thereby detecting the biomolecule. In embodiments, the method includes imaging the tissue section.

In embodiments, the method includes detecting biomolecules in a tissue, the method including: (i) binding a first polynucleotide probe to a first nucleic acid molecule in the tissue and incorporating a sequence of the first nucleic acid molecule into the first polynucleotide probe; amplifying the first polynucleotide probe to form a first amplification product; and binding a first fluorescently labeled nucleotide to the first amplification product; (ii) binding a second polynucleotide probe to an oligonucleotide, wherein the oligonucleotide is attached to a protein in the tissue; amplifying the second polynucleotide probe to form a second amplification product; and binding a second fluorescently labeled nucleotide to the second amplification product; (iii) contacting the tissue with a stain; and (iv) directing an excitation light to the tissue section and detecting an emission light from the first fluorescently labeled nucleotide, the second fluorescently labeled nucleotide, and the stain. A stain is a chemical agent used to selectively color components of biological tissues or cells to enhance their visibility under a microscope. Stains typically bind to specific cellular structures or organelles, such as proteins, nucleic acids, lipids, or carbohydrates, allowing for the differentiation and identification of these structures. In embodiments, the stain is a fluorescent stain (e.g., an intrinsic stain). Intrinsic or fluorescent stains are chemical compounds that possess the inherent ability to emit fluorescence when exposed to specific wavelengths of light, thereby enabling the visualization of biological structures without the need for additional staining agents; examples include eosin, which absorbs light in the blue-green part of the spectrum (around 490-520 nm) and emits light in the green-yellow part of the spectrum (around 520-550 nm), and Hoechst stains, which bind to DNA and emit blue fluorescence around 461 nm. In embodiments, detecting includes directing an excitation light to the cell or tissue and detecting an emission light from the stain.

In embodiments, the method includes contacting the cell or tissue including the template polynucleotide with an oligonucleotide-specific binding agent including a first target hybridization sequence and a second target hybridization sequence; hybridizing the first target hybridization sequence to the template polynucleotide and hybridizing the second target hybridization sequence to the template polynucleotide; ligating the first target hybridization sequence to the second target hybridization sequence to form a circular polynucleotide; amplifying the circular polynucleotide to form an amplification product; and hybridizing a first sequencing primer to the amplification product, and sequencing the first target hybridization sequence or the second target hybridization sequence.

In embodiments, the method includes immobilizing a plurality of tissue sections to the first solid support, wherein a tissue in a plurality of tissue sections includes the biomolecule to be detected. In embodiments, the method includes immobilizing 24 tissue sections (10 mm×17 mm sections). In embodiments, the method includes immobilizing 40 tissue sections (10 mm×10 mm sections). In embodiments, the method includes immobilizing 128 tissue sections (4 m×4 m sections).

The cell or tissue may be manipulated prior to immobilizing the cell or tissue onto a solid support using known techniques in the art (see, e.g., PCT Publication WO2023076832A1). In embodiments, the method further includes cutting a sample portion from the biological sample (e.g., including cells or tissues) using a punch device such that the punch device contains the sample portion; mounting the punch device containing the sample portion onto the first solid support as described herein (e.g., inverting the punch device); pushing the sample portion out of the punch device using a piston, so that all or a portion thereof of the sample portion is positioned on the first solid support as described herein. In embodiments, the method further includes cutting a sample portion from the biological sample using two or more punch devices such that each punch device contains a different the sample portion; mounting each punch device containing the sample portion onto the first solid support as described herein; pushing the sample portions out of the punch devices using one or more pistons so that the sample portions are positioned onto the first solid support as described herein.

In embodiments, the biomolecule is a nucleic acid molecule, carbohydrate, or protein. In embodiments, the biomolecule is a nucleic acid molecule. In embodiments, the biomolecule is a carbohydrate. In embodiments, the biomolecule is a protein. In embodiments, a biomolecule is a cell surface protein. In embodiments, a biomolecule is a cell surface marker. In embodiments, the biomolecule is a cluster of differentiation (CD) marker. The biomolecule to be detected can be any biological molecules including but not limited to proteins, nucleic acids, lipids, carbohydrates, ions, or multicomponent complexes containing any of the above. In embodiments, the biomolecule is an intracellular organelle. Examples of subcellular targets include organelles, e.g., mitochondria, Golgi apparatus, endoplasmic reticulum, chloroplasts, endocytic vesicles, exocytic vesicles, vacuoles, lysosomes, etc. Exemplary nucleic acid targets can include genomic DNA of various conformations (e.g., A-DNA, B-DNA, Z-DNA), mitochondria DNA (mtDNA), mRNA, tRNA, rRNA, hRNA, miRNA, and piRNA. In embodiments, the biomolecule is a non-nucleic acid target. Non-nucleic acid targets include, but are not limited to, lipids, carbohydrates, peptides, proteins, glycoproteins, lipoproteins, phosphoproteins, acetylated variants of proteins, amidation variants of proteins, hydroxylation variants of proteins, methylation variants of proteins, ubiquitylation variants of proteins, sulfation variants of proteins, viral coat proteins, extracellular and intracellular proteins, antibodies, and antigen binding fragments. In embodiments, the biomolecule is located within the cell. In embodiments, the biomolecule is located on the surface of the cell. In embodiments, the biomolecule is attached on a cell surface, such as a transmembrane analyte.

A biomolecule to be detected or a plurality of biomolecules to be detected using the methods described herein can be isolated or obtained from a sample. A sample can be any specimen that is isolated or obtained from a subject or part thereof. A sample can be any specimen that is isolated or obtained from multiple subjects. Non-limiting examples of specimens include fluid or tissue from a subject, including, without limitation, blood or a blood product (e.g., serum, plasma, platelets, buffy coats, or the like), umbilical cord blood, chorionic villi, amniotic fluid, cerebrospinal fluid, spinal fluid, lavage fluid (e.g., lung, gastric, peritoneal, ductal, ear, arthroscopic), a biopsy sample, celocentesis sample, cells (blood cells, lymphocytes, placental cells, stem cells, bone marrow derived cells, embryo or fetal cells) or parts thereof (e.g., mitochondrial, nucleus, extracts, or the like), urine, feces, sputum, saliva, nasal mucous, prostate fluid, lavage, semen, lymphatic fluid, bile, tears, sweat, breast milk, breast fluid, the like or combinations thereof. Non-limiting examples of tissues include organ tissues (e.g., liver, kidney, lung, thymus, adrenals, skin, bladder, reproductive organs, intestine, colon, spleen, brain, the like or parts thereof), epithelial tissue, hair, hair follicles, ducts, canals, bone, eye, nose, mouth, throat, ear, nails, the like, parts thereof or combinations thereof. A sample may include cells or tissues that are normal, healthy, diseased (e.g., infected), and/or cancerous (e.g., cancer cells). A sample obtained from a subject may include cells or cellular material (e.g., nucleic acids) of multiple organisms (e.g., virus nucleic acid, fetal nucleic acid, bacterial nucleic acid, parasite nucleic acid). A sample may include a cell and RNA transcripts. A sample can include nucleic acids obtained from one or more subjects. In some embodiments a sample may include nucleic acid obtained from a single subject.

In embodiments, the biomolecule is on the surface of the tissue section or on the surface of the cell. In embodiments, the detection agent includes a protein-specific binding agent. In embodiments, the detection agent includes a protein-specific binding agent bound to a nucleic acid sequence (e.g., a nucleic acid label), bioconjugate reactive moiety, an enzyme, or a fluorophore. In embodiments, the protein-specific binding agent is an antibody, single domain antibody, single-chain Fv fragment (scFv), antibody fragment-antigen binding (Fab), affimer, or an aptamer. In embodiments, the protein-specific binding agent is an antibody. In embodiments, the protein-specific binding agent is a single domain antibody. In embodiments, the protein-specific binding agent is a single-chain Fv fragment (scFv). In embodiments, the protein-specific binding agent is an antibody fragment-antigen binding (Fab). In embodiments, the protein-specific binding agent is an affimer. In embodiments, the protein-specific binding agent is an aptamer. In embodiments, a protein-specific binding agent is a protein-specific antibody-oligo (Ab-O) conjugate.

In embodiments, the detection agent is a biomolecule-specific binding agent. In embodiments, the biomolecule-specific binding agent is a protein-specific binding agent. In embodiments, the biomolecule-specific binding agent is an oligonucleotide-specific binding agent. In embodiments, the biomolecule-specific binding agent is capable of binding to a cluster of differentiation (CD) marker, integrin, selectin, cadherin, cytokine receptor, chemokine receptor, Toll-like receptor (TLR), ion channel, transmembrane protein, lipoprotein, glycoprotein, cell surface protein, transport protein, intracellular organelle, or transcription factor. In embodiments, the intracellular organelle includes actin, carbohydrate, centrosomes and centrioles, chloroplasts (in plant cells and some protists), cytoskeleton, endoplasmic reticulum, endosome, Golgi apparatus, intermediate filaments, lysosome, microfilaments, microtubules, mitochondria, nuclear envelope, nuclear pores, nucleoid, nucleolus, nucleus, peroxisome, phosphatidylserine, plasma membrane, ribosomes, rough endoplasmic reticulum, smooth endoplasmic reticulum, transferrin receptor, transport vesicles, and/or vacuoles. In embodiments, the biomolecule specific binding agent is capable of binding to a biomolecule in the mitogen-activated protein kinase (MAPK) pathway, PI3K/AKT/mTOR pathway, Wnt/β-catenin pathway, intrinsic (mitochondrial) pathway, extrinsic (death receptor) pathway, caspase cascade, Notch signaling pathway, hedgehog signaling pathway, TGF-β (transforming growth factor Beta) pathway, JAK/STAT pathway, G-protein coupled receptor (GPCR) pathway, calcium signaling pathway, glycolysis, citric acid cycle (Krebs Cycle), oxidative phosphorylation, lipid metabolism pathway, amino acid metabolism, Toll-like receptor (TLR) pathway, NF-κB signaling pathway, complement pathway, nucleotide excision repair (NER), base excision repair (BER), mismatch repair (MMR), cyclin-dependent kinase (CDK) pathway, Rb (retinoblastoma) pathway, p53 pathway, unfolded protein response (UPR), heat shock response pathway, oxidative stress pathway, BMP (bone morphogenetic protein) pathway, FGF (fibroblast growth factor) pathway, Sonic Hedgehog pathway, neurotrophin signaling pathway, synaptic transmission pathway, axon guidance pathways, insulin signaling pathway, thyroid hormone pathway, steroid hormone pathway, VEGF (vascular endothelial growth factor) pathway, DNA methylation pathway, histone modification pathway, or angiogenesis. In embodiments, the biomolecule specific binding agent is capable of binding to a biomolecule on the surface of or in a B cell, Mature B Cell, Follicular B cell, Marginal Zone B cell, Short lived plasma cell, Memory B cell, Long lived plasma cell, B1 cell, Breg, Germinal Center B cell, Macrophage, Monocyte, M1 macrophage, M2 macrophage, Dendritic Cell, Plasmacytoid dendritic cell, Monocyte-derived dendritic cell, T cell, T Follicular Helper, Th1, Th2, Th9, Th17, Th22, Treg, platelet (activated), platelet (rested), natural killer cell, neutrophil, basophil, eosinophil, mast cell, astrocyte, neuron, glial cell, lymphocyte, myeloid cell, granulocytes, neural cells, stem cells, endothelial cells, epithelial cells, mesenchymal stem cell, hematopoietic stem cell, embryonic stem, stromal cell, erythrocyte, fibroblast, or apoptotic cell.

In embodiments, the detection agent includes a protein-specific binding agent or oligonucleotide-specific binding agent. In embodiments, the detection agent includes a protein-specific binding agent. In embodiments, the detection agent includes an oligonucleotide-specific binding agent.

In embodiments, the detection agent includes an oligonucleotide-specific binding agent including a nucleic acid sequence, bioconjugate reactive moiety, an enzyme, or a fluorophore.

In embodiments, the detection agent is an oligonucleotide-specific binding agent capable of hybridizing to a target oligonucleotide sequence in a tissue section. In embodiments, the detection agent is an oligonucleotide. In embodiments, the detection agent is an oligonucleotide, wherein the oligonucleotide includes: a) a first region at a 3′ end that is hybridized to a first complementary region of the polynucleotide, and b) a second region at a 5′ end that is hybridized to a second complementary region of the polynucleotide, wherein the second complementary region is 5′ with respect to the first complementary region. In embodiments, the method includes i) circularizing the oligonucleotide agent to generate a circular oligonucleotide and ligating the oligonucleotide-specific binding agent; ii) amplifying the circular oligonucleotide by extending an amplification primer hybridized to the circular oligonucleotide with a strand-displacing polymerase, wherein the amplification primer extension generates an extension product including multiple complements of the circular oligonucleotide; and iii) sequencing the extension product of step (ii). In embodiments, circularizing the oligonucleotide-specific binding agent includes extending the 3′ end of the oligonucleotide-specific binding agent (using a polymerase to incorporate one or more nucleotides) along the target nucleic acid to generate a complementary sequence and ligating the extended 3′ end of the oligonucleotide-specific binding agent to the 5′ end of the oligonucleotide-specific binding agent. In embodiments, the circular oligonucleotide includes a barcode sequence. In embodiments, circularizing in step i) further includes extending the 3′ end of the oligonucleotide primer (e.g., extending the 3′ end of the primer using a polymerase (e.g., a Thermus thermophilus (Tth) DNA polymerase) to incorporate one or more nucleotides) along the target nucleic acid to generate a complementary sequence (e.g., complementary to the target nucleic acid, for example a target RNA sequence) prior to ligating the complementary sequence to the 5′ end of the oligonucleotide primer. In embodiments, the oligonucleotide is an oligonucleotide primer.

In embodiments, the label is a nucleic acid sequence. In embodiments, a label is a bioconjugate reactive moiety. In embodiments, a label is an enzyme. In embodiments, a label is a fluorophore.

In embodiments, the detection agent includes a label. In embodiments, the label is an oligonucleotide label, wherein the nucleotide sequence of the oligonucleotide label is known a priori (e.g., prior to contacting the detection agent with the biomolecule of interest), and the detection of the oligonucleotide label is associated with the detection of the biomolecule of interest (e.g., a protein or nucleic acid molecule of interest).

In embodiments, the oligonucleotide is about 50 to about 500 nucleotides in length. In embodiments, the oligonucleotide is about 50 to about 300 nucleotides in length. In embodiments, the oligonucleotide is about 80 to about 300 nucleotides in length. In embodiments, the oligonucleotide is about 50 to about 150 nucleotides in length. In embodiments, the oligonucleotide is about or more than about 40, 50, 75, 100, 125, 150, 175, 200, 250, 300, 350, 400, or 500 nucleotides in length. In embodiments, the oligonucleotide is less than about 50, 75, 100, 125, 150, 175, 200, 250, 300, 350, 400, or 500 nucleotides in length.

In embodiments, the oligonucleotide includes at least one target-specific region. In embodiments, the oligonucleotide includes two target-specific regions. In embodiments, the oligonucleotide includes at least one flanking-target region (i.e., an oligonucleotide sequence that flanks the region of interest). In embodiments, the oligonucleotide includes two flanking-target regions. A target-specific region is a single stranded polynucleotide that is at least 50% complementary, at least 75% complementary, at least 85% complementary, at least 90% complementary, at least 95% complementary, at least 98%, at least 99% complementary, or 100% complementary to a portion of a nucleic acid molecule that includes a target sequence (e.g., a gene of interest). In embodiments, the target-specific region is capable of hybridizing to at least a portion of the target sequence. In embodiments, the target-specific region is substantially non-complementary to other target sequences present in the sample. In embodiments, the oligonucleotide is a padlock probe. Padlock probes are specialized ligation probes, examples of which are known in the art, see for example Nilsson M, et al. Science. 1994; 265(5181):2085-2088), and has been applied to detect transcribed RNA in cells, see for example Christian A T, et al. Proc Natl Acad Sci USA. 2001; 98(25):14238-14243, both of which are incorporated herein by reference in their entireties.

Typically, padlock probes hybridize to adjacent sequences and are then ligated together to form a circular oligonucleotide. In embodiments, the oligonucleotide hybridize to sequences adjacent to the target nucleic acid sequence resulting in a gap (e.g., a gap spanning the length of the target nucleic acid sequence). The construction of the oligonucleotide allows for selective targeting, enabling detection of specific targets within the cell or tissue section. In embodiments, the method further includes amplifying and sequencing the oligonucleotide.

In embodiments, the label is a fluorescent moiety that has a maximum excitation wavelength between 350-400 nm, between 400-450 nm, between 450-500 nm, between 500-550 nm, between 550-600 nm, between 600-650 nm, between 650-700 nm, or between 700-750 nm. In embodiments, the label is a fluorescent moiety that has a maximum emission wavelength between 400-450 nm, between 450-500 nm, between 500-550 nm, between 550-600 nm, between 600-650 nm, between 650-700 nm, between 700-750 nm, between 750-800 nm, or between 800-850 nm.

In embodiments, detecting a biomolecule in or on a cell or tissue includes detecting a plurality of different targets within an optically resolved volume of a cell or tissue immobilized onto the first solid support described herein. In embodiments, the method includes i) associating a different oligonucleotide barcode from a known set of barcodes with each of the plurality of targets; ii) sequencing each barcode to obtain a multiplexed signal in the cell or tissue; iii) demultiplexing the multiplexed signal by comparison with the known set of barcodes; and iv) detecting the plurality of targets by identifying the associated barcodes detected in the cell or tissue. In embodiments, the method includes detecting a plurality of targets (e.g., a nucleic acid sequence or a protein) within an optically resolved volume of a sample (e.g., a voxel). In embodiments, the method includes i) associating an oligonucleotide barcode with each of the plurality of targets; ii) sequencing each barcode to obtain a multiplexed signal; and iii) demultiplexing the multiplexed signal to obtain a set of signals corresponding to barcodes with a specified Hamming distance; thereby detecting a plurality of targets within an optically resolved volume of a sample.

In embodiments, detecting a biomolecule in or on a cell or tissue includes detecting a plurality of different nucleic acid sequences within an optically resolved volume of cell or tissue immobilized onto the first solid support described herein, wherein the method includes i) associating a different oligonucleotide barcode from a known set of barcodes with each of the plurality of targets, wherein associating an oligonucleotide barcode with each of the plurality of targets includes hybridizing a padlock probe to two adjacent nucleic acid sequences of the target, wherein the padlock probe is a single-stranded polynucleotide having a 5′ and a 3′ end, and wherein the padlock probe includes a primer binding sequence from a known set of primer binding sequences; ii) sequencing each barcode to obtain a multiplexed signal in the cell or tissue; iii) demultiplexing the multiplexed signal by comparison with the known set of barcodes; and iv) detecting the plurality of targets by identifying the associated barcodes detected in the cell.

In embodiments, detecting a biomolecule in or on a cell or tissue includes detecting a plurality of proteins (e.g., different proteins) within an optically resolved volume of a cell or tissue immobilized onto the first solid support described herein, wherein the method includes i) associating a different oligonucleotide barcode from a known set of barcodes with each of the plurality of targets, wherein associating an oligonucleotide barcode with each of the plurality of targets includes contacting each of the targets with a specific binding reagent, wherein the specific binding reagent includes an oligonucleotide barcode; ii) hybridizing a padlock probe to two adjacent nucleic acid sequences of the barcode, wherein the padlock probe is a single-stranded polynucleotide having a 5′ and a 3′ end, and wherein the padlock probe includes a primer binding sequence from a known set of primer binding sequences; iii) sequencing each barcode to obtain a multiplexed signal in the cell or tissue; iv) demultiplexing the multiplexed signal by comparison with the known set of barcodes; and v) detecting the plurality of targets by identifying the associated barcodes detected in the cell or tissue.

In embodiments, detecting a biomolecule in or on a cell or tissue includes detecting a plurality of proteins (e.g., different proteins) within an optically resolved volume of a cell or tissue immobilized onto the first solid support described herein, wherein the method includes i) associating a different oligonucleotide barcode from a known set of barcodes with each of the plurality of targets, wherein associating an oligonucleotide barcode with each of the plurality of targets includes contacting each of the targets with a specific binding reagent, wherein the specific binding reagent includes an oligonucleotide barcode; ii) sequencing each barcode to obtain a multiplexed signal in the cell or tissue; iii) demultiplexing the multiplexed signal by comparison with the known set of barcodes; and iv) detecting the plurality of targets by identifying the associated barcodes detected in the cell or tissue.

In embodiments, detecting a biomolecule in or on a cell or tissue includes a) detecting a plurality of proteins (e.g., different proteins), followed by b) detecting a plurality of different nucleic acid sequences within an optically resolved volume of cell or tissue immobilized onto the first solid support described herein. In embodiments, detecting a biomolecule in or on a cell or tissue includes a) detecting a plurality of nucleic acid sequences, followed by b) detecting a plurality of different proteins (e.g., different proteins within an optically resolved volume of cell or tissue immobilized onto the first solid support described herein.

In embodiments, the dimensions (i.e., the x, y, and z dimensions) of the optically resolved volume in a cell or tissue are about 0.5 μm×0.5 μm×0.5 μm; 1 μm×1 μm×1 μm; 2 μm×2 μm×2 μm; 0.5 μm×0.5 μm×1 μm; 0.5 μm×0.5 μm×2 μm; 2 μm×2 μm×1 μm; or 1 μm×1 μm×2 μm.

In embodiments, the method further includes amplifying a nucleic acid molecule (e.g., a nucleic acid molecule in a cell) to generate amplification products. In embodiments, amplifying includes contacting the flow cell assembly as described herein with one or more reagents for amplifying the target polynucleotide. Examples of reagents include but are not limited to polymerase, buffer, and nucleotides (e.g., an amplification reaction mixture). In certain embodiments the term “amplifying” refers to a method that includes a polymerase chain reaction (PCR). Conditions conducive to amplification (i.e., amplification conditions) are known and often include at least a suitable polymerase, a suitable template, a suitable primer or set of primers, suitable nucleotides (e.g., dNTPs), a suitable buffer, and application of suitable annealing, hybridization and/or extension times and temperatures. In embodiments, amplifying generates an amplicon. In embodiments, amplifying generates a rolony. In embodiments, an amplicon contains multiple, tandem copies of the circularized nucleic acid molecule of the corresponding sample nucleic acid. The number of copies can be varied by appropriate modification of the amplification reaction including, for example, varying the number of amplification cycles run, using polymerases of varying processivity in the amplification reaction and/or varying the length of time that the amplification reaction is run, as well as modification of other conditions known in the art to influence amplification yield. Generally, the number of copies of a nucleic acid in an amplicon is at least 100, 200, 500, 1000, 2000, 3000, 4000, 5000, 6000, 7000, 8000, 9000 and 10,000 copies, and can be varied depending on the application. As disclosed herein, one form of an amplicon is as a nucleic acid “ball” localized to the particle and/or well of the array. The number of copies of the nucleic acid can therefore provide a desired size of a nucleic acid “ball” or a sufficient number of copies for subsequent analysis of the amplicon, e.g., sequencing.

In embodiments, amplifying includes bridge polymerase chain reaction (bPCR) amplification, solid-phase rolling circle amplification (RCA), solid-phase exponential rolling circle amplification (eRCA), solid-phase recombinase polymerase amplification (RPA), solid-phase helicase dependent amplification (HDA), template walking amplification, or emulsion PCR on particles, or combinations of the methods. In embodiments, amplifying includes a bridge polymerase chain reaction amplification. In embodiments, amplifying includes a thermal bridge polymerase chain reaction (t-bPCR) amplification. In embodiments, amplifying includes a chemical bridge polymerase chain reaction (c-bPCR) amplification. Chemical bridge polymerase chain reactions include fluidically cycling a denaturant (e.g., formamide) and one or more additives (e.g., ethylene glycol) and maintaining the temperature within a narrow temperature range (e.g., +/−5° C.) or isothermally. In embodiments, c-bPCR does not include isothermal amplification, rather it requires minor (e.g., +/−5° C.) thermal oscillations. In contrast, thermal bridge polymerase chain reactions include thermally cycling between high temperatures (e.g., 85° C.-95° C.) and low temperatures (e.g., 60° C.-70° C.). Thermal bridge polymerase chain reactions may also include a denaturant, typically at a much lower concentration than traditional chemical bridge polymerase chain reactions. In embodiments, amplifying includes generating a double-stranded amplification product.

It will be appreciated that any of the amplification methodologies described herein or known in the art can be utilized with universal or target-specific primers to amplify the target polynucleotide. Suitable methods for amplification include, but are not limited to, the polymerase chain reaction (PCR), strand displacement amplification (SDA), transcription mediated amplification (TMA) and nucleic acid sequence-based amplification (NASBA), for example, as described in U.S. Pat. No. 8,003,354, which is incorporated herein by reference in its entirety. The above amplification methods can be employed to amplify one or more nucleic acids of interest. Additional examples of amplification processes include, but are not limited to, bridge-PCR, recombinase polymerase amplification (RPA), loop-mediated isothermal amplification (LAMP), rolling circle amplification (RCA), strand displacement amplification (SDA), rolling circle amplification (RCA) with exponential strand displacement amplification. In embodiments, amplification includes an isothermal amplification reaction. In embodiments, amplification includes bridge amplification. In general, bridge amplification uses repeated steps of annealing of primers to templates, primer extension, and separation of extended primers from templates. Because primers are attached within the core polymer, the extension products released upon separation from an initial template is also attached within the core. The 3′ end of an amplification product is then permitted to anneal to a nearby reverse primer that is also attached within the core, forming a “bridge” structure. The reverse primer is then extended to produce a further template molecule that can form another bridge. In embodiments, forward and reverse primers hybridize to primer binding sites that are specific to a particular target nucleic acid. In embodiments, forward and reverse primers hybridize to primer binding sites that have been added to, and are common among, target polynucleotides. Adding a primer binding site to target nucleic acids can be accomplished by any suitable method, examples of which include the use of random primers having common 5′ sequences and ligating adapter nucleotides that include the primer binding site. Examples of additional clonal amplification techniques include, but are not limited to, bridge PCR, solid-phase rolling circle amplification (RCA), solid-phase exponential rolling circle amplification, solid-phase recombinase polymerase amplification (RPA), solid-phase helicase dependent amplification (HDA), template walking amplification, emulsion PCR on particles (beads), or combinations of the aforementioned methods. Optionally, during clonal amplification, additional solution-phase primers can be supplemented in the microplate for enabling or accelerating amplification. In embodiments, the amplifying includes rolling circle amplification (RCA) or rolling circle transcription (RCT) (see, e.g., Lizardi et al., Nat. Genet. 19:225-232 (1998), which is incorporated herein by reference in its entirety). Several suitable rolling circle amplification methods are known in the art. For example, RCA amplifies a circular polynucleotide (e.g., DNA) by polymerase extension of an amplification primer complementary to a portion of the template polynucleotide. This process generates copies of the circular polynucleotide template such that multiple complements of the template sequence arranged end to end in tandem are generated (i.e., a concatemer) locally preserved at the site of the circle formation. In embodiments, the amplifying occurs at isothermal conditions. In embodiments, the amplifying includes hybridization chain reaction (HCR). HCR uses a pair of complementary, kinetically trapped hairpin oligomers to propagate a chain reaction of hybridization events, as described in Dirks, R. M., & Pierce, N. A. (2004) PNAS USA, 101(43), 15275-15278, which is incorporated herein by reference for all purposes. In embodiments, the amplifying includes branched rolling circle amplification (BRCA); e.g., as described in Fan T, Mao Y, Sun Q, et al. Cancer Sci. 2018; 109:2897-2906, which is incorporated herein by reference in its entirety. In embodiments, the amplifying includes hyberbranched rolling circle amplification (HRCA). Hyperbranched RCA uses a second primer complementary to the first amplification product. This allows products to be replicated by a strand-displacement mechanism, which yields drastic amplification within an isothermal reaction (Lage et al., Genome Research 13:294-307 (2003), which is incorporated herein by reference in its entirety). In embodiments, amplifying includes polymerase extension of an amplification primer. In embodiments, the polymerase is T4, T7, Sequenase, Taq, Klenow, and Pol I DNA polymerases. In embodiments, the polymerase is SD polymerase, Bst large fragment polymerase, or a phi29 polymerase or mutant thereof. In embodiments, the strand-displacing enzyme is an SD polymerase, Bst large fragment polymerase, or a phi29 polymerase or mutant thereof. In embodiments, the strand-displacing polymerase is phi29 polymerase, phi29 mutant polymerase or a thermostable phi29 mutant polymerase. A “phi polymerase” (or “Φ29 polymerase”) is a DNA polymerase from the Φ29 phage or from one of the related phages that, like Φ29, contain a terminal protein used in the initiation of DNA replication. For example, phi29 polymerases include the B103, GA-1, PZA, Φ15, BS32, M2Y (also known as M2), Nf, G1, Cp-1, PRD1, PZE, SFS, Cp-5, Cp-7, PR4, PR5, PR722, L17, Φ21, and AV-1 DNA polymerases, as well as chimeras thereof. A phi29 mutant DNA polymerase includes one or more mutations relative to naturally-occurring wild-type phi29 DNA polymerases, for example, one or more mutations that alter interaction with and/or incorporation of nucleotide analogs, increase stability, increase read length, enhance accuracy, increase phototolerance, and/or alter another polymerase property, and can include additional alterations or modifications over the wild-type phi29 DNA polymerase, such as one or more deletions, insertions, and/or fusions of additional peptide or protein sequences. Thermostable phi29 mutant polymerases are known in the art, see for example US 2014/0322759, which is incorporated herein by reference for all purposes. For example, a thermostable phi29 mutant polymerase refers to an isolated bacteriophage phi29 DNA polymerase including at least one mutation selected from the group consisting of M8R, V51A, M97T, L123S, G197D, K209E, E221K, E239G, Q497P, K512E, E515A, and F526 (relative to wild type phi29 polymerase). In embodiments, the polymerase is a phage or bacterial RNA polymerases (RNAPs). In embodiments, the polymerase is a T7 RNA polymerase. In embodiments, the polymerase is an RNA polymerase. Useful RNA polymerases include, but are not limited to, viral RNA polymerases such as T7 RNA polymerase, T3 polymerase, SP6 polymerase, and KII polymerase; Eukaryotic RNA polymerases such as RNA polymerase I, RNA polymerase II, RNA polymerase III, RNA polymerase IV, and RNA polymerase V; and Archaea RNA polymerase.

In embodiments, the method further includes detecting the amplification products. In embodiments, detecting the amplification products includes detecting the label (e.g., the nucleic acid sequence). In embodiments, detecting the amplification products includes detecting the oligonucleotide label. In embodiments, detecting includes sequencing. In embodiments, sequencing includes extending a sequencing primer annealed to the target polynucleotide to incorporate a nucleotide containing a detectable label that indicates the identity of a nucleotide in the target polynucleotide, detecting the detectable label, and optionally repeating the extending and detecting of steps. In embodiments, the methods include sequencing one or more bases of a target nucleic acid by extending a sequencing primer hybridized to a target nucleic acid (e.g., an amplification product of a target nucleic acid). In embodiments, the sequencing includes sequencing-by-synthesis, sequencing by ligation, sequencing-by-hybridization, or pyrosequencing, and generates a sequencing read. In embodiments, generating a sequencing read includes executing a plurality of sequencing cycles, each cycle including extending the sequencing primer by incorporating a nucleotide or nucleotide analogue using a polymerase and detecting a characteristic signature indicating that the nucleotide or nucleotide analogue has been incorporated.

In embodiments, sequencing includes a plurality of sequencing cycles. In embodiments, sequencing includes 20 to 100 sequencing cycles. In embodiments, sequencing includes 50 to 100 sequencing cycles. In embodiments, sequencing includes 50 to 300 sequencing cycles. In embodiments, sequencing includes 50 to 150 sequencing cycles. In embodiments, sequencing includes at least 10, 20, 30 40, or 50 sequencing cycles. In embodiments, sequencing includes at least 10 sequencing cycles. In embodiments, sequencing includes 10 to 20 sequencing cycles. In embodiments, sequencing includes 10, 11, 12, 13, 14, or 15 sequencing cycles. In embodiments, sequencing includes (a) extending a sequencing primer by incorporating a labeled nucleotide, or labeled nucleotide analogue and (b) detecting the label to generate a signal for each incorporated nucleotide or nucleotide analogue.

In embodiments, the method includes sequencing the first and/or the second strand of an amplification product by extending a sequencing primer hybridized thereto. A variety of sequencing methodologies can be used such as sequencing-by-synthesis (SBS), pyrosequencing, sequencing by ligation (SBL), or sequencing by hybridization (SBH). Pyrosequencing detects the release of inorganic pyrophosphate (PPi) as particular nucleotides are incorporated into a nascent nucleic acid strand (Ronaghi, et al., Analytical Biochemistry 242(1), 84-9 (1996); Ronaghi, Genome Res. 11(1), 3-11 (2001); Ronaghi et al. Science 281(5375), 363 (1998); U.S. Pat. Nos. 6,210,891; 6,258,568; and. 6,274,320, each of which is incorporated herein by reference in its entirety). In pyrosequencing, released PPi can be detected by being converted to adenosine triphosphate (ATP) by ATP sulfurylase, and the level of ATP generated can be detected via light produced by luciferase. In this manner, the sequencing reaction can be monitored via a luminescence detection system. In both SBL and SBH methods, target nucleic acids, and amplicons thereof, that are present at features of an array are subjected to repeated cycles of oligonucleotide delivery and detection. SBL methods, include those described in Shendure et al. Science 309:1728-1732 (2005); U.S. Pat. Nos. 5,599,675; and 5,750,341, each of which are incorporated herein by reference in their entirety; and the SBH methodologies are as described in Bains et al., Journal of Theoretical Biology 135(3), 303-7 (1988); Drmanac et al., Nature Biotechnology 16, 54-58 (1998); Fodor et al., Science 251(4995), 767-773 (1995); and WO 1989/10977, each of which are incorporated herein by reference in their entirety.

In SBS, extension of a nucleic acid primer along a nucleic acid template is monitored to determine the sequence of nucleotides in the template. The underlying chemical process can be catalyzed by a polymerase, wherein fluorescently labeled nucleotides are added to a primer (thereby extending the primer) in a template dependent fashion such that detection of the order and type of nucleotides added to the primer can be used to determine the sequence of the template. A plurality of different nucleic acid fragments can be subjected to an SBS technique under conditions where events occurring for different templates can be distinguished due to their location in the array. In embodiments, the sequencing step includes annealing and extending a sequencing primer to incorporate a detectable label that indicates the identity of a nucleotide in the target polynucleotide, detecting the detectable label, and repeating the extending and detecting steps. In embodiments, the methods include sequencing one or more bases of a target nucleic acid by extending a sequencing primer hybridized to a target nucleic acid (e.g., an amplification product produced by the amplification methods described herein). In embodiments, the sequencing step may be accomplished by an SBS process. In embodiments, sequencing includes a sequencing by synthesis process, where individual nucleotides are identified iteratively, as they are polymerized to form a growing complementary strand. In embodiments, nucleotides added to a growing complementary strand include both a label and a reversible chain terminator that prevents further extension, such that the nucleotide may be identified by the label before removing the terminator to add and identify a further nucleotide. Such reversible chain terminators include removable 3′ blocking groups, for example as described in U.S. Pat. Nos. 10,738,072 or 11,174,281. Once such a modified nucleotide has been incorporated into the growing polynucleotide chain complementary to the region of the template being sequenced, there is no free 3′-OH group available to direct further sequence extension and therefore the polymerase cannot add further nucleotides. Once the identity of the base incorporated into the growing chain has been determined, the 3′ block may be removed to allow addition of the next successive nucleotide. By ordering the products derived using these modified nucleotides it is possible to deduce the DNA sequence of the DNA template. Non-limiting examples of suitable labels are described in U.S. Pat. Nos. 8,178,360, 5,188,934(4,7-dichlorofluorescein dyes); U.S. Pat. No. 5,366,860 (spectrally resolvable rhodamine dyes); U.S. Pat. No. 5,847,162 (4,7-dichlororhodamine dyes); U.S. Pat. No. 4,318,846 (ether-substituted fluorescein dyes); U.S. Pat. No. 5,800,996 (energy transfer dyes); U.S. Pat. No. 5,066,580 (xanthene dyes): U.S. Pat. No. 5,688,648 (energy transfer dyes); and the like.

Sequencing includes, for example, detecting a sequence of signals. Examples of sequencing include, but are not limited to, sequencing by synthesis (SBS) processes in which reversibly terminated nucleotides carrying fluorescent dyes are incorporated into a growing strand, complementary to the target strand being sequenced. In embodiments, the nucleotides are labeled with up to four unique fluorescent dyes. In embodiments, the nucleotides are labeled with at least two unique fluorescent dyes. In embodiments, the readout is accomplished by epifluorescence imaging. A variety of sequencing chemistries are available, non-limiting examples of which are described herein.

Use of the sequencing method outlined above is a non-limiting example, as essentially any sequencing methodology which relies on successive incorporation of nucleotides into a polynucleotide chain can be used. Suitable alternative techniques include, for example, pyrosequencing methods, FISSEQ (fluorescent in situ sequencing), MPSS (massively parallel signature sequencing), or sequencing by ligation-based methods.

In embodiments, detecting includes detecting 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3 transcripts per μm². In embodiments, detecting includes detecting 4, 5, 6, 7, 8, 9, 10, 11, 12, 13, 14, 15, 16, 17, 18, 19, 2, 21, 22, 23, 24, 25, 26, 27, 28, 29, or 30 transcripts per μm². In embodiments, detecting includes detecting 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3 transcripts per μm³. In embodiments, detecting includes detecting 4, 5, 6, 7, 8, 9, 10, 11, 12, 13, 14, 15, 16, 17, 18, 19, 2, 21, 22, 23, 24, 25, 26, 27, 28, 29, or 30 transcripts per μm³.

In embodiments, the method further includes obtaining an image of a cell or tissue. In embodiments, the imaging includes phase-contrast microscopy, bright-field microscopy, Nomarski differential-interference-contrast microscopy, dark field microscopy, electron microscopy, or cryo-electron microscopy. In embodiments, the light transmittance of the sample is measured. For example, light transmittance may be measured with a visible near-infrared optical fiber spectrometer, wherein a circular spot of light (e.g., diameter, 5 mm) is irradiated on the central part a sample and the transmitted light is collected using an optical sensor.

In embodiments, the method further includes an imaging modality including immunofluorescence (IF), or immunohistochemistry modality (e.g., immunostaining). In embodiments, the method further includes an imaging modality including fluorescent hematoxylin and eosin (H&E) modality. For example, the method includes contacting the sample with a stain (e.g., Acridine orange, Auramine O, Calcofluor white, DAPI, Ethidium bromide, Hoechst 33258, Propidium iodide, Rhodamine B, SYBR Green, Texas Red, Thioflavin T, TOTO®-3, Uvitex 2B, YOYO®-1, 7-Aminoactinomycin D (7-AAD), TO-PRO®, TOPRO-3®, or eosin). In embodiments, the method includes ER staining (e.g., contacting the tissue section with a cell-permeable dye which localizes to the endoplasmic reticula), Golgi staining (e.g., contacting the tissue section with a cell-permeable dye which localizes to the Golgi), F-actin staining (e.g., contacting the tissue section with a phalloidin-conjugated dye that binds to actin filaments), lysosomal staining (e.g., contacting the tissue section with a cell-permeable dye that accumulates in the lysosome via the lysosome pH gradient), mitochondrial staining (e.g., contacting the tissue section with a cell-permeable dye which localizes to the mitochondria), nucleolar staining, or plasma membrane staining. For example, the method includes live cell imaging (e.g., obtaining images of the tissue section) prior to or during fixing, immobilizing, and permeabilizing the tissue section. Immunohistochemistry (IHC) is a powerful technique that exploits the specific binding between an antibody and antigen to detect and localize specific antigens in cells and tissue, commonly detected and examined with the light microscope. Known IHC modalities may be used, such as the protocols described in Magaki, S., Hojat, S. A., Wei, B., So, A., & Yong, W. H. (2019). Methods in molecular biology (Clifton, N.J.), 1897, 289-298, which is incorporated herein by reference. In embodiments, the additional imaging modality includes bright field microscopy, phase contrast microscopy, Nomarski differential-interference-contrast microscopy, or dark field microscopy. In embodiments, the method further includes determining the cell morphology of the tissue section (e.g., the cell boundary or cell shape) using known methods in the art. For example, to determining the cell boundary includes comparing the pixel values of an image to a single intensity threshold, which may be determined quickly using histogram-based approaches as described in Carpenter, A. et al Genome Biology 7, R100 (2006) and Arce, S., Sci Rep 3, 2266 (2013)). By “microscopic analysis” is meant the analysis of a specimen using techniques that provide for the visualization of aspects of a specimen that cannot be seen with the unaided eye, i.e., that are not within the resolution range of the normal human eye. Such techniques may include, without limitation, optical microscopy, e.g., bright field, oblique illumination, dark field, phase contrast, differential interference contrast, interference reflection, epifluorescence, confocal microscopy, CLARITY-optimized light sheet microscopy (COLM), light field microscopy, tissue expansion microscopy, etc., laser microscopy, such as, two photon microscopy, electron microscopy, and scanning probe microscopy. By “preparing a biological specimen for microscopic analysis” is generally meant rendering the specimen suitable for microscopic analysis at an unlimited depth within the specimen. In embodiments, the immobilized tissue section is imaged using “optical sectioning” techniques, such as laser scanning confocal microscopes, laser scanning 2-Photon microscopy, parallelized confocal (i.e. spinning disk), computational image deconvolution methods, and light sheet approaches. Optical sectioning microscopy methods provide information about single planes of a volume by minimizing contributions from other parts of the volume and do so without physical sectioning. The resulting “stack” of such optically sectioned images, represents a full reconstruction of the 3-dimensional features of a tissue volume. A typical confocal microscope includes a 10×/0.5 objective (dry; working distance, 2.0 mm) and/or a 20×/0.8 objective (dry; working distance, 0.55 mm), with a s z-step interval of 1 to 5 μm. A typical light sheet fluorescence microscope includes an sCMOS camera, a 2×/0.5 objective lens, and zoom microscope body (magnification range of ×0.63 to ×6.3). For entire scanning of whole samples, the z-step interval is 5 or 10 μm, and for image acquisition in the regions of interest, an interval in the range of 2 to 5 μm may be used.

In embodiments, the imaging modality is capable of imaging an imaging area of about 1 cm² to about 10 cm², 1 cm² to about 5 cm², 5 cm² to about 10 cm², 10 cm² to about 30 cm², 30 cm² to about 60 cm², 60 cm² to about 90 cm², 90 cm² to about 120 cm², or more.

In embodiments, the collection of information (e.g., sequencing information and cell morphology) is referred to as a signature. The term “signature” may encompass any gene or genes, protein or proteins, or epigenetic element(s) whose expression profile or whose occurrence is associated with a specific cell type, subtype, or cell state of a specific cell type or subtype within a population of cells. It is to be understood that also when referring to proteins (e.g., differentially expressed proteins), such may fall within the definition of “gene” signature. Levels of expression or activity or prevalence may be compared between different cells in order to characterize or identify for instance signatures specific for cell (sub)populations. Increased or decreased expression or activity of signature genes may be compared between different cells in order to characterize or identify for instance specific cell (sub)populations.

In embodiments, the methods described herein may further include constructing a 3-dimensional pattern of abundance, expression, and/or activity of each target from spatial patterns of abundance, expression, and/or activity of each target of multiple samples. In embodiments, the multiple samples can be consecutive tissue sections of a 3-dimensional tissue sample.

### EXAMPLES

### Example 1. Development of Flow Cell Assembly for Robust Tissue Adhesion

The compatibility of surfaces with specific biological sample types is often not universal among different sample types, such as the case where a surface (e.g., a slide) is suitable for formalin-fixed paraffin-embedded (FFPE) tissue but not for other types like fresh frozen, paraformaldehyde (PFA)-fixed frozen tissue, or fresh cultured cells. Additionally, surfaces of slides used in histology and pathology often require some level of customization based on the tissue source, like kidney, bone marrow, tonsil, or liver. Specific tissue types exhibit a heightened propensity for detachment from slides, including skin, bone, cartilage, dental tissue, and retinal tissue, as well as biopsies of fatty tissues such as the brain. Samples that are cut to thicknesses deviating from standard parameters, nerve cells, or specimens including multiple tissue types are also prone to separation from the slide surface. Different adhesives used in slide coating provide different degrees of hydrophobicity, hydrophilicity, wettability and contact angle tailored for particular tissue types and applications.

Typical sample slides are substantially planar (i.e., flat) glass, often 75×25 mm and 1 mm thick, or 3×1-inch and 1 mm thick, and are used to hold a biological specimen. In histopathology applications the glass slides are ground and polished for safe handling and include a frosted area painted for labeling purposes. Distinguishing between glass utilized in enological applications (wine glasses) and glass employed in histological laboratories, it is pertinent to note the compositional differences. In histological applications, borosilicate glass is predominantly utilized, attributed to its superior properties concerning its transmittance and reflectivity properties. Borosilicate glass is characterized by its high clarity and minimal light absorption, allowing for the transmission of a greater spectrum of light. Such a property is essential in microscopy, as it ensures that more light passes through the specimen, thereby providing clearer, more detailed visualizations of the sample under observation. Enhanced light transmittance is crucial for accurate and detailed microscopic examinations, particularly in high-resolution imaging. Additionally, the reduced reflectivity of borosilicate glass minimizes the interference caused by surface reflections, thus enhancing the quality of the image. Low reflectivity is especially beneficial when examining specimens that require high magnification or intricate detail observation, as it ensures that the light is focused on the specimen rather than being reflected off the surface. The absence of additives in borosilicate glass during the manufacturing process contributes to its enhanced purity, yielding superior optical and thermal characteristics. Consequently, this renders borosilicate glass more costly.

Addressing the chemical inertness of glass, it is essential to acknowledge the molecular structure of silica (SiO₂). Silica, the foundational constituent of glass, features a tetrahedral arrangement where each silicon atom is covalently bonded to four oxygen atoms. This robust lattice structure imparts glass with its chemically inert nature, as the preoccupied valence electrons in the silicon-oxygen bonds leave minimal propensity for additional chemical interactions. Due to the innate inertness of bare glass (i.e., unmodified glass), which lack chemical coatings, poses a risk of sample loss due to the absence of chemical adhesion between the tissue and the glass surface. In such instances, only electrostatic forces prevail, offering minimal adhesion. To mitigate this issue, histological laboratories often resort to heating techniques, wherein tissue samples are essentially baked onto the glass slide. This process also leverages the evaporation of water trapped between the tissue and the glass, aiding in the retention of the sample on the slide.

Immunohistochemistry commonly subjects tissue samples to elevated temperatures and numerous washing cycles with buffers of varying pH, alongside antigen retrieval methods that employ high temperatures, pressures, enzymes, or chemicals. These processes can lead to the dislodgement of tissue from glass slides. Similarly, in situ hybridization techniques involve high temperatures and prolonged stringency washes, potentially endangering tissue integrity if non-coated slides are used. To mitigate these risks, employing slides with enhanced adhesive properties is commonly utilized to safeguard the specimen. These adhesives interact with hydroxyl groups present on the glass surface, subsequently exposing amino groups that bear a positive charge. Given that most animal tissues carry a negative charge, they are naturally attracted to the positively charged amino groups on the slide, forming covalent bonds. These bonds are significantly stronger, ensuring robust attachment of the tissue to the slide, thereby preserving the integrity of the specimen during the histological processing.

Common additives on slides include proteins like albumin, gelatin, Poly-L-lysine, and extracts from the Cordia myxa tree, which provide amine groups (i.e., —NH₂) groups to attract negatively charged tissue samples. Some have historically used protein-based additives like Elmer's Glue or gelatin, however such additives can create background staining due to off-target hematoxylin binding to large proteins within the additive. Commercial slide coatings include aminosilanes, such as 3-Aminopropyltriethoxysilane (APTES) or 3-Aminopropyltrimethoxysilane (APTMS), which are compounds where an amine group is bonded to a silicon atom. The diversity among the approximately 3,000 aminosilanes can be attributed to differences in the length of the carbon chain, the presence of additional functional groups, and the degree of branching. Furthermore, the choice of aminosilane can influence the reactivity towards other chemicals used in slide preparation and staining processes. For instance, certain aminosilanes may provide enhanced reactivity towards specific tissue components, facilitating stronger adhesion.

Most NGS devices utilize a flow cell to capture nucleic acid fragments, amplify the fragments, and sequence the fragments. For example, the Singular Genomics® flow cell, similar to a microscope slide, is made of an optically transparent surface coated with oligonucleotides which are complementary to the sequencing adapters so that single-stranded, adapter-ligated DNA fragments can attach through hybridization. After attaching a DNA template to the anchors, solid phase amplification methods may be used to generate millions of copies of the template. A common method of doing solid-phase amplification involves bridge amplification methodologies (referred to as bridge PCR) as exemplified by the disclosures of U.S. Pat. Nos. 5,641,658; 7,115,400; 7,790,418; U.S. Patent Publ. No. 2008/0009420, each of which are incorporated herein by reference in their entirety. In sum, bridge amplification methods allow amplification products (e.g., amplicons) to be immobilized on a solid support in order to form arrays including colonies (or “clusters”) of immobilized nucleic acid molecules. Each cluster or colony on such an array is formed from a plurality of identical immobilized polynucleotide strands and a plurality of identical immobilized complementary polynucleotide strands. The products of solid-phase amplification reactions are referred to as “bridged” structures when formed by annealed pairs of immobilized polynucleotide strands and immobilized complementary strands, both strands being immobilized on the solid support at the 5′ end, preferably via a covalent attachment. During bridge PCR, additional chemical additives may be included in the reaction mixture, in which the DNA strands are denatured by flowing a denaturant such as formamide or NaOH over the DNA, which chemically denatures complementary strands. This is followed by washing out the denaturant and reintroducing a polymerase in buffer conditions that allow primer annealing and extension. Following amplification, the clusters are subjected to sequencing upon the introduction of a sequencing primer into the flow cell. Sequencing ensues with the extension of the sequencing primer using reversibly terminated fluorescently labeled nucleotides. Base call for each incorporated nucleotide is accomplished by detecting the emission signal and intensity of the fluorescently labeled nucleotide being incorporated. Following nucleotide incorporation, the reversibly terminated moiety at the 3′ end is removed, rendering the 3′ end ready for the next nucleotide incorporation step. Many clusters immobilized on the flow cell are sequenced in this massively parallel manner, underscoring the efficiency of flow cells in the field of genomics.

While flow cells have been instrumental in transforming the efficiency and economic feasibility of NGS DNA sequencing, their application in spatial biology, particularly for in situ RNA detection within cells and tissues, remains unexplored and challenging. A primary impediment in this translation is tissue delamination, a process where the structural integrity of tissue samples is compromised during repetitive reagent exchanges. Furthermore, when utilizing tissue sections, commonly around 5 μm in thickness, additional complications arise. Thin tissue sections are prone to wrinkling, which leads to non-uniform exposure to reagents and target detection inefficiencies. Degradation can result from both the mechanical handling of these fragile sections and the chemical interactions during the sequencing process, leading to a loss of vital biological information and potential misinterpretation of sequencing data. The development of a spatial in-situ sequencing platform would enable leveraging novel sequencing chemistry, fast optics, and innovative engineering that is foundational to commercially available Next Generation Sequencing (NGS) benchtop sequencers, such as the G4® provided by Singular Genomics®. However, the lack of such spatial in-situ sequencing platform where spatial biology analyses are performed directly on a flow cell remains unexplored and such deficiency prevents the efficiency provided from using flow cells to be realized for spatial biology applications.

Described herein are compositions and methods directed to the development of a robust flow cell assembly including a functionalized glass tissue slide that facilitates tissue adherence for in situ spatial sequencing workflows. Preparing a surface for tissue section mounting is a critical step in minimizing loss of tissue material during subsequent processing Protocols for the development of a robust solid support for tissue adherence and the assembly of the solid support into a flow cell as described herein for in situ spatial sequencing workflows are described infra and illustrated in FIG. 1A.

Glass functionalization with polymer (e.g., a resist) and coupling agent: Borosilicate glass slides were washed three times in ethanol bath while being sonicated. The glass slides were submerged into Ormocomp® (Micro Resist Technology GmbH, Germany), then contacted with Ormodev solvent (50:50 4-methyl-2-pentanone and 2-propanol, Micro Resist Technology GmbH, Germany), and rinsed using hexamethyldisilazane (HMDS). The surfaces of the slides were further functionalized with polyethylenimine (PEI). For PEI functionalization, the slides were incubated with 10% PEI in deionized water at room temperature on an orbital shaker. Following overnight incubation with 10% PEI, the slides were incubated in 0.1 M sodium hydroxide solution for 10 minutes at room temperature on an orbital shaker, followed by three washes with deionized water. In embodiments, focusing beads (e.g., focusing particles) were deposited following the surface functionalization with Ormocomp®. In embodiments, focusing beads (e.g., focusing particles) were deposited following the surface functionalization with PEI.

Deparaffinization and Heat-Induced Antigen Retrieval: FFPE tissue sections were prepared and transferred to the functionalized glass slide using techniques known in the art (see, e.g., PCT Publication WO2023076832A1). Following tissue section transfer, the slides were baked at elevated temperatures (e.g., 30-70° C.) and placed in dark storage at room temperature overnight. The tissue sections were then deparaffinized using xylene followed by 100% EtOH incubation. The slides were dried at 37° C. for 15 mins. Following deparaffinization, the slides were immersed into antigen retrieval buffer (pH 9) and incubated in a pressure cooker. The tissue sections were fixed using 4% paraformaldehyde (PFA) for 20 minutes.

Flow cell assembly: The slides were then assembled into a flow cell assembly by affixing a second solid support that includes a pressure-sensitive adhesive laminated onto glass slide with drilled ports. These drilled ports function as inlet and outlet ports for fluidic communication with the tissue section housed in flow cell assembly. The pressure-sensitive adhesive includes demarcations to define the lanes of the flow cell assembly. In embodiments, the flow cell assembly includes 2 lanes. In embodiments, the flow cell assembly includes 4 lanes. To prepare the second solid support to attachment to the functionalized glass slide containing the tissue section, a liner attached to the pressure-sensitive adhesive was removed. Using a fixture to align the functionalized tissue slide and second solid support, the second solid support was affixed onto the functionalized glass slide containing the tissue section by applying pressure to create a fluidic leak-free seal between the two slides, which renders the assembly ready for downstream preparation for in situ spatial sequencing (e.g., antibody staining, hybridization of padlock probe, rolling circle amplification, cluster amplification, and sequencing).

In embodiments, affixing the second solid support to the first solid support placing the first solid support described herein and the second solid support described herein on a platform and applying uniform pressure as described herein. In embodiments, affixing the second solid support to the first solid support placing the first solid support described herein and the second solid support described herein on a platform and applying uniform pressure to the pressure sensitive adhesive described herein.

FIGS. 2A-2B. FIG. 2A provides a schematic to prepare a second solid support described herein for its attachment to a first solid support described herein by affixing a gasket (e.g., a gasket described herein) onto the second solid support to define two distinct reaction chambers or channels. FIG. 2B provides a schematic to prepare a second solid support described herein for its attachment to a first solid support described herein by affixing a gasket (e.g., a gasket described herein) onto the second solid support to define four distinct reaction chambers or channels on the second solid support described herein. As shown in FIGS. 2A and 2B, prior to affixing the second solid support to the first solid support, the second solid support is placed onto a platform as shown in step 1 of FIGS. 2A and 2B and affixed with a gasket including a peel-off backing as shown in step 2 of FIGS. 2A and 2B. The peel-off backing is removed as shown in step 3 of FIGS. 2A and 2B to affix the second solid support to the first solid support including an attached cell or tissue sample.

To support the development of a robust flow cell assembly for in situ spatial sequencing applications, a study was performed to identify optimal combinations of pressure-sensitive adhesive and carriers. Table 1 provides six combinations of silicone pressure sensitive adhesives and two types of carriers, polyimide and polyester (abbreviated as PET). These spacer elements (e.g., including combinations of pressure-sensitive adhesive and carriers) were evaluated in the presence of cluster amplification and sequencing reagents for their ability to provide a fluidic leak-free seal for the flow cell assembly. Specifically, air leakage or reagent leakage from the flow cell assembly when exposed to extension solutions and sequencing solutions as well as during cycling and imaging were evaluated. An embodiment of a flow cell assembly with the pressure sensitive adhesives and carrier structure (e.g., a polymer) are depicted in FIG. 1B.

TABLE 1
Compatibility testing of combination of pressure sensitive adhesive and carrier polymers in cluster
amplification and sequencing protocols. Numbers shown in parentheses correspond to thickness measurements
in micrometers (μm). Pass/fail summaries are provided for the experimental conditions tested.

| | PSA 1 | PSA 2 | PSA 3 | PSA 4 | PSA 5 | PSA 6 |
|---|---|---|---|---|---|---|
| Adhesive (top, μm) | Silicone (60) | Silicone (25) | Silicone (25) | Silicone (57) | Silicone (51) | Silicone (50) |
| carrier (μm) | Polyimide (25) | PET (51) | PET (25) | PET (13) | Polyimide (25) | NA |
| Adhesive | Silicone (60) | Silicone (25) | Silicone (25) | Silicone (57) | Silicone (51) | NA |
| (bottom, μm) | | | | | | |
| Total thickness (μm) | 145 | 102 | 76 | 127 | 127 | 100 (2 |
| | | | | | | layers) |
| Peel Adhesion | 11.03 | 11.11 | 11.11 | 16.67 | 12.5 | 13 |
| (N/25 mm) | | | | | | |
| Flow cell Leakage | pass | pass | pass | pass | pass | pass |
| Test (Air) | | | | | | |
| Buffer A | pass | pass | pass | pass | pass | pass |
| (55° C., 30 min) | | | | | | |
| Buffer B | pass | pass | pass | pass | pass | pass |
| (61° C., 4 hr) | | | | | | |
| Flow cell Leakage | pass | pass | pass | pass | pass | pass |
| Test (Air) | | | | | | |
| Cycle sequencing | Overnight | Overnight | Overnight | Overnight | Overnight | Overnight |
| with wash buffer | | | | | | |
| and imaging | | | | | | |
| focusing beads | | | | | | |
| Flow cell Leakage | pass | pass | pass | pass | fail | fail |
| Test (Air) | | | | | | |

### Example 2. Optimization of Combination of Polymer and Coupling Agent for Surface Functionalization

The adhesion of a tissue section to a solid support (e.g., a glass tissue slide) used for biomedical imaging modalities is a cornerstone of extracting insight related to the composition, architecture, abundance, and spatial distribution of key macromolecules. Common workflows used to detect nucleic acid and protein molecules of interest in tissue sections require harsh conditions, such as high temperatures and incubation times, which can cause tissues to detach from the tissue slides (referred to tissue delamination). Additionally, tissue type influences its adherence to glass slides. For example, tissues deriving from skin, bone, and brain are prone to delamination, which poses critical challenges to the manipulation and analyses of these tissue types. Furthermore, the structure and morphology of the tissue section could be altered while it is contacted with assay conditions (referred to tissue distortion).

Methods to functionalize the surface of glass tissue slides are known in the art. For example, organosilane compounds are commonly employed to derivatize the surface of the glass tissue slides with reactive chemical moieties that facilitate cell adhesion between the glass and functional groups present in the tissue section. However, Das et al. described that biomolecules bound to silane-functionalized glass surfaces can be susceptible to detachment during high throughout genomics workflows as these workflows require the use of high temperatures and incubation times (Anal. Chem. 2023, 95, 41, 15384-15393). Das et al. also noted that such assay conditions promote hydrolytic instability between the Si—O—Si bond formed between the hydroxyl moiety of the glass slide and the silane moiety of the organosilane compound (Anal. Chem. 2023, 95, 41, 15384-15393). Additionally, certain surface functionalization agents, such as PEG-oxysilane, have been shown to inhibit cell adhesion rather than to promote it (Chen et al. Langmuir. 2010 Dec. 7; 26(23):17790-4). Moreover, Applicant has previously observed that functionalizing the surface of glass tissue slides with an aminosilane containing surface functionalizing agent, (3-Aminopropyl)triethoxysilane (APTES), produced inconsistent tissue adhesion when subjected to conditions for spatial transcriptomics studies (data not shown). The development of a robust glass substrate to which tissue sections can adhere and remain adhered throughout a given workflow is greatly needed.

Described herein are compositions and methods directed to the development of a robust flow cell assembly including a functionalized glass tissue slide that facilitates tissue adherence throughout amplification and sequencing workflows. Tissue stability studies were performed to identify the optimal combination of surface functionalizing agents (i.e., combination for polymer and coupling agent) for glass tissue slides that enable strong tissue retention following exposure to various assay conditions (e.g., conditions used for deparaffinization, heat-induced antigen retrieval, and sequencing-by-synthesis cycles). These studies were performed following the transfer of FFPE tissue sections onto glass slides functionalized with one of the following: polyethylenimine (PEI); Ormocomp® (an organically-modified ceramic polymer); Ormocomp® and PEI of varying molecular weights (600; 2,000; 25,000; and 750,000); Ormocomp® and polyallylamine; Ormocomp® and spermidine; Ormocomp® and (PEG)₃₂ diamine (abbreviated as P32 DA in FIG. 3A); Ormocomp® and (PEG)₃ diamine (abbreviated as P3 DA in FIG. 3A); and Ormocomp® and ethylenediamine (abbreviated as EDA in FIG. 3A). Ormocomp® is a commercially available organically-modified ceramic polymer containing alkoxysilane groups capable of interacting with the hydroxyl groups of glass and has an optical transparency to wavelengths between 400 nm-1500 nm (Kapyla et al. Langmuir 2014, 30, 48, 14555-14565). Methods for manipulating and transferring tissue sections to glass slides are known in the art (see, e.g., PCT Publication WO2023076832A1).

Briefly, protocols used for the tissue stability studies are as follows. Following the transfer of FFPE tissue sections onto functionalized glass slides, the tissue sections were deparaffinized using xylene followed by 100% EtOH incubation. Following, the tissue sections were subjected antigen retrieval buffer (pH 9) in a pressure cooker for 20 minutes, after which the flow cell was assembled. In embodiments, flow cell assembly included contacting the functionalized glass slide containing the tissue section with a second solid support including a UV cured adhesive. In embodiments, flow cell assembly included contacting the functionalized glass slide containing the tissue section with a second solid support including a pressure sensitive adhesive. In embodiments, flow cell assembly included contacting the functionalized glass slide containing the tissue section with a second solid support including a spacer element, wherein the spacer element includes an adhesive, carrier polymer, and second adhesive. Reagents were flowed into the flow cell assemblies for eosin y and TO-PRO3 staining, followed by flowing in wash buffer to remove unbound staining agents. During 150 sequencing cycles, reagents for nucleotide incorporation, reversible terminator cleaving agents, and wash buffers were flowed into the flow cell assemblies.

As shown in Table 2, different combinations of the polymer and coupling agents were assessed for retention of the FFPE tissue section during deparaffinization, heat-induced antigen retrieval, and 150 sequencing-by-synthesis cycles. Glass slides functionalized with PEI or Ormocomp® alone did not provide sufficient surface functionality to retain the tissue section following deparaffinization, heat-induced antigen retrieval, and 150 sequencing cycles. We discovered that the combination of the organically modified ceramic (i.e., Ormocomp®) and PEI of varying molecular weights (abbreviated as M.W., where M.W. of PEI analyzed include 600; 25,000; and 750,000) resulted in tissue retention following the tissue transfer onto the functionalized glass slide as well as deparaffinization and sequencing cycles in the flow cell assembly, suggesting a synergistic effect resulting from this combination of polymer (i.e., Ormocomp®) and coupling agent (i.e., PEI). Other combinations of polymer and coating agent that promoted tissue retention included Ormocomp® and polyallylamine and Ormocomp® and (PEG)₃₂ diamine. However, upon scrutiny of the flow cell assembly functionalized with Ormocomp® and (PEG)₃₂ diamine, partial tissue detachment was observed in the third and fourth lanes, as encircled in FIG. 3A. The superiority of the combination of Ormocomp® and PEI was hypothesized to result from three reasons. Firstly, the presence of acrylates and silane groups afforded from the use of Ormocomp® provides functional groups to facilitate covalent interactions between the functionalized glass surface and the tissue section. Secondly, Ormocomp® is pinhole-free and hypothesized to prevent direct contact between fluids used during the tissue stability study and the glass surface. Thirdly, PEI is also hypothesized to further protect Ormocomp® from any instability by having multivalent binding sites (e.g., multiple amine groups) to Ormocomp®, which are consequently stabilized by covalent and electrostatic interactions between these two layers.

TABLE 2
Tissue retention on functionalized glass slide following
tissue transfer onto functionalized glass slide, deparaffinization,
heat-induced antigen retrieval and 150 sequencing cycles,
where the glass slide was functionalized with various combinations
of polymer and coupling agent.

| Combination of | | Deparaffinization and | |
|---|---|---|---|
| Polymer and | At | Heat-Induced Antigen | 150 Sequencing |
| Coupling Agent | Transfer | Retrieval | Cycles |
| PEI | ✓ | x | x |
| Ormocomp ® | ✓ | x | x |
| Ormocomp ® and | ✓ | ✓ | ✓ |
| PEI (25,000) | | | |
| Ormocomp ® and | ✓ | ✓ | ✓ |
| PEI (600) | | | |
| Ormocomp ® and | ✓ | x | ✓ |
| PEI (2,000) | | | |
| Ormocomp ® and | ✓ | ✓ | ✓ |
| PEI (750,000) | | | |
| Ormocomp ® and | ✓ | ✓ | ✓ |
| polyallylamine | | | |
| Ormocomp ® and | ✓ | x | ✓ |
| spermidine | | | |
| Ormocomp ® and | ✓ | ✓ | ✓ |
| (PEG)₃₂ diamine | | | |
| Ormocomp ® and | ✓ | x | ✓ |
| (PEG)₃ diamine | | | |
| Ormocomp ® and | ✓ | x | ✓ |
| ethylenediamine | | | |

“Checkmark” symbol signifies tissue retention was observed following the experimental step.
“x” symbol signifies tissue retention was not observed following the experimental step.
Numbers shown in parentheses correspond to molecular weights of PEI.

Following the assessment of the combination of surface modification agents, various studies were performed using a total of 272 FFPE sections to evaluate tissue adhesion and tissue distortion (or lack thereof) during 155 sequencing-by-synthesis cycles in flow cell assemblies including glass slides functionalized with Ormocomp® and PEI (M.W. 25,000). FFPE tissue types evaluated in these studies included kidney FFPE tissue sections (123), tonsil FFPE tissue sections (73), bone marrow decalcified with formic acid (45), and bone marrow decalcified with EDTA (31), where the quantity of each tissue section are shown in parentheses. As shown in FIGS. 3B and 3C, images of kidney and bone marrow FFPE tissue sections transferred onto glass slides functionalized with Ormocomp® and PEI (25,000) showed no detectable signs of tissue delamination or distortion during a 155 sequencing-by-synthesis cycle run. Arrows are visual aids to show that tissue edges and small tissue islands remain adhered throughout fluidic cycling. Location of tissue sections relative to direction of fluidic flow (e.g., near inlet, center, or outlet) was evaluated. Images obtained for bone marrow FFPE tissue section are shown at near the inlet port, middle, and near the outlet port of the flow cell assembly over 155 sequencing cycles. No observable delamination or distortion was observed regardless of location of tissue section (FIG. 3D).

### Example 3. Spatial Transcriptomics Using Flow Cell Assembly

One key influencing factor in the pathophysiological development of a disease stems from the aberrant gene and protein expression of disease-relevant genes and proteins along with the spatial heterogeneity in their abundance and distribution among cells and tissues. Spatial biology techniques, such as in situ sequencing, enables the scrutiny of disease-relevant biomolecules (such as lipids, carbohydrates, nucleic acids, and/or proteins) in the original context of intact tissue, which enables the evaluation of these macromolecules in relation to the tissue architecture and cellular microenvironment, both of which are governed by the intracellular and intercellular communication in situ.

Provided herein are flow cell assemblies and detection agents including labels capable of detecting biomolecules in tissue sections in situ. Tissue sections may be manipulated using methods and techniques known in the art to for in situ transcriptomics workflows (see, e.g., U.S. Pat. No. 11,891,656, which is incorporated herein by reference in its entirety). For example, a tissue section including a nucleic acid of interest (e.g., the mRNA transcript of the oncogene ERBB2) is detected in a tissue section adhered onto a functionalized glass slide of a flow cell assembly described herein. Detection of the nucleic acid of interest requires the development of a detection agent, such as an oligonucleotide probe or padlock probe, with a sequence capable of hybridizing with the nucleic acid of interest to facilitate its detection in situ (e.g., oligonucleotide label). The determination of the sequence of the oligonucleotide label and its association to the nucleic acid of interest is made a priori, and the oligonucleotide label is capable of being detected by various methods. In embodiments, the oligonucleotide label is amplified prior to detection to boost its signal for detection. In embodiments, the mode of detection is by sequencing-by-synthesis, where the sequence of the oligonucleotide label is detected and used to associate and identify the nucleic acid of interest in the tissue section following bioinformatic analyses.

Other biomolecules contemplated for detection include a protein of interest (e.g., Akt). Tissue sections may be manipulated using methods and techniques known in the art to for in situ proteomics workflows (see, e.g., U.S. Pat. No. 11,891,656, which is incorporated herein by reference in its entirety). Detection of a protein of interest is performed using a protein-specific binding agent, such as an antibody with an oligonucleotide label (e.g., protein-specific antibody-oligo (Ab-O) conjugates), where the determination of the sequence of the oligonucleotide label and its association to the protein of interest is made a priori. In embodiments, the oligonucleotide label is amplified prior to detection to boost its signal for detection. In embodiments, the mode of detection is by sequencing-by-synthesis, where the sequence of the oligonucleotide label is detected and used to associate and identify the protein of interest in the tissue section following bioinformatic analyses.

An example of a spatial transcriptomic study performed using kidney tissue adhered onto a functionalized solid support as described herein and assembled to a flow cell with two-lane configuration is shown in FIG. 4A over the first 10 sequencing cycles. Shown in FIG. 4B is a QC image of the kidney tissue sample from FIG. 4A taken using a Nikon microscope following the hybridization of a fluorescently labeled probe to verify lack of tissue delamination and distortion prior to sequencing run.

Additional spatial transcriptomic studies were performed using colon, breast tissue, lung tissue, and lymph node tissue adhered onto a functionalized solid support as described herein and assembled to a flow cell. Tissues were prepared for transfer to the functionalized tissue glass slide in deparaffinization and heat-induced antigen retrieval steps as described supra in Example 1. Following the transfer of the tissues onto the functionalized tissue glass slides, padlock probes targeting the target RNA transcripts were allowed to hybridize with the target genes. In embodiments, 1, 2, 3, 4, 5, 6, 7, 8, 9, 10, 11, 12, 13, 14, 15, 16, 17, 18, 19, or 20 unique padlock probes were used to target each gene. In embodiments, 3 unique padlock probes were used to target each gene. In embodiments, 5 unique padlock probes were used to target each gene. In embodiments, 7 unique padlock probes were used to target each gene. In embodiments, 9 unique padlock probes were used to target each gene. In embodiments, 11 unique padlock probes were used to target each gene. In embodiments, 12 unique padlock probes were used to target each gene. Following hybridization, the padlock probes were ligated using SplintR® ligase, amplified, and sequenced. In embodiments, target RNA transcripts were further detected using fluorescent hematoxylin and eosin (H&E) staining. In embodiments, about 100, about 200, about 300, about 400, or about 500 nucleic acids of interest are detected. In embodiments, about 300 nucleic acids of interest are detected. In embodiments, about 350 nucleic acids of interest are detected. In embodiments, about 400 nucleic acids of interest are detected.

### Example 4. Combined Spatial Transcriptomics and Proteomics Using Flow Cell Assembly

We proceeded to adapt the workflow described supra to enable a combined transcriptomic and proteomics readout using the same tissue attached to the flow cell assembly described herein. Buccitelli et al. reported that transcriptomics and proteomics provide non-redundant readouts as mRNA levels detected from a transcriptomics readout do not invariably correlate with its protein levels (see, e.g., Buccitelli et. al. Nat Rev Genet. 2020 Oct; 21(10):630-644, which is incorporated herein by reference in its entirety). Different confounding factors, such as epigenetic changes to the transcriptional state of a gene, transcription rates, mRNA half-lives, whether proteins are transported to different cellular locations following their translation, and protein half-lives, could impact protein levels and/or cause deviations in correlations between the mRNA and protein levels for individual genes. As such, obtaining proteomics data and/or in combination with the transcriptomics data from the same tissue section provides immeasurable insight to unraveling the biological complexities of healthy and/or diseased cells within a tissue sample.

Provided herein are flow cell assemblies and methods of using thereof for in situ detection of nucleic acids and proteins in tissue sections. A combined transcriptomics and proteomics study was conducted using the flow cell assembly described herein and detection agents described herein to detect nucleic acids of interest and proteins of interest in colon tissue. In embodiments, the flow cell assembly includes a two-lane configuration. In embodiments, the flow cell assembly includes a four-lane configuration. In embodiments, the distance between the first solid support and second solid support of the flow cell assembly is about 70 μm. In embodiments, the distance between the first solid support and second solid support of the flow cell assembly is about 90 μm. In embodiments, the distance between the first solid support and second solid support of the flow cell assembly is about 145 μm.

Tissues were prepared for transfer to the functionalized tissue glass slide in deparaffinization and heat-induced antigen retrieval steps as described supra. Following the transfer of the tissues onto the functionalized tissue glass slides, padlock probes targeting the target RNA transcripts were allowed to hybridize with the nucleic acids of interest. In embodiments, 3 unique padlock probes with a sequence capable of hybridizing with a nucleic acid of interest are used to facilitate its detection in situ. In embodiments, 7 unique padlock probes with a sequence capable of hybridizing with a nucleic acid of interest are used to facilitate its detection in situ. In embodiments, 12 unique padlock probes with a sequence capable of hybridizing with a nucleic acid of interest are used to facilitate its detection in situ. Following hybridization, the padlock probes targeting the nucleic acids of interest were ligated using SplintR® ligase and amplified using rolling circle amplification. Following amplification of the ligated padlock probes corresponding to the nucleic acids of interest, the tissue section was contacted with detection agents targeting proteins of interest. In embodiments, the detection agent is an antibody with an oligonucleotide label, where the determination of the sequence of the oligonucleotide label and its association to a protein of interest is made a priori. In embodiments, the oligonucleotide label is a padlock probe, where the sequence of the padlock probe and its association to a protein of interest is made a priori. Following the binding interaction between target-specific antibody and the protein of interest, padlock probes associated with the proteins of interest were ligated using SplintR® ligase and amplified using rolling circle amplification. Amplicons corresponding to the padlock probes targeting nucleic acids of interest and amplicons associated with proteins of interest were sequenced. In embodiments, nucleic acids of interest and proteins of interest were further detected using fluorescent hematoxylin and eosin (H&E) staining.

FIG. 5A provides an image of a colon tissue attached to the flow cell assembly described herein. Each dot on the image depicts a detected RNA molecule. FIG. 5B shows a magnified view of the region enclosed by the square in FIG. 5A. Using the methods described herein and attaching the colon tissue onto the flow cell assembly described herein enables the detection of rare subpopulations, such as transit amplifying cells, along with a diversity of cell types, such as B cells, plasma cells, T cells, enterocytes, tuft cells, adipocytes, myeloid cells, Paneth cells, endothelial cells, goblet cells, pericytes, neural cells, glial cells, stem cells, stromal cells, epithelial cells, D-cells, and L-cells.

In addition to the image of the colon tissue shown in FIGS. 5A and 5B, spatial proteomics data was obtained using the same tissue section. FIG. 6A provides an image of the same colon tissue section shown in FIGS. 5A and 5B, where proteins of interest, such as CHGA (blue), ITLN1 (green), and OLFM4 (red), were detected using protein-specific antibody-oligo (Ab-O) conjugates. Following binding of oligonucleotide probes to the Ab-O and subsequent detection, the respective proteins are identified within the tissue, which are shown with arrows as visual aids for the presence of CHGA, ITLN1, and OLFM4 proteins in the colon tissue section. FIG. 6B shows a magnified view of the region enclosed by the square in FIG. 6A.

Alternatively, or additionally, methods of using the flow cell assembly described herein for the detection of proteins of interest without the detection of nucleic acids of interest were also contemplated. For a proteomics workflow, tissues were prepared for transfer to the functionalized tissue glass slide in deparaffinization and heat-induced antigen retrieval steps as described supra and contacted with detection agents targeting proteins of interest. In embodiments, the detection agent is an antibody with an oligonucleotide label, where the determination of the sequence of the oligonucleotide label and its association to the protein of interest is made a priori. In embodiments, the oligonucleotide label is a padlock probe, where the sequence of the padlock probe and its association to the protein of interest is made a priori. Following the binding interaction between target-specific antibody and the protein of interest, padlock probes associated with the proteins of interest were ligated using SplintR® ligase and amplified using rolling circle amplification. Amplicons associated with proteins of interest were sequenced. In embodiments, proteins of interest were further detected using fluorescent hematoxylin and eosin (H&E) staining. In embodiments, about 10, 11, 12, 13, 14, 15, 16, 17, 18, 19, 20, 21, 22, 23, 24, 25, 26, 27, 28, 29, 30, or more proteins of interest are detected. In embodiments, about 10 proteins of interest are detected. In embodiments, about 15 proteins of interest are detected. In embodiments, about 20 proteins of interest are detected.

FIG. 7 provides composite images and representative views of the 12 proteins of interest (PD-1, PD-L1, CD56, CD8, HLADR, CD4, CD3, Ki67, CD20, ATPase, CD45RA, and PanCk) detected in from tonsil tissue in a proteomics workflow using the flow cell assembly described herein during the first four imaging cycles (i.e., read 1, read 2, read 3, and read 4).

Following the combined in situ transcriptomics and proteomics study described supra, a time course study was conducted to evaluate the surface stability of the glass slides functionalized with Ormocomp® and PEI under different storage conditions over time. Eleven tissue types were adhered to glass slides functionalized with Ormocomp® and PEI and stored at room temperature for 9 months or at 4° C. in ambient air for 9 months. Following 9 months of storage at both conditions, tissue sections showed robust adhesion on the functionalized glass slides without delamination, signifying a long shelf life for the functionalized slides and their compatibility for long-term storage and use. An immuno-oncology panel of targeting 300 different RNA transcripts and a panel of padlock probes targeting 10 to 15 proteins were hybridized to the tissues and subjected to 100 cycles of sequencing using methods described supra.

What is claimed is:

1. A flow cell assembly comprising:
a first solid support;
a resist attached to the first solid support, wherein the resist is a poly dimethylsiloxane (PDMS), poly(methyl methacrylate) (PMMA), cyclic olefin copolymer (COC), silsesquioxane resist, an epoxy-based polymer resist, poly(vinylpyrrolidone-vinyl acrylic acid) copolymer resist, an Off-stoichiometry thiol-enes (OSTE) resist, amorphous fluoropolymer resist, a crystalline fluoropolymer resist, polysiloxane resist, or an organically modified ceramic polymer resist;
a coupling agent attached to the resist;
a cell or tissue attached to the coupling agent;
a second solid support attached to the first solid support, wherein the second solid support is configured to define a reaction chamber when attached to the first solid support.

2. The flow cell assembly of claim 1, further comprising a frame configured to retain the flow cell assembly.

3. The flow cell assembly of claim 2, wherein the frame comprises a ferromagnetic pin.

4. The flow cell assembly of claim 1, further comprising a microchip.

5. The flow cell assembly of claim 4, wherein the microchip is an electronically erasable programmable read only memory (EEPROM) chip.

6. The flow cell assembly of claim 1, wherein the second solid support comprises a channel bored into the second solid support.

7. The flow cell assembly of claim 1, wherein the second solid support comprises a gasket, wherein the gasket defines the reaction chamber.

8. The flow cell assembly of claim 7, wherein the gasket comprises silicone, polyimide, fluorocarbon elastomer, ethylene propylene diene, polychloroprene, polytetrafluoroethylene, nitrile rubber, butyl rubber, natural rubber, thermoplastic elastomer, or a combination thereof.

9. The flow cell assembly of claim 1, further comprising 2, 3, 4, 5, 6, 7, 8, 9, 10, 11, or 12 reaction chambers.

10. The flow cell assembly of claim 1, wherein the reaction chamber comprises a depth of about 50 μm to about 150 μm.

11. The flow cell assembly of claim 1, wherein the reaction chamber comprises a depth of about 80 μm to about 110 μm.

12. The flow cell assembly of claim 1, wherein the reaction chamber comprises a width of about 4 μm to about 15 μm.

13. The flow cell assembly of claim 1, wherein the second solid support is attached to the first solid support via a pressure sensitive adhesive.

14. The flow cell assembly of claim 1, wherein the tissue is embedded in an embedding material comprising paraffin wax, polyepoxide polymer, polyacrylic polymer, agar, gelatin, celloidin, cryogel, optimal cutting temperature (OCT) compositions, glycols, or a combination thereof.

15. The flow cell assembly of claim 1, wherein the first solid support or the second solid support comprises an inlet port and an outlet port.

16. The flow cell assembly of claim 1, wherein the first solid support or the second solid support further comprises an IR reflective coating.

17. The flow cell assembly of claim 1, wherein the first solid support further comprises a plurality of particles.

18. The flow cell assembly of claim 1, wherein the coupling agent comprises (3-aminopropyl)triethoxysilane (APTES), (3-Aminopropyl)trimethoxysilane (APTMS), γ-Aminopropylsilatrane (APS), N-(6-aminohexyl)aminomethyltriethoxysilane (AHAMTES), polyethylenimine (PEI), 5,6-epoxyhexyltriethoxysilane, or triethoxysilylbutyraldehyde, or a combination thereof.

19. A method of making a flow cell assembly, the method comprising:
binding a resist to a first solid support;
binding a coupling agent to the resist;
attaching a cell or tissue to the coupling agent; and
affixing a second solid support to the first solid support, wherein the first solid support or the second solid support comprises an inlet port.

20. A method of detecting a biomolecule in or on a cell or tissue, said method comprising:
immobilizing a cell or tissue comprising a biomolecule to a solid support, wherein said solid support comprises a resist attached to the solid support, and a coupling agent attached to the resist;
attaching a second solid support to the first solid support;
contacting the biomolecule in or on said cell or tissue with a detection agent comprising a label;
detecting the label, thereby detecting the biomolecule.
